(19) United States
(12) Patent Application Publication
(10) Pub. No.: US 2021/0109375 A1
(43) Pub. Date: Apr. 15, 2021

(54) OPHTHALMIC OPTICAL TESTING SYSTEM AND METHOD

(71) Applicant: Perfect IP, LLC, Dallas, TX (US)

(72) Inventors: Ruth (nmn) Sahler, Irvine, CA (US); Donald Michael Boyer, Oceanside, CA (US); Kevin (nmn) Gonzalez-Martinez, Anaheim, CA (US); Raymond Kenneth Alley, Laguna Hills, CA (US)

(21) Appl. No.: 17/063,887

(22) Filed: Oct. 6, 2020

Related U.S. Application Data
(60) Provisional application No. 62/913,468, filed on Oct. 10, 2019.
(60) Provisional application No. 62/966,419, filed on Jan. 27, 2020.

(51) Int. Cl. G02C 7/02; G01M 11/02

(52) U.S. Cl. CPC G02C 7/024; G02C 7/022; G01M 11/0221

(57) ABSTRACT

An ophthalmic optical testing system/method allowing human eye characteristics modeling and evaluation of a lens under test (LUT) is disclosed. The system and method incorporate an axial positioning platform (APP) allowing tip/tilt/rotation about a vertical or horizontal axis of an optical retention framework (ORF) containing a cassette support tower (CST). The CST retains a pupil lens fixture (PLF) incorporating pinhole or light blocking device (POL). The ORF mates to a corneal and test longitudinal axis positioning platforms (LAP) that are attached respectively to a corneal lens fixture (CLF) retaining corneal lens optics (CLO) and a test lens fixture (TLF) retaining an lens under test (LUF) and LUT. The LAPs allow longitudinal adjustment of lenses along a common optical axis (LOA) pathway. APP positioning, LAP adjustments, and selection of CLO/PLO/LUT permit LOA optical characteristics to be adjusted and tested.

### CROSS REFERENCE TO RELATED APPLICATIONS

### Provisional Patent Applications

This application claims benefit under 35 U.S.C. § 119 and incorporates by reference United States Provisional Patent Application for OPHTHALMIC TESTING SYSTEM AND METHOD, by inventors Ruth (nmn) Sahler, Donald Michael Boyer, Kevin (nmn) Gonzalez-Martinez, and Raymond Kenneth Alley, filed on Oct. 10, 2019, EFSID 37425307, Ser. No. 62/913,468, confirmation number 6384, attorney docket number PIP-1902P.

This application claims benefit under 35 U.S.C. § 119 and incorporates by reference United States Provisional Patent Application for OPHTHALMIC TESTING SYSTEM AND METHOD, by inventors Ruth (nmn) Sahler, Donald Michael Boyer, Kevin (nmn) Gonzalez-Martinez, and Raymond Kenneth Alley, filed on Jan. 27, 2020, EFSID 38411898, Ser. No. 62/966,419, confirmation number 2745, attorney docket number PIP-1902P2.

### United States Patents and Patent Applications

This application incorporates by reference the following United States issued patents: U.S. Pat. Nos. 8,152,302; 8,292,952; 8,568,627; 8,646,916; 8,920,690; 9,192,292; 9,023,257; 9,925,621; 9,186,242; 9,107,746; 10,219,948.

This application incorporates by reference the following United States Patent Application Publications: 2011/0130654; 2011/0130677; 2011/0128501; 2011/0212205; 2013/0103144; 2014/0249516; 2014/0243443; 2015/0112203; 2018/0231800; 2018/0229459; 2019/0117452.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present disclosure relates to an ophthalmic optical testing apparatus (OTA). More particularly, and not by way of limitation, the present disclosure is directed to a system and method for ophthalmic optical testing in which the human eye can be modeled in order to evaluate the performance of various ophthalmic options available to a patient prior to patient surgery, the performance of various intraocular lens (IOL) and/or lens under test (LUT) models, and/or the potential effect of light sources on the eye.

### BACKGROUND AND PRIOR ART

Surgery that involves the eye (or related ophthalmic region of the eye) is often a stressful event for the patient and the surgeon. In some cases, different options might be available to the patient and it is currently difficult to evaluate the visual outcome of each option. Currently there is no methodology to explore these options and their outcomes absent actually performing surgery on the patient's eye. It would be helpful to the patient and physician to have a device where the effect of a given option may be evaluated in a model of the human eye prior to surgery. In this manner, a patient and physician may explore the performance of a variety of surgical options prior to committing to a selected surgical option.

The OTA also would also allow a lens manufacturer to test various models in a setting which replicates the human eye. The OTA would also allow the testing of light exposures on the retina or cornea.

The OTA mirrors the patient's physiology and the options available to the patient. The patient and physician can then view the optical results of each option and their concomitant results and make an informed choice. The same OTA can also be used to compare various measurement devices or calibrate different devices with each other. The OTA can be used by ophthalmic companies as an additional test for intraocular lenses (the “IOLs”) in vitro. It can also be used for laser safety testing or to examine light hazards.

### BRIEF SUMMARY OF THE INVENTION

The disclosed OTA invention permits the human eye to be modeled prior to performing actual patient surgery in order to evaluate a variety of possible ophthalmic patient treatment options. In this manner the patient's physiology can be mirrored in an ophthalmic eye model and then a variety of lens can be placed in the OTA to model and evaluate each lens option with respect to the desired patient outcome.

Using an appropriate measuring device, a physician can then decide if the lens the surgeon proposes is appropriate or needs to be adjusted to better serve the patient. The OTA provides a dry run on the visual effects created by the lens chosen by the doctor. The same OTA can also be used to compare measurement devices or calibrate different system, thus providing a better understanding of each system's capabilities, options, and limitations. Additionally the OTA can be used by ophthalmic companies as an additional validation test after “in-vitro” lab testing and prior to “in-vivo” implantation. Finally, the same OTA could be used to validate, compare, calibrate, or select ophthalmic measurement devices for use with a given patient or class of patients. The OTA can also be customized to reflect different corneal shapes and based upon a particular shape further adapt a visual solution for that particular patient.

The OTA disclosed herein generally consists of an adjustable platform on which an optical retention framework (ORF) is mounted. The ORF supports a plurality of lens-retaining structures in a lens alignment series (LAS). In its basic form the ORF incorporates a cassette support tower (CST) that retains a lens cassette fixture (LCF) holding a pupil lens fixture (PLF) that incorporates the equivalent of pinhole or light block device (POL) and/or pinhole/iris opening. To each side of the PLF are configured longitudinally adjustable platforms on which corneal lens optics (CLO) and intraocular lens (IOL) optics are held within corneal/IOL fixtures. The corneal lens may be adjusted based upon corneal measurements of the patient. This allows for the posterior and anterior lens distances to be adjusted as well as a variety of other distances in the longitudinal optical axis (LOA) pathway that is common to the CLO, PLO, and IOL.

Adjustment of the mechanical positioning of the CLO, PLO, and IOL as well as proper selection of these lenses allows a physician to evaluate a number of optical pathways for a patient prior to surgery.

Operation of the OTA is as follows: the physician places a lens which is modeled after the patient's cornea in the CLF, a lens modeled after the patient's pupil in the PLF and the IOL/LUT selected for the patient in the LUF. The slots can be adjusted by the set screws or automated linear stage system to replicate the physiology of the patient. Once the components have been properly positioned a light can be directed through the model and the image quality produced by the OTA with the components and adjustments selected for that test can be evaluated.

Various aspects of patient eye physiology can be adjusted for each test done with the OTA including but not limited to anterior chamber depth (“ACD”), posterior chamber depth (“PCD”), the pupil opening, as well as the variable lens components comprising the cornea, pupil, and IOL.

Different retina diffusion and thermal papers can be inserted along the LOA in slots provided by the ORF to evaluate theoretical thermal heat buildup from different procedures. The OTA can be used with class II and III devices to validate heat dissipation algorithms and safety factors.

### BRIEF DESCRIPTION OF THE DRAWINGS

For a fuller understanding of the advantages provided by the invention, reference should be made to the following detailed description together with the accompanying drawings wherein:

FIG. 1 illustrates a system block diagram depicting a preferred exemplary application context including a system embodiment of the present invention;

FIG. 2 illustrates a system block diagram depicting a preferred exemplary system embodiment of the present invention;

FIG. 3 illustrates a front perspective assembly view of a preferred exemplary system embodiment of the present invention;

FIG. 4 illustrates a front view of a preferred exemplary system embodiment of the present invention;

FIG. 5 illustrates a rear view of a preferred exemplary system embodiment of the present invention;

FIG. 6 illustrates a left side view of a preferred exemplary system embodiment of the present invention;

FIG. 7 illustrates a right side view of a preferred exemplary system embodiment of the present invention;

FIG. 8 illustrates top and bottom views of a preferred exemplary system embodiment of the present invention;

FIG. 9 illustrates a front right top perspective view of a preferred exemplary system embodiment of the present invention;

FIG. 10 illustrates a rear right top perspective view of a preferred exemplary system embodiment of the present invention;

FIG. 11 illustrates a rear left top perspective view of a preferred exemplary system embodiment of the present invention;

FIG. 12 illustrates a front left top perspective view of a preferred exemplary system embodiment of the present invention;

FIG. 13 illustrates a front right bottom perspective view of a preferred exemplary system embodiment of the present invention;

FIG. 14 illustrates a rear right bottom perspective view of a preferred exemplary system embodiment of the present invention;

FIG. 15 illustrates a rear left bottom perspective view of a preferred exemplary system embodiment of the present invention;

FIG. 16 illustrates a front left bottom perspective view of a preferred exemplary system embodiment of the present invention;

FIG. 17 illustrates a front view of a preferred exemplary embodiment of an optical retention framework (ORF) useful in some preferred embodiments of the present invention;

FIG. 18 illustrates a rear view of a preferred exemplary embodiment of an optical retention framework (ORF) useful in some preferred embodiments of the present invention;

FIG. 19 illustrates a left side view of a preferred exemplary embodiment of an optical retention framework (ORF) useful in some preferred embodiments of the present invention;

FIG. 20 illustrates a right side view of a preferred exemplary embodiment of an optical retention framework (ORF) useful in some preferred embodiments of the present invention;

FIG. 21 illustrates a top view of a preferred exemplary embodiment of an optical retention framework (ORF) useful in some preferred embodiments of the present invention;

FIG. 22 illustrates a bottom view of a preferred exemplary embodiment of an optical retention framework (ORF) useful in some preferred embodiments of the present invention;

FIG. 23 illustrates a front top perspective front side section view of a preferred exemplary embodiment of an optical retention framework (ORF) useful in some preferred embodiments of the present invention;

FIG. 24 illustrates a front top perspective right side section view of a preferred exemplary embodiment of an optical retention framework (ORF) useful in some preferred embodiments of the present invention;

FIG. 25 illustrates a front right top perspective view of a preferred exemplary embodiment of an optical retention framework (ORF) useful in some preferred embodiments of the present invention;

FIG. 26 illustrates a rear right top perspective view of a preferred exemplary embodiment of an optical retention framework (ORF) useful in some preferred embodiments of the present invention;

FIG. 27 illustrates a rear left top perspective view of a preferred exemplary embodiment of an optical retention framework (ORF) useful in some preferred embodiments of the present invention;

FIG. 28 illustrates a front left top perspective view of a preferred exemplary embodiment of an optical retention framework (ORF) useful in some preferred embodiments of the present invention;

FIG. 29 illustrates a front right bottom perspective view of a preferred exemplary embodiment of an optical retention framework (ORF) useful in some preferred embodiments of the present invention;

FIG. 30 illustrates a rear right bottom perspective view of a preferred exemplary embodiment of an optical retention framework (ORF) useful in some preferred embodiments of the present invention;

FIG. 31 illustrates a rear left bottom perspective view of a preferred exemplary embodiment of an optical retention framework (ORF) useful in some preferred embodiments of the present invention;

FIG. 32 illustrates a front left bottom perspective view of a preferred exemplary embodiment of an optical retention framework (ORF) useful in some preferred embodiments of the present invention;

FIG. 33 illustrates a front view of a preferred exemplary embodiment of a corneal lens fixture (CLF) useful in some preferred embodiments of the present invention;

FIG. 34 illustrates a rear view of a preferred exemplary embodiment of a corneal lens fixture (CLF) useful in some preferred embodiments of the present invention;

FIG. 35 illustrates a left side view of a preferred exemplary embodiment of a corneal lens fixture (CLF) useful in some preferred embodiments of the present invention;

FIG. 36 illustrates a right side view of a preferred exemplary embodiment of a corneal lens fixture (CLF) useful in some preferred embodiments of the present invention;

FIG. 37 illustrates a top view of a preferred exemplary embodiment of a corneal lens fixture (CLF) useful in some preferred embodiments of the present invention;

FIG. 38 illustrates a bottom view of a preferred exemplary embodiment of a corneal lens fixture (CLF) useful in some preferred embodiments of the present invention;

FIG. 39 illustrates a front top perspective front side section view of a preferred exemplary embodiment of a corneal lens fixture (CLF) useful in some preferred embodiments of the present invention;

FIG. 40 illustrates a front top perspective right side section view of a preferred exemplary embodiment of a corneal lens fixture (CLF) useful in some preferred embodiments of the present invention;

FIG. 41 illustrates a front right top perspective view of a preferred exemplary embodiment of a corneal lens fixture (CLF) useful in some preferred embodiments of the present invention;

FIG. 42 illustrates a rear right top perspective view of a preferred exemplary embodiment of a corneal lens fixture (CLF) useful in some preferred embodiments of the present invention;

FIG. 43 illustrates a rear left top perspective view of a preferred exemplary embodiment of a corneal lens fixture (CLF) useful in some preferred embodiments of the present invention;

FIG. 44 illustrates a front left top perspective view of a preferred exemplary embodiment of a corneal lens fixture (CLF) useful in some preferred embodiments of the present invention;

FIG. 45 illustrates a front right bottom perspective view of a preferred exemplary embodiment of a corneal lens fixture (CLF) useful in some preferred embodiments of the present invention;

FIG. 46 illustrates a rear right bottom perspective view of a preferred exemplary embodiment of a corneal lens fixture (CLF) useful in some preferred embodiments of the present invention;

FIG. 47 illustrates a rear left bottom perspective view of a preferred exemplary embodiment of a corneal lens fixture (CLF) useful in some preferred embodiments of the present invention;

FIG. 48 illustrates a front left bottom perspective view of a preferred exemplary embodiment of a corneal lens fixture (CLF) useful in some preferred embodiments of the present invention;

FIG. 49 illustrates a front view of a preferred exemplary embodiment of a test lens fixture (TLF) useful in some preferred embodiments of the present invention;

FIG. 50 illustrates a rear view of a preferred exemplary embodiment of a test lens fixture (TLF) useful in some preferred embodiments of the present invention;

FIG. 51 illustrates a left side view of a preferred exemplary embodiment of a test lens fixture (TLF) useful in some preferred embodiments of the present invention;

FIG. 52 illustrates a right side view of a preferred exemplary embodiment of a test lens fixture (TLF) useful in some preferred embodiments of the present invention;

FIG. 53 illustrates a top view of a preferred exemplary embodiment of a test lens fixture (TLF) useful in some preferred embodiments of the present invention;

FIG. 54 illustrates a bottom view of a preferred exemplary embodiment of a test lens fixture (TLF) useful in some preferred embodiments of the present invention;

FIG. 55 illustrates a front top perspective view of a preferred exemplary embodiment of a test lens fixture (TLF) useful in some preferred embodiments of the present invention;

FIG. 56 illustrates a rear top perspective view of a preferred exemplary embodiment of a test lens fixture (TLF) useful in some preferred embodiments of the present invention;

FIG. 57 illustrates a front right top perspective view of a preferred exemplary embodiment of a test lens fixture (TLF) useful in some preferred embodiments of the present invention;

FIG. 58 illustrates a rear right top perspective view of a preferred exemplary embodiment of a test lens fixture (TLF) useful in some preferred embodiments of the present invention;

FIG. 59 illustrates a rear left top perspective view of a preferred exemplary embodiment of a test lens fixture (TLF) useful in some preferred embodiments of the present invention;

FIG. 60 illustrates a front left top perspective view of a preferred exemplary embodiment of a test lens fixture (TLF) useful in some preferred embodiments of the present invention;

FIG. 61 illustrates a front right bottom perspective view of a preferred exemplary embodiment of a test lens fixture (TLF) useful in some preferred embodiments of the present invention;

FIG. 62 illustrates a rear right bottom perspective view of a preferred exemplary embodiment of a test lens fixture (TLF) useful in some preferred embodiments of the present invention;

FIG. 63 illustrates a rear left bottom perspective view of a preferred exemplary embodiment of a test lens fixture (TLF) useful in some preferred embodiments of the present invention;

FIG. 64 illustrates a front left bottom perspective view of a preferred exemplary embodiment of a test lens fixture (TLF) useful in some preferred embodiments of the present invention;

FIG. 65 illustrates a front view of a preferred exemplary embodiment of a lens cassette fixture (LCF)/lens under test fixture (LUF) useful in some preferred embodiments of the present invention;

FIG. 66 illustrates a rear view of a preferred exemplary embodiment of a lens cassette fixture (LCF)/lens under test fixture (LUF) useful in some preferred embodiments of the present invention;

FIG. 67 illustrates a left side view of a preferred exemplary embodiment of a lens cassette fixture (LCF)/lens under test fixture (LUF) useful in some preferred embodiments of the present invention;

FIG. 68 illustrates a right side view of a preferred exemplary embodiment of a lens cassette fixture (LCF)/lens under test fixture (LUF) useful in some preferred embodiments of the present invention;

FIG. 69 illustrates a top view of a preferred exemplary embodiment of a lens cassette fixture (LCF)/lens under test fixture (LUF) useful in some preferred embodiments of the present invention;

FIG. 70 illustrates a bottom view of a preferred exemplary embodiment of a lens cassette fixture (LCF)/lens under test fixture (LUF) useful in some preferred embodiments of the present invention;

FIG. 71 illustrates a front top perspective top side section view of a preferred exemplary embodiment of a lens cassette fixture (LCF)/lens under test fixture (LUF) useful in some preferred embodiments of the present invention;

FIG. 72 illustrates a front top perspective right side section view of a preferred exemplary embodiment of a lens cassette fixture (LCF)/lens under test fixture (LUF) useful in some preferred embodiments of the present invention;

FIG. 73 illustrates a front right top perspective view of a preferred exemplary embodiment of a lens cassette fixture (LCF)/lens under test fixture (LUF) useful in some preferred embodiments of the present invention;

FIG. 74 illustrates a rear right top perspective view of a preferred exemplary embodiment of a lens cassette fixture (LCF)/lens under test fixture (LUF) useful in some preferred embodiments of the present invention;

FIG. 75 illustrates a rear left top perspective view of a preferred exemplary embodiment of a lens cassette fixture (LCF)/lens under test fixture (LUF) useful in some preferred embodiments of the present invention;

FIG. 76 illustrates a front left top perspective view of a preferred exemplary embodiment of a lens cassette fixture (LCF)/lens under test fixture (LUF) useful in some preferred embodiments of the present invention;

FIG. 77 illustrates a front right bottom perspective view of a preferred exemplary embodiment of a lens cassette fixture (LCF)/lens under test fixture (LUF) useful in some preferred embodiments of the present invention;

FIG. 78 illustrates a rear right bottom perspective view of a preferred exemplary embodiment of a lens cassette fixture (LCF)/lens under test fixture (LUF) useful in some preferred embodiments of the present invention;

FIG. 79 illustrates a rear left bottom perspective view of a preferred exemplary embodiment of a lens cassette fixture (LCF)/lens under test fixture (LUF) useful in some preferred embodiments of the present invention;

FIG. 80 illustrates a front left bottom perspective view of a preferred exemplary embodiment of a lens cassette fixture (LCF)/lens under test fixture (LUF) useful in some preferred embodiments of the present invention;

FIG. 81 illustrates a front view of a preferred exemplary embodiment of an axial positioning platform (APP) useful in some preferred embodiments of the present invention;

FIG. 82 illustrates a rear view of a preferred exemplary embodiment of an axial positioning platform (APP) useful in some preferred embodiments of the present invention;

FIG. 83 illustrates a left side view of a preferred exemplary embodiment of an axial positioning platform (APP) useful in some preferred embodiments of the present invention;

FIG. 84 illustrates a right side view of a preferred exemplary embodiment of an axial positioning platform (APP) useful in some preferred embodiments of the present invention;

FIG. 85 illustrates a top view of a preferred exemplary embodiment of an axial positioning platform (APP) useful in some preferred embodiments of the present invention;

FIG. 86 illustrates a bottom view of a preferred exemplary embodiment of an axial positioning platform (APP) useful in some preferred embodiments of the present invention;

FIG. 87 illustrates a front top perspective view of a preferred exemplary embodiment of an axial positioning platform (APP) useful in some preferred embodiments of the present invention;

FIG. 88 illustrates a front bottom perspective view of a preferred exemplary embodiment of an axial positioning platform (APP) useful in some preferred embodiments of the present invention;

FIG. 89 illustrates a front right top perspective view of a preferred exemplary embodiment of an axial positioning platform (APP) useful in some preferred embodiments of the present invention;

FIG. 90 illustrates a rear right top perspective view of a preferred exemplary embodiment of an axial positioning platform (APP) useful in some preferred embodiments of the present invention;

FIG. 91 illustrates a rear left top perspective view of a preferred exemplary embodiment of an axial positioning platform (APP) useful in some preferred embodiments of the present invention;

FIG. 92 illustrates a front left top perspective view of a preferred exemplary embodiment of an axial positioning platform (APP) useful in some preferred embodiments of the present invention;

FIG. 93 illustrates a front right bottom perspective view of a preferred exemplary embodiment of an axial positioning platform (APP) useful in some preferred embodiments of the present invention;

FIG. 94 illustrates a rear right bottom perspective view of a preferred exemplary embodiment of an axial positioning platform (APP) useful in some preferred embodiments of the present invention;

FIG. 95 illustrates a rear left bottom perspective view of a preferred exemplary embodiment of an axial positioning platform (APP) useful in some preferred embodiments of the present invention;

FIG. 96 illustrates a front left bottom perspective view of a preferred exemplary embodiment of an axial positioning platform (APP) useful in some preferred embodiments of the present invention;

FIG. 97 illustrates a front right top perspective view of a preferred exemplary embodiment of an axial positioning platform (APP) with axial support platform (ASP) removed that is useful in some preferred embodiments of the present invention;

FIG. 98 illustrates a rear right top perspective view of a preferred exemplary embodiment of an axial positioning platform (APP) with axial support platform (ASP) removed that is useful in some preferred embodiments of the present invention;

FIG. 99 illustrates a rear left top perspective view of a preferred exemplary embodiment of an axial positioning platform (APP) with axial support platform (ASP) removed that is useful in some preferred embodiments of the present invention;

FIG. 100 illustrates a front left top perspective view of a preferred exemplary embodiment of an axial positioning platform (APP) with axial support platform (ASP) removed that is useful in some preferred embodiments of the present invention;

FIG. 101 illustrates a front right top perspective front side section view of an axial positioning platform (APP) useful in some preferred embodiments of the present invention;

FIG. 102 illustrates a front right bottom perspective front side section view of a preferred exemplary embodiment of an axial positioning platform (APP) useful in some preferred embodiments of the present invention;

FIG. 103 illustrates a front right top perspective right side section view of a preferred exemplary embodiment of an axial positioning platform (APP) useful in some preferred embodiments of the present invention; and

FIG. 104 illustrates a front right bottom perspective right side section view of a preferred exemplary embodiment of an axial positioning platform (APP) useful in some preferred embodiments of the present invention.

FIG. 105 illustrates a front view of a preferred exemplary embodiment of a micrometer-based longitudinal axis positioning platform (LAP) useful in some preferred embodiments of the present invention;

FIG. 106 illustrates a rear view of a preferred exemplary embodiment of a micrometer-based longitudinal axis positioning platform (LAP) useful in some preferred embodiments of the present invention;

FIG. 107 illustrates a left side view of a preferred exemplary embodiment of a micrometer-based longitudinal axis positioning platform (LAP) useful in some preferred embodiments of the present invention;

FIG. 108 illustrates a right side view of a preferred exemplary embodiment of a micrometer-based longitudinal axis positioning platform (LAP) useful in some preferred embodiments of the present invention;

FIG. 109 illustrates a top view of a preferred exemplary embodiment of a micrometer-based longitudinal axis positioning platform (LAP) useful in some preferred embodiments of the present invention;

FIG. 110 illustrates a bottom view of a preferred exemplary embodiment of a micrometer-based longitudinal axis positioning platform (LAP) useful in some preferred embodiments of the present invention;

FIG. 111 illustrates a front top perspective view of a preferred exemplary embodiment of a micrometer-based longitudinal axis positioning platform (LAP) useful in some preferred embodiments of the present invention;

FIG. 112 illustrates a front bottom perspective view of a preferred exemplary embodiment of a micrometer-based longitudinal axis positioning platform (LAP) useful in some preferred embodiments of the present invention;

FIG. 113 illustrates a front right top perspective view of a preferred exemplary embodiment of a micrometer-based longitudinal axis positioning platform (LAP) useful in some preferred embodiments of the present invention;

FIG. 114 illustrates a rear right top perspective view of a preferred exemplary embodiment of a micrometer-based longitudinal axis positioning platform (LAP) useful in some preferred embodiments of the present invention;

FIG. 115 illustrates a rear left top perspective view of a preferred exemplary embodiment of a micrometer-based longitudinal axis positioning platform (LAP) useful in some preferred embodiments of the present invention;

FIG. 116 illustrates a front left top perspective view of a preferred exemplary embodiment of a micrometer-based longitudinal axis positioning platform (LAP) useful in some preferred embodiments of the present invention;

FIG. 117 illustrates a front right bottom perspective view of a preferred exemplary embodiment of a micrometer-based longitudinal axis positioning platform (LAP) useful in some preferred embodiments of the present invention;

FIG. 118 illustrates a rear right bottom perspective view of a preferred exemplary embodiment of a micrometer-based longitudinal axis positioning platform (LAP) useful in some preferred embodiments of the present invention;

FIG. 119 illustrates a rear left bottom perspective view of a preferred exemplary embodiment of a micrometer-based longitudinal axis positioning platform (LAP) useful in some preferred embodiments of the present invention;

FIG. 120 illustrates a front left bottom perspective view of a preferred exemplary embodiment of a micrometer-based longitudinal axis positioning platform (LAP) useful in some preferred embodiments of the present invention;

FIG. 121 illustrates a front right top perspective view of a preferred exemplary embodiment of a micrometer-based longitudinal axis positioning platform (LAP) with top movable surface (TMS) removed that is useful in some preferred embodiments of the present invention;

FIG. 122 illustrates a rear right top perspective view of a preferred exemplary embodiment of a micrometer-based longitudinal axis positioning platform (LAP) with top movable surface (TMS) removed that is useful in some preferred embodiments of the present invention;

FIG. 123 illustrates a rear left top perspective view of a preferred exemplary embodiment of a micrometer-based longitudinal axis positioning platform (LAP) with top movable surface (TMS) removed that is useful in some preferred embodiments of the present invention;

FIG. 124 illustrates a front left top perspective view of a preferred exemplary embodiment of a micrometer-based longitudinal axis positioning platform (LAP) with top movable surface (TMS) removed that is useful in some preferred embodiments of the present invention;

FIG. 125 illustrates a front right top perspective front side section view of a preferred exemplary embodiment of a micrometer-based longitudinal axis positioning platform (LAP) useful in some preferred embodiments of the present invention;

FIG. 126 illustrates a front right bottom perspective front side section view of a preferred exemplary embodiment of a micrometer-based longitudinal axis positioning platform (LAP) useful in some preferred embodiments of the present invention;

FIG. 127 illustrates a front right top perspective right side section view of a preferred exemplary embodiment of a micrometer-based longitudinal axis positioning platform (LAP) useful in some preferred embodiments of the present invention;

FIG. 128 illustrates a front right bottom perspective right side section view of a preferred exemplary embodiment of a micrometer-based longitudinal axis positioning platform (LAP) useful in some preferred embodiments of the present invention;

FIG. 129 illustrates a system block diagram depicting a preferred exemplary system embodiment of the present invention in which the APP is not included;

FIG. 130 illustrates a front right top perspective view of a preferred exemplary system embodiment of the present invention in which the APP is not included;

FIG. 131 illustrates a rear right top perspective view of a preferred exemplary system embodiment of the present invention in which the APP is not included;

FIG. 132 illustrates a rear left top perspective view of a preferred exemplary system embodiment of the present invention in which the APP is not included;

FIG. 133 illustrates a front left top perspective view of a preferred exemplary system embodiment of the present invention in which the APP is not included;

FIG. 134 illustrates a front right bottom perspective view of a preferred exemplary system embodiment of the present invention in which the APP is not included;

FIG. 135 illustrates a rear right bottom perspective view of a preferred exemplary system embodiment of the present invention in which the APP is not included;

FIG. 136 illustrates a rear left bottom perspective view of a preferred exemplary system embodiment of the present invention in which the APP is not included;

FIG. 137 illustrates a system block diagram depicting a preferred exemplary system embodiment of the present invention in which the APP+PLF+PLO are not included;

FIG. 138 illustrates a front right top perspective view of a preferred exemplary system embodiment of the present invention in which the APP+PLF+PLO are not included;

FIG. 139 illustrates a rear right top perspective view of a preferred exemplary system embodiment of the present invention in which the APP+PLF+PLO are not included;

FIG. 140 illustrates a rear left top perspective view of a preferred exemplary system embodiment of the present invention in which the APP+PLF+PLO are not included;

FIG. 141 illustrates a front left top perspective view of a preferred exemplary system embodiment of the present invention in which the APP+PLF+PLO are not included;

FIG. 142 illustrates a front right bottom perspective view of a preferred exemplary system embodiment of the present invention in which the APP+PLF+PLO are not included;

FIG. 143 illustrates a rear right bottom perspective view of a preferred exemplary system embodiment of the present invention in which the APP+PLF+PLO are not included;

FIG. 144 illustrates a rear left bottom perspective view of a preferred exemplary system embodiment of the present invention in which the APP+PLF+PLO are not included;

FIG. 145 illustrates a system block diagram depicting a preferred exemplary system embodiment of the present invention in which the APP+PLF+PLO+TLP are not included;

FIG. 146 illustrates a front right top perspective view of a preferred exemplary system embodiment of the present invention in which the APP+PLF+PLO+TLP are not included;

FIG. 147 illustrates a rear right top perspective view of a preferred exemplary system embodiment of the present invention in which the APP+PLF+PLO+TLP are not included;

FIG. 148 illustrates a rear left top perspective view of a preferred exemplary system embodiment of the present invention in which the APP+PLF+PLO+TLP are not included;

FIG. 149 illustrates a front left top perspective view of a preferred exemplary system embodiment of the present invention in which the APP+PLF+PLO+TLP are not included;

FIG. 150 illustrates a front right bottom perspective view of a preferred exemplary system embodiment of the present invention in which the APP+PLF+PLO+TLP are not included;

FIG. 151 illustrates a rear right bottom perspective view of a preferred exemplary system embodiment of the present invention in which the APP+PLF+PLO+TLP are not included;

FIG. 152 illustrates a rear left bottom perspective view of a preferred exemplary system embodiment of the present invention in which the APP+PLF+PLO+TLP are not included;

FIG. 153 illustrates a system block diagram depicting a preferred exemplary system embodiment of the present invention in which the APP+TLP+TLF are not included;

FIG. 154 illustrates a front right top perspective view of a preferred exemplary system embodiment of the present invention in which the APP+TLP+TLF are not included;

FIG. 155 illustrates a rear right top perspective view of a preferred exemplary system embodiment of the present invention in which the APP+TLP+TLF are not included;

FIG. 156 illustrates a rear left top perspective view of a preferred exemplary system embodiment of the present invention in which the APP+TLP+TLF are not included;

FIG. 157 illustrates a front left top perspective view of a preferred exemplary system embodiment of the present invention in which the APP+TLP+TLF are not included;

FIG. 158 illustrates a front right bottom perspective view of a preferred exemplary system embodiment of the present invention in which the APP+TLP+TLF are not included;

FIG. 159 illustrates a rear right bottom perspective view of a preferred exemplary system embodiment of the present invention in which the APP+TLP+TLF are not included;

FIG. 160 illustrates a rear left bottom perspective view of a preferred exemplary system embodiment of the present invention in which the APP+TLP+TLF are not included;

FIGS. 161-168 illustrates flowcharts depicting a number of preferred exemplary invention method embodiments useful in some preferred embodiments of the present invention.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of an OPHTHALMIC OPTICAL TESTING SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Lens Alignment Series (LAS) not Limitive

While the present invention will be described in terms of a 3-lens lens alignment series (LAS) comprising corneal lens optics (CLO), pinhole or light block device (POL), and a intraocular lens (IOL) optics, the scope of the present invention is not limited to three lenses. In some preferred embodiments not detailed herein, the LAS may incorporate a plurality of lenses positioned along a common longitudinal optical axis (LOA) pathway. Thus, the present invention is not limited in scope to a 3-lens LAS as described herein. As depicted herein, there may be a plurality of slots in which optics are retained which allow a wide variety of optical pathways along the LOA to be evaluated prior to patient surgery.

### Intraocular Lens (IOL) not Limitive

While the present invention will be described in terms of testing an intraocular lens (IOL), the present invention is not limited to this type of lens testing, and the term “intraocular lens (IOL)” should be broadly interpreted to include any type of optical lens and will generically be referred to herein as the “lens under test (LUT).”

### Pupil Lens Fixture (PLF) not Limitive

The present invention may incorporate a wide degree of construction options with respect to the pupil lens fixture (PLF) described herein. Specifically, the PLF may incorporate means for retaining a pupil lens for testing overall optical path properties and/or may incorporate a pupil pinhole/iris opening for testing purposes.

### Manual Mechanical Alignment not Limitive

The ophthalmic optical testing apparatus (OTA) described herein is detailed with mechanical adjustments for tip, tilt, rotation, corneal lens fixture (CLF) longitudinal movement, and test lens fixture (TLF) longitudinal movement that is actuated by manual mechanical means. Each of these manual mechanical alignments (as well as others that may affect the position of the lenses in the LAS along the LOA can be implemented using an electro-mechanical servo motor controlled by a digital computer control system (CCS) executing machine instructions stored on a computer-readable medium. Thus, the present invention is to be understood to have a wide variety of variants that are operated under computer control and which may be automated via execution of machine instructions stored on a computer-readable medium.

### Axial Positioning Platform (APP) not Limitive

While the axial positioning platform (APP) depicted herein is configured as a vertical axis positioning platform, the present invention is not limited to this configuration and the axis of rotation may in some preferred embodiments be horizontal or some angle between horizontal and vertical with respect to the base on which the overall optical system is mounted.

### Additional Positional Adjustments Anticipated

While the present invention allows for longitudinal positioning of a number of optical components, it is anticipated that set screws or other adjustment means may be incorporated within the lens retaining frameworks described herein to provide further adjustment to the LOA pathway optics. These adjustments may adjust the position or arrangement of the slots in the system or the inserts placed in such slots. These adjustments may impact magnification, diopter, and/or refractive properties of the overall LOA pathway.

### Testing Material/Paper not Limitive

Several preferred invention embodiments employ the use of testing material or testing material having a planar surface that is perpendicularly positioned in the path of the LOA between the TLF/IOL and the CLF/CLO. While the position of the testing material/paper is generally depicted as located between the TLF/IOL and the CLF/CLO, the present invention anticipated that the testing material/paper may be located at any position along the LOA. Additionally, while the testing material/paper is generally selected from a group consisting of: retina diffusion paper; thermal paper; heat sensitive paper; heat sensitive material; and graticule paper, the present invention is not limited to these specific testing material/paper types.

### Construction Materials not Limitive

The present invention may be manufactured using a variety of materials, including but not limited to preferred plastics, glasses, PMMAs, composite materials, syntactic materials, metals, wood, and/or combinations thereof. In at least one embodiment, many system components are manufactured from a plastic based material utilizing a three-dimensional (3D) printer. In some examples, some system components may also be manufactured from an injection mold, and/or milled from a single piece of material.

### Construction Elements not Limitive

While the present invention will be described in terms of its most complete and generalized form, it should be noted that it may be constructed with any combination of the elements described herein and that some elements will be present in some preferred embodiments and may be absent in other preferred embodiments. Thus, the combinations of elements described herein are only exemplary of some of the preferred invention embodiments and these combinations are not limitive of the scope of the claimed invention.

### Overview

There is a need for a device that allows for testing of a proposed IOL prior to the replacement of a human lens or the in-situ adjustment of a lens. For example, there is a need for a device (OTA) that is capable of modeling a human eye in a manner that can account for the size, lens shape, corneal shape, eye physiology, retina position, lens position, and/or other ophthalmic optical conditions. The OTA described herein also has the ability to test a variety of eye configurations, corneal structure, lens power, and lens shape.

### Application Context System Overview (0100)

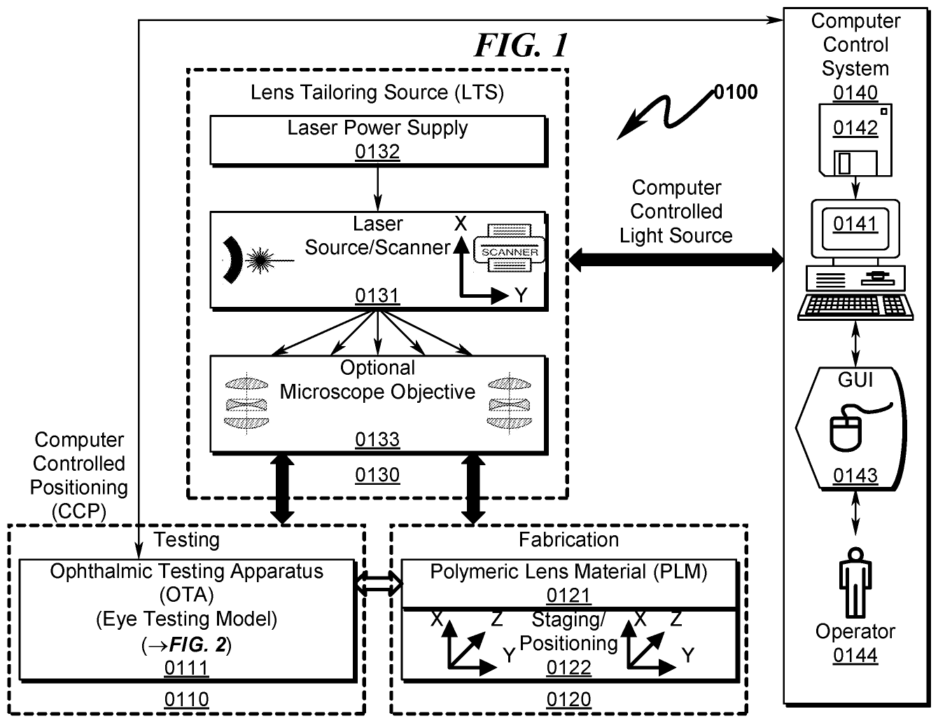

An overview of the application context for the present invention system is generally depicted in FIG. 1 (0100) wherein an eye model (0110) ophthalmic optical testing apparatus (OTA) (0111) is substituted for an actual human eye in the testing of a fabricated (0120) intraocular lens (IOL) (or lens under test (LUT)) typically comprising polymeric lens material (PLM) (0121). The fabrication (0120) process typically involves the use of a lens tailoring source (LTS) (0130) comprising a laser source/scanner (0131), laser power supply (0132) and optional microscope objective (0133). The LTS (0130) is typically under control of a computer control system (CCS) (0140) that generally includes a digital computer (0141) executing machine instructions read from a computer readable medium (0142) and receiving overall command direction from a graphical user interface (0143) under direction of a human operator (0144).

The purpose of the ophthalmic optical testing apparatus (OTA) (0111) in this application context is to verify the function of the fabricated lens (0120) and determine if the optical characteristics of the lens in combination with that of the patient's eye characteristics as modeled by the OTA are suitable for the patient prior to actual patient surgery.

### Ophthalmic Optical Testing Apparatus Overview (0200)-(0300)

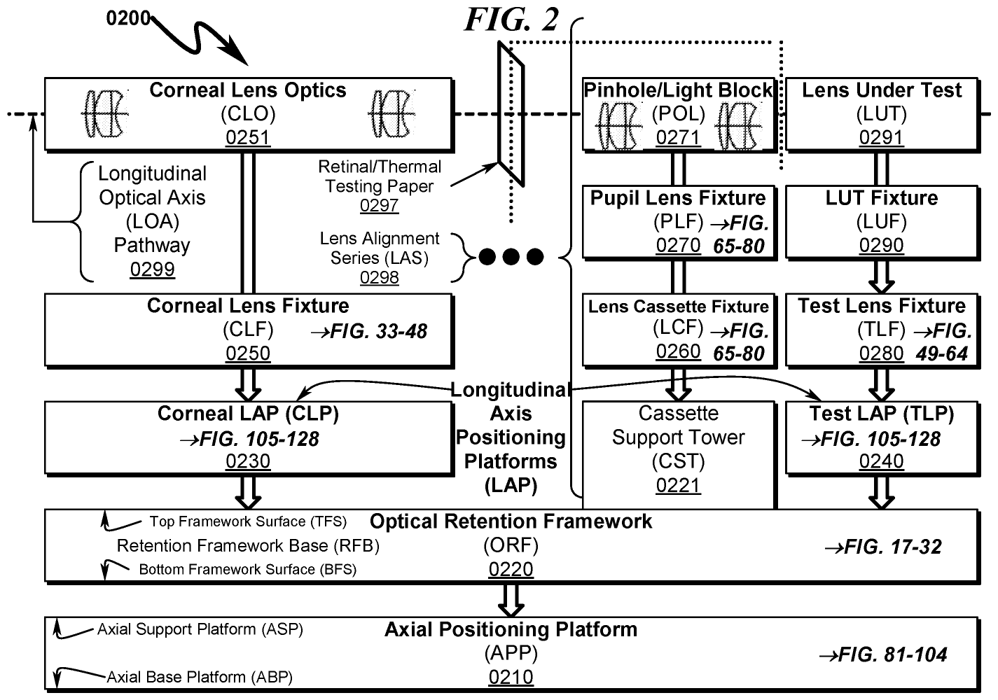

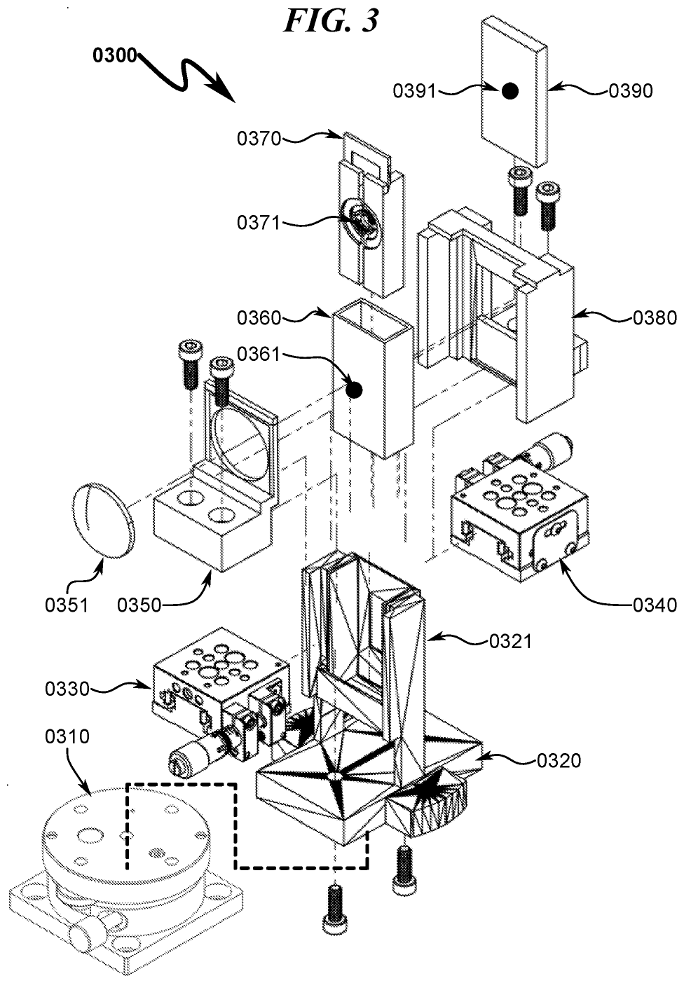

A general overview of the ophthalmic optical testing apparatus (OTA) (0111) in FIG. 1 (0100) is generally depicted in the system block diagram of FIG. 2 (0200) with an assembly view of the various components of the OTA generally depicted in FIG. 3 (0300). The OTA is typically constructed upon a stable planar surface using a base comprising an axial positioning platform (APP) (0210, 0310) that allows rotation about a vertical or horizontal axis of an optical retention framework (ORF) (0220, 0320). The ORF (0220, 0320) is mechanically mated to one or more longitudinal axis positioning platforms (LAP) (0230, 0330, 0240, 0340) referred to herein as the corneal LAP (CLP) (0230, 0330) and test LAP (0240, 0340) that allow longitudinal adjustment of lenses and other optics along a common longitudinal optical axis (LOA) (0299) pathway.

At least one LAP (0230, 0330) serves to mechanically retain a corneal lens fixture (CLF) (0250, 0350) that comprises corneal lens optics (CLO) (0251, 0351). One or more LAP (0240, 0340) serves to support a test lens fixture (TLF) (0280, 0380) that retains a lens under test fixture (LUF) (0290, 0390). The ILF (0290, 0390) supports retention of one or more intraocular lenses (IOL) or lenses under test (LUT) (0291, 0391) that may be substituted using different removable LUF (0290, 0390) structures within the overall OTA.

The ORF (0220, 0320) provides for a cassette support tower (CST) (0221, 0321) that has one or more slots that allow a lens cassette fixture (LCF) (0260, 0360) to be retained along the LOA (0299). The LCF incorporates an aperture (0361) along the LOA (0299) that in some embodiments may be adjustable. The LCF (0260, 0360) allows capture of a pupil lens fixture (PLF) (0270, 0370) that contains pinhole or light block device (POL) (0271, 0371) that mimic optical characteristics of the patient's eye. Within the context of the present invention, the CLF (0250, 0350), PLF (0270, 0370), and LUF (0290, 0390) allow replacement of the respective CLO (0251, 0351), PLF (0271, 0371), and LUF (0291, 0391) lens structures to be replaced/substituted with ease thus allowing the overall LOA (0299) pathway to be optically adjusted to mimic the overall characteristics of the patient's eye in conjunction with an IOL (0291, 0391) lens structure under test/evaluation.

Adjustment of the axial/tip/tilt position of the ORF (0220) mounted upon the APP (0210) and relative position of the CLF (0250) via the corneal LAP (CLP) (0230) in conjunction with proper selection of the LCF (0260)/TLF (0280)/IOL (0281) and adjustment of the related test LAP (0240) permit adjustment of the optical characteristics of the LOA (0299) to support a variety of pre-surgery patient testing objectives prior to committing to actual patient surgery.

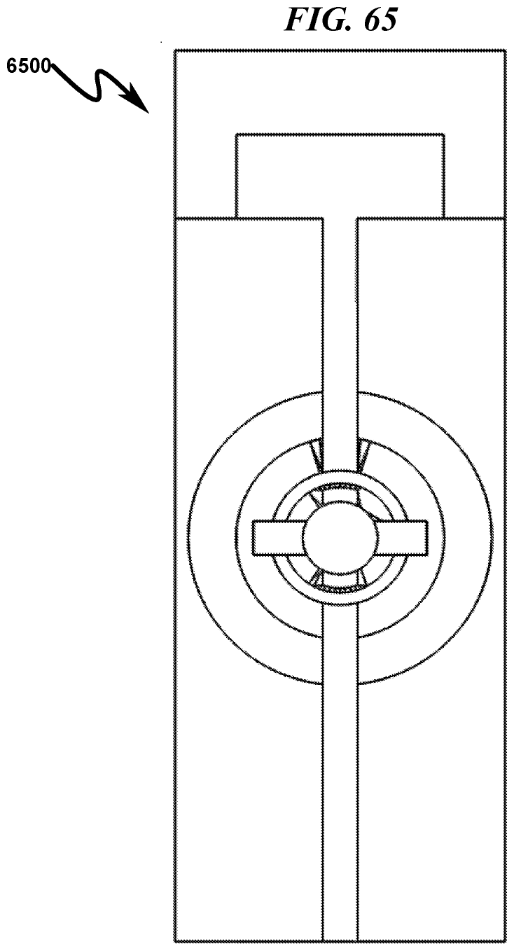

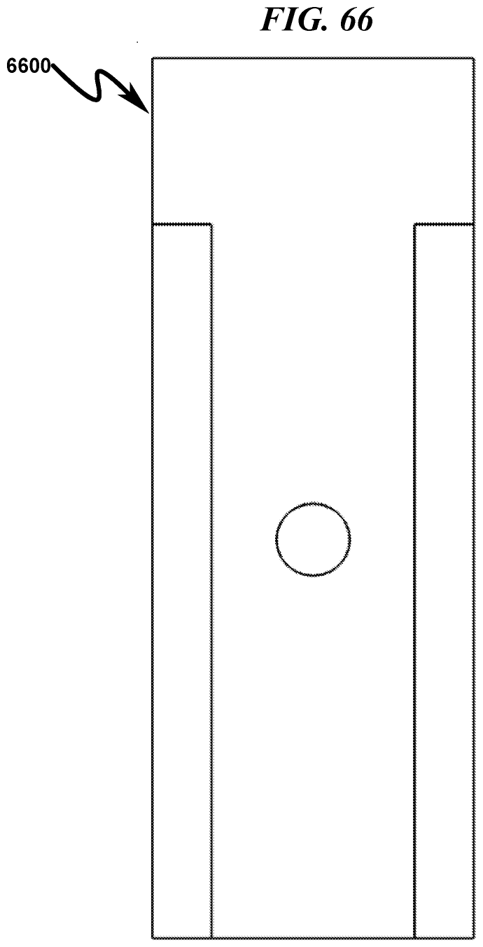

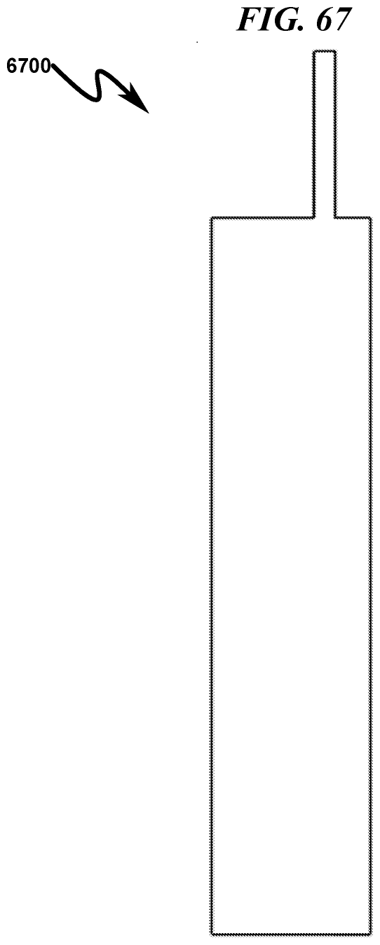

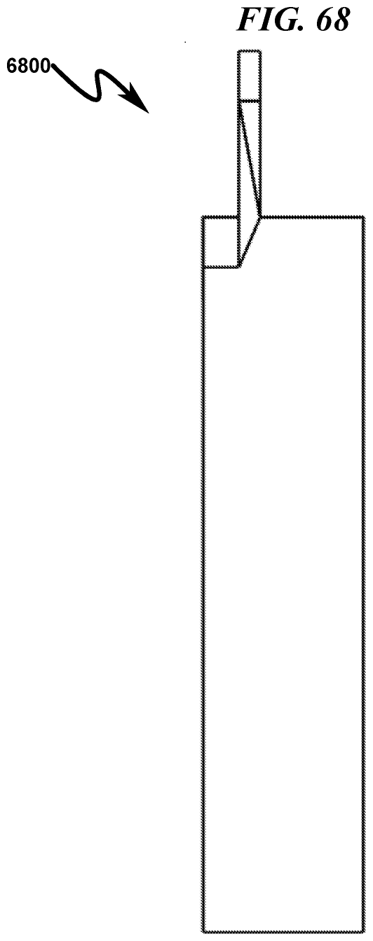

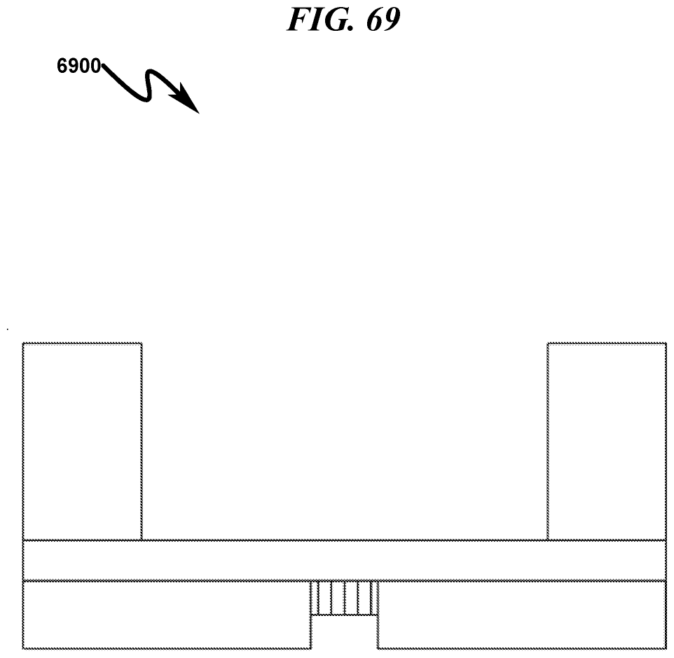

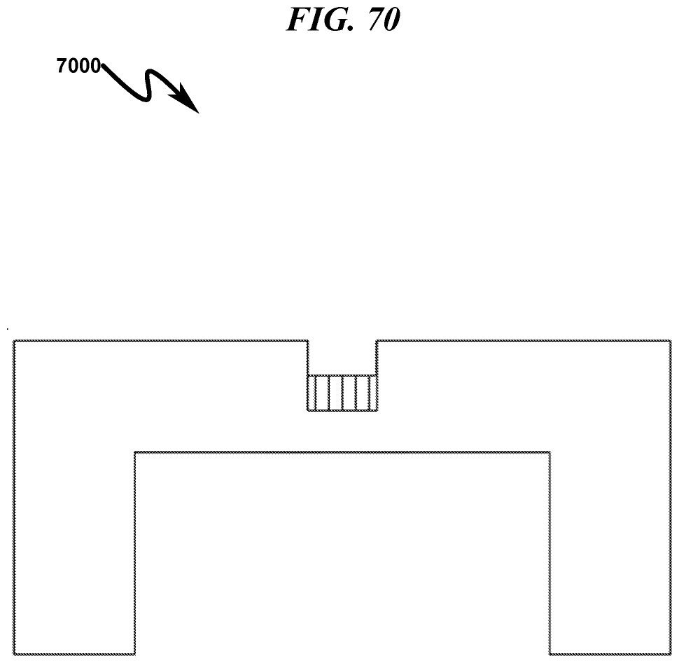

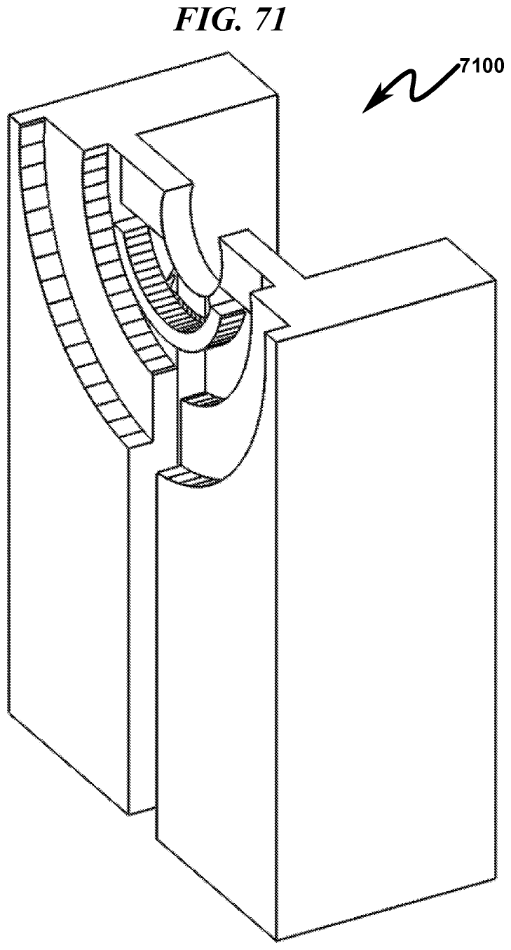

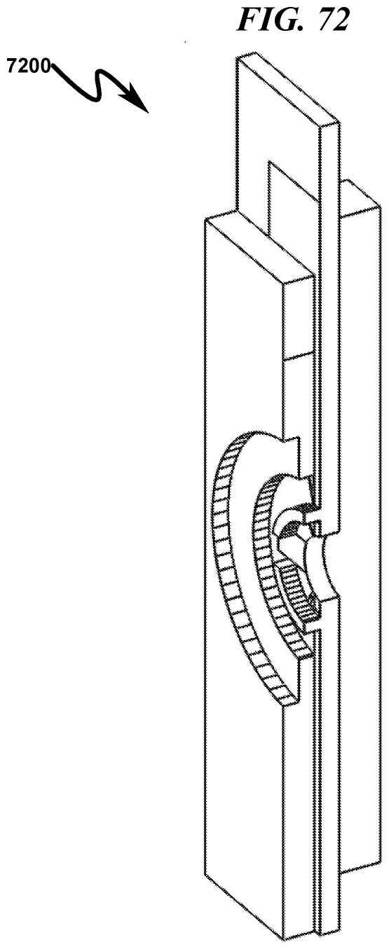

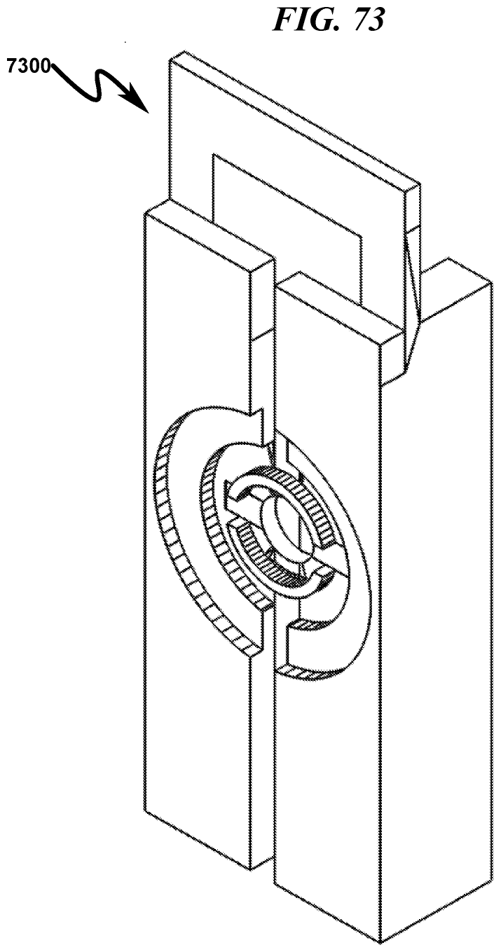

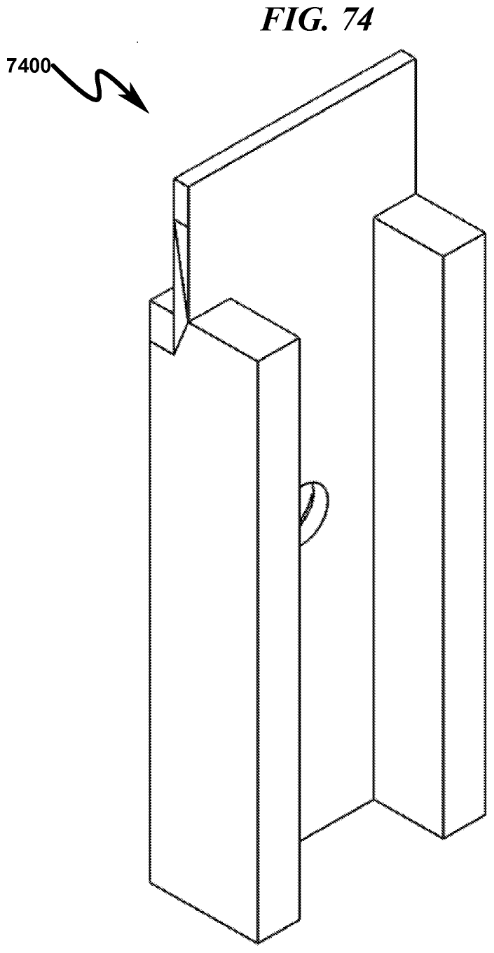

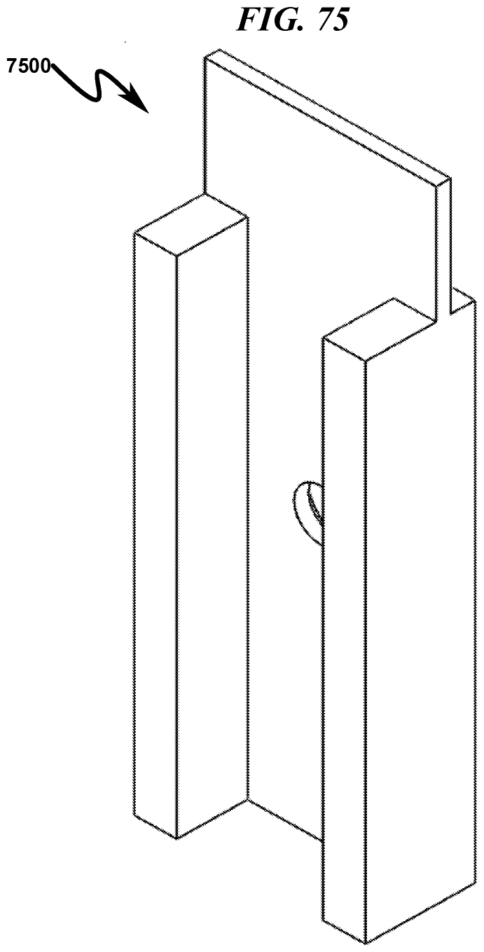

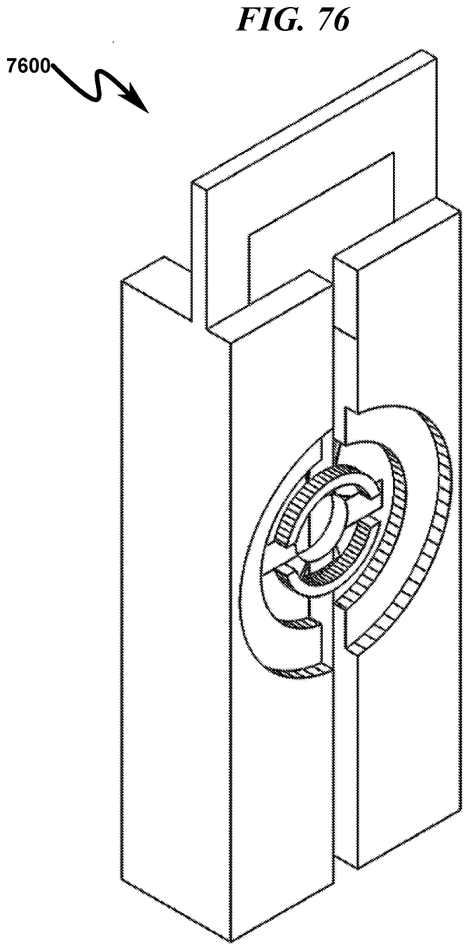

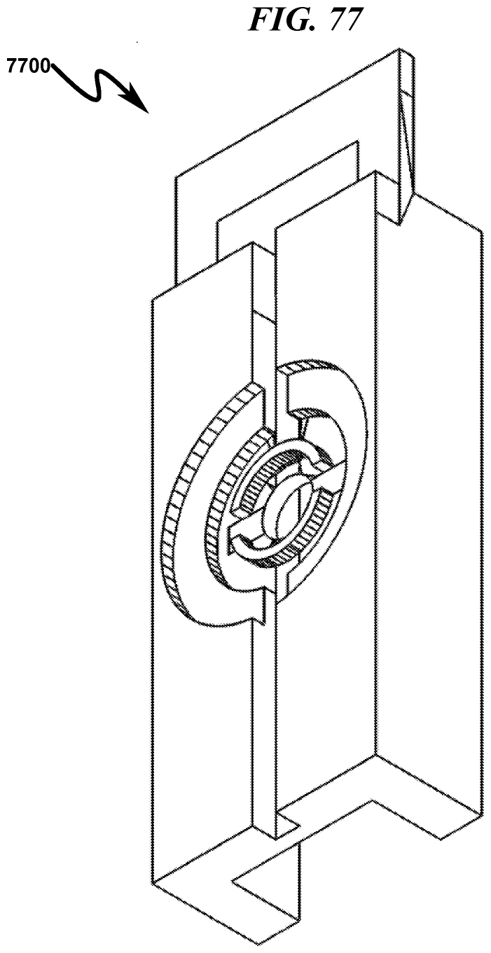

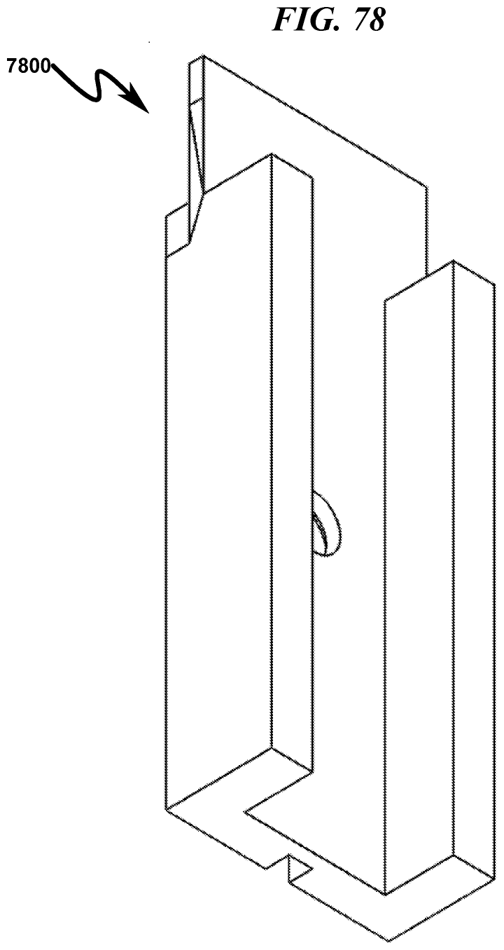

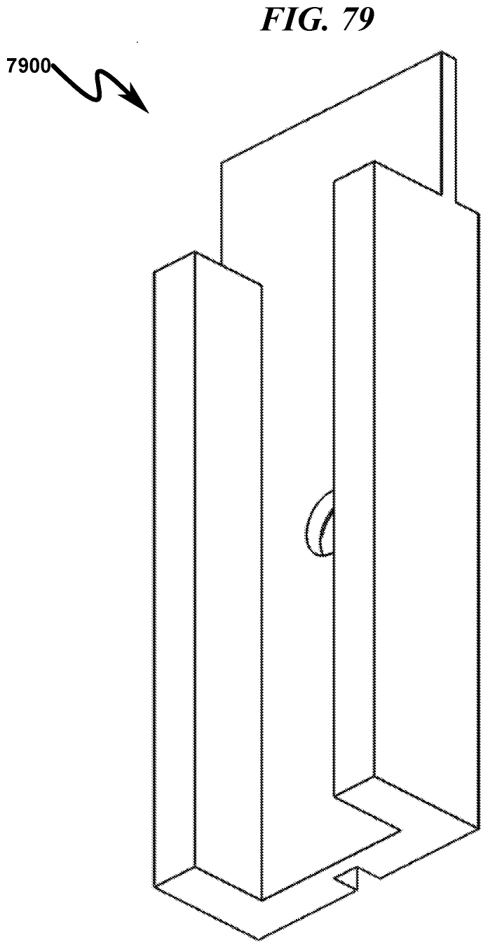

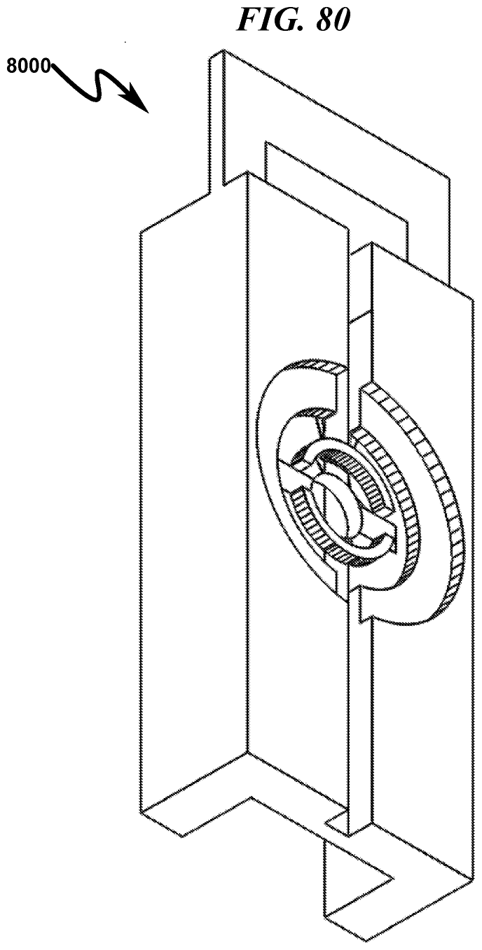

One skilled in the art will recognize that the IOL fixture (LUF) (0290, 0390) depicted in FIG. 3 (0300) may be embodied in a variety of forms to allow the positioning and substitution of an intraocular lens (IOL) (0291, 0391) within the LUF (0290, 0390) framework. As such, no additional detail of this fixture is provided herein except as to the additional detail provided in FIG. 65 (6500)-FIG. 80 (8000) which provides detail on a pupil lens fixture having a similar cassette substitution structure. One skilled in the art will no doubt realize that while FIG. 65 (6500)-FIG. 80 (8000) may be used to implement the LUF (0290, 0390), other forms of equivalent function may be substituted without departing from the scope of the claimed invention.

### Optical Testing Paper

As generally depicted in FIG. 2 (0200), different optical testing papers (0297) (retina diffusion, thermal, etc.) may optionally be inserted along the LOA to simulate the retinal position and evaluate thermal heat buildup from different procedures. The present invention allows operator training with class II and III laser devices without the need for actual patient participation and also allows for patient-safe validation of heat dissipation algorithms and safety factors by medical device manufacturers. These testing papers are shown by example and are not exhaustive of the testing papers that may be incorporated along the LOA of the present invention.

Additional testing options for the OTA may include safety tests of ophthalmic devices and facilitating safety training and testing for ophthalmologists. Allowing a different retina insert for the OTA with thermal properties matching the testing devices wavelength can permit testing of laser parameters associated with IOL customization and various Class II and Class III devices. The thermal retina inserts may also be used to test and validate Class II and Class III devices in regards of laser safety.

### Exemplary Embodiment Detail Views (0400)-(1600)

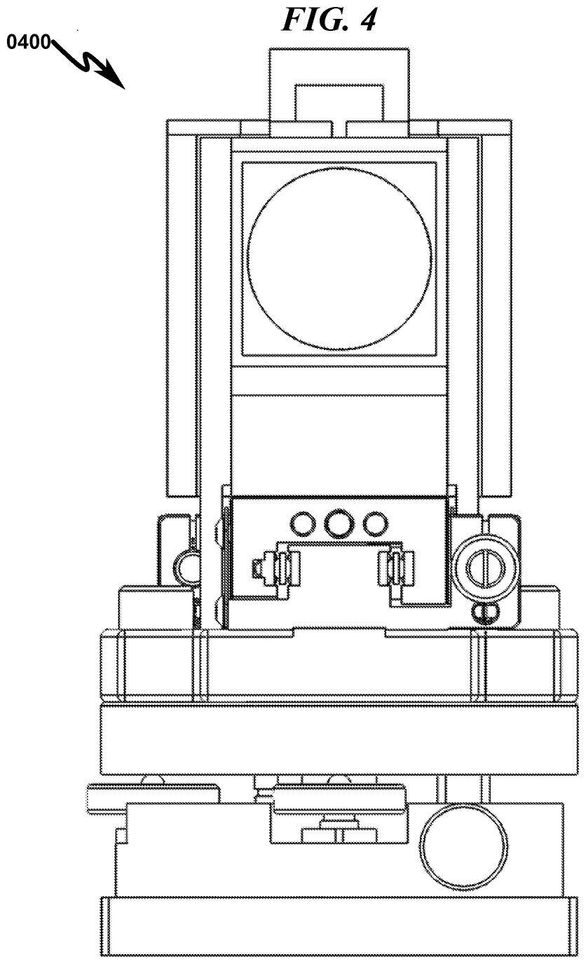

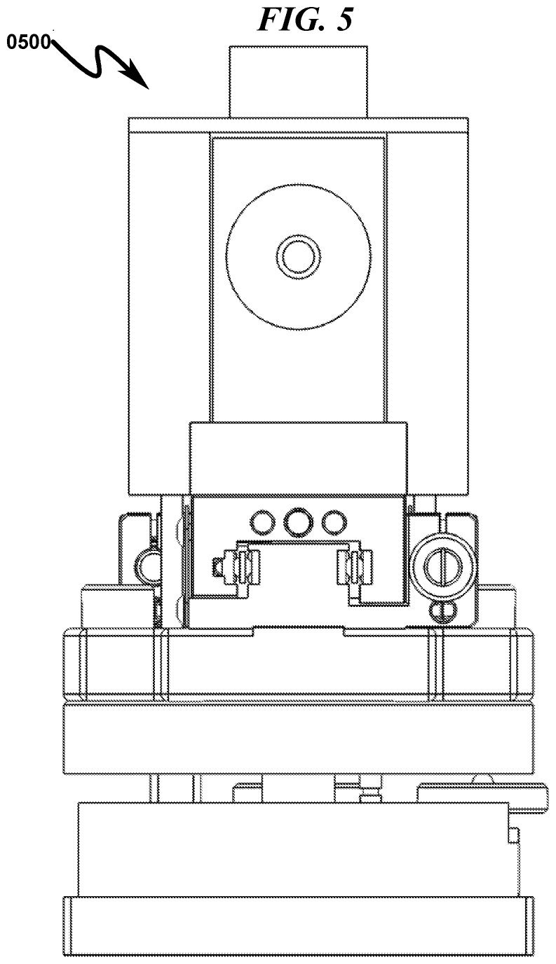

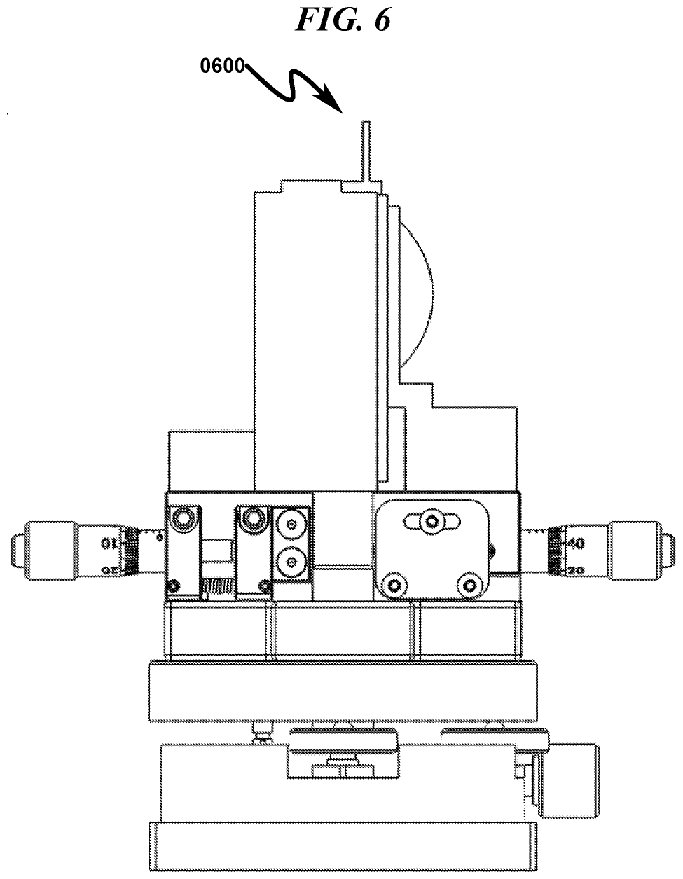

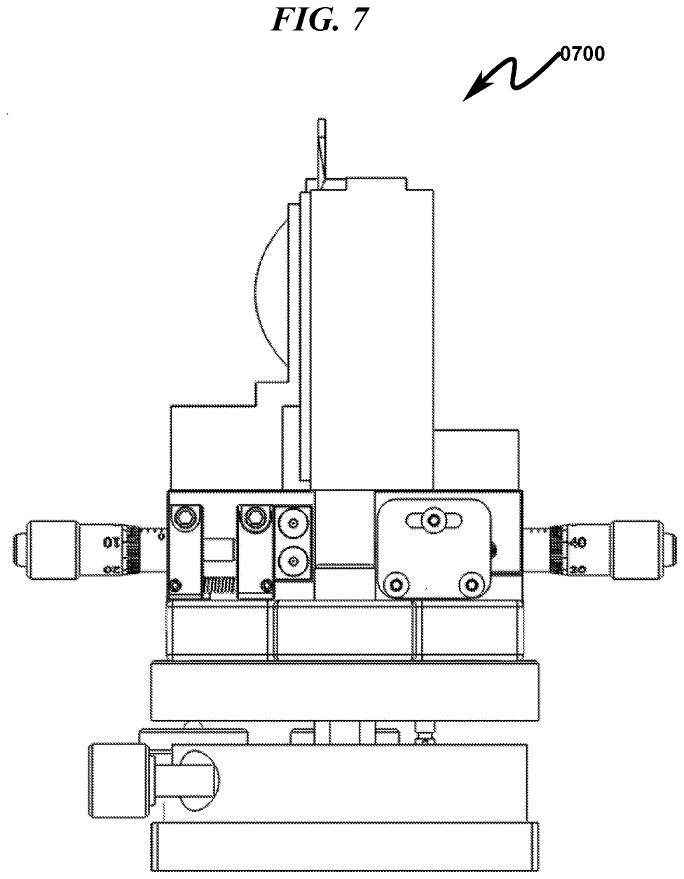

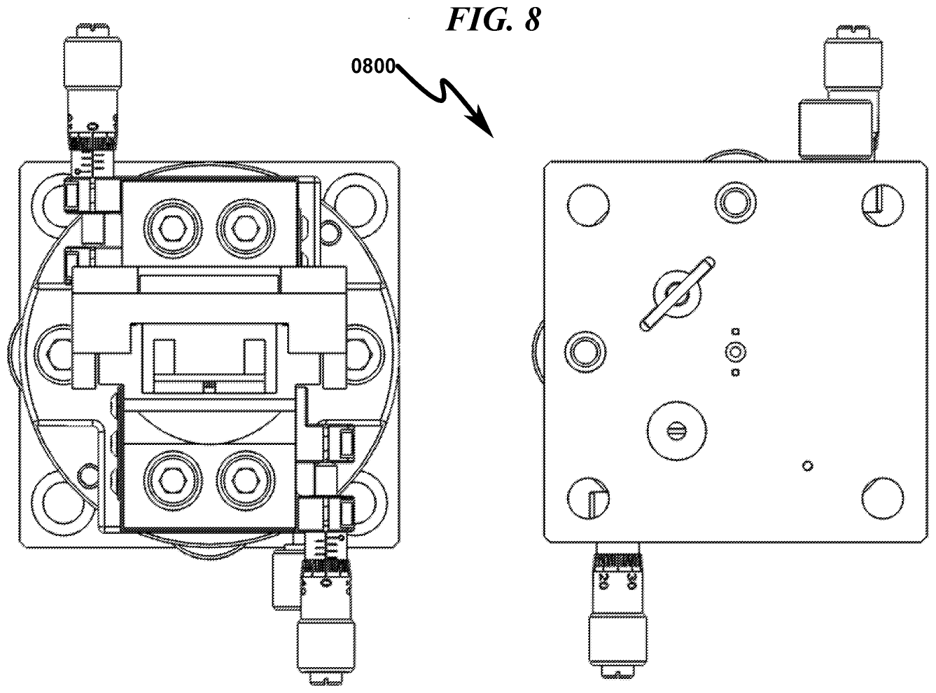

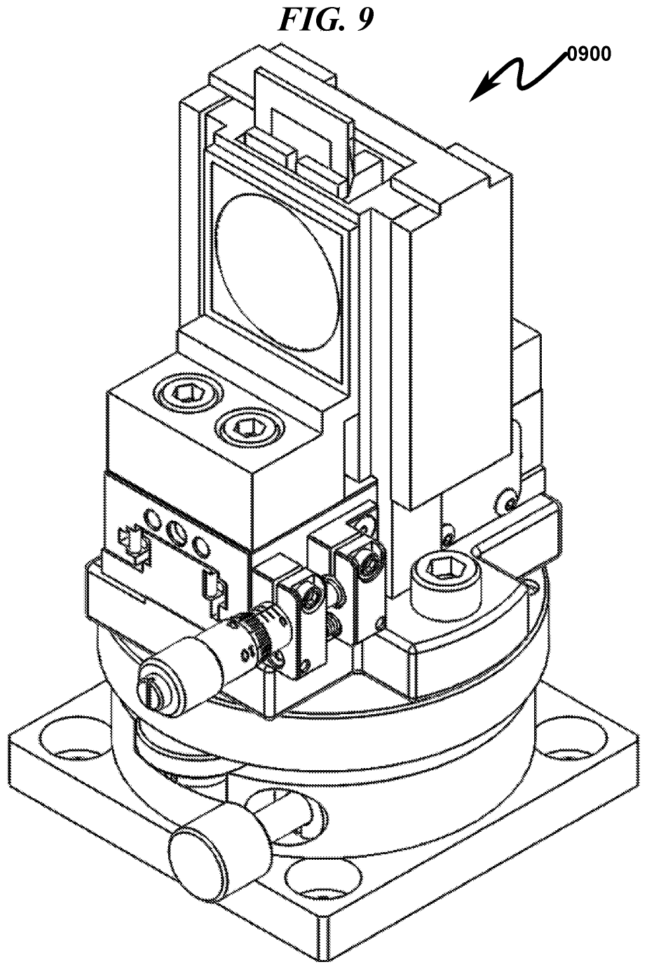

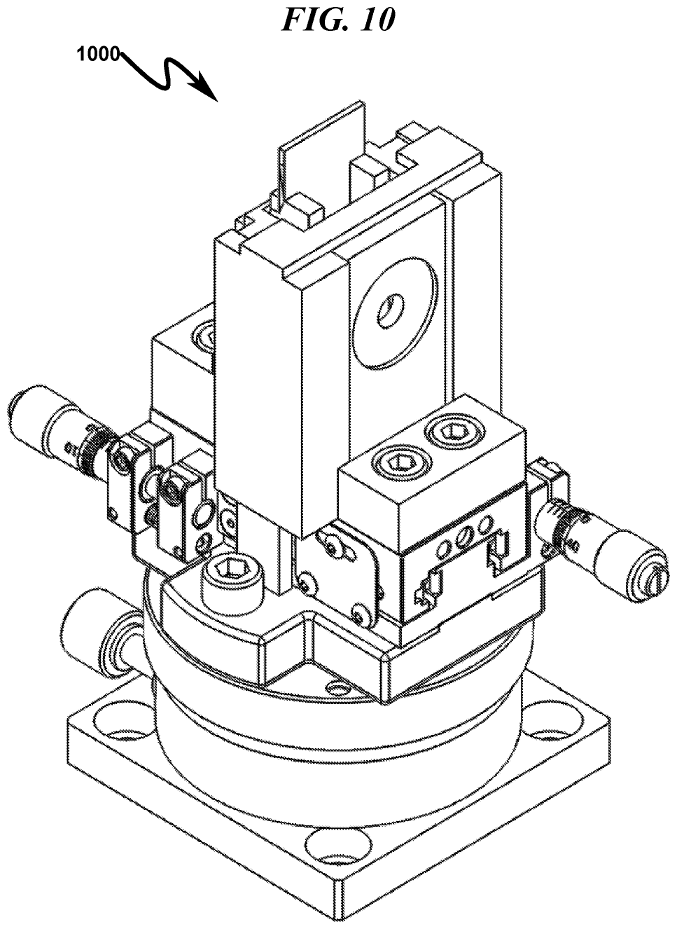

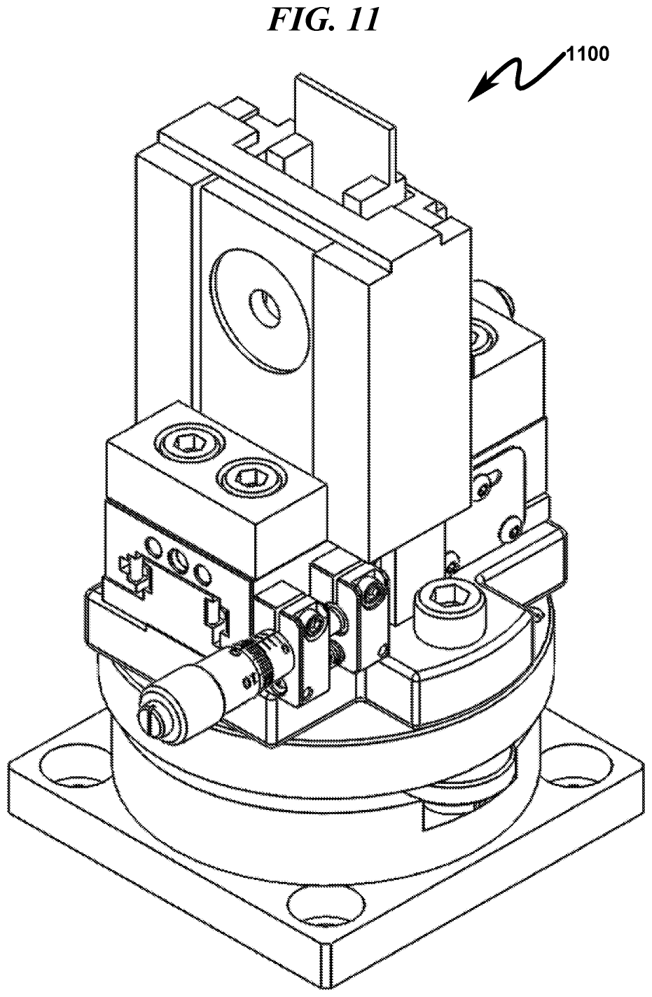

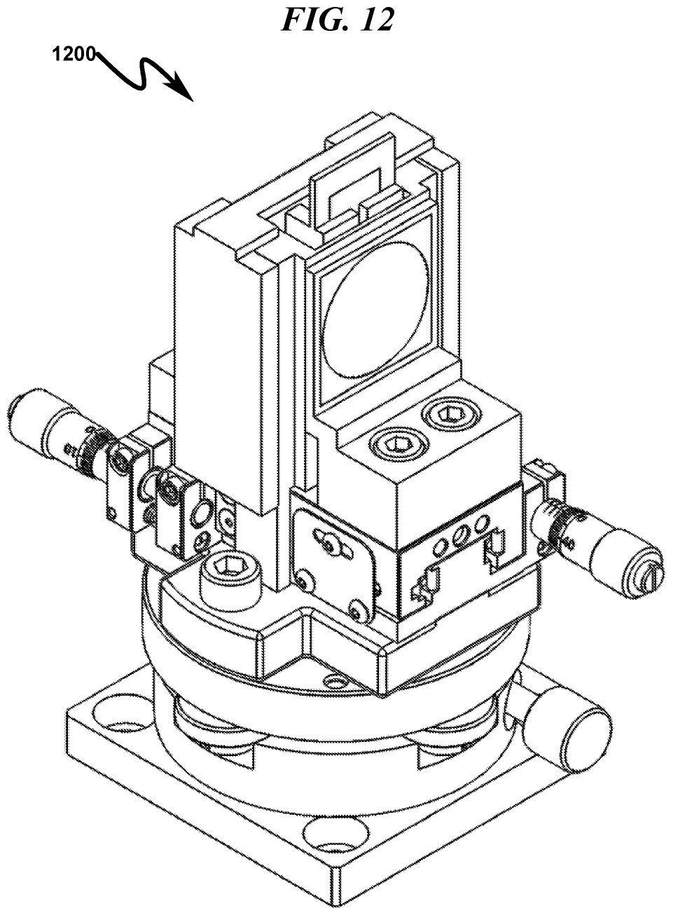

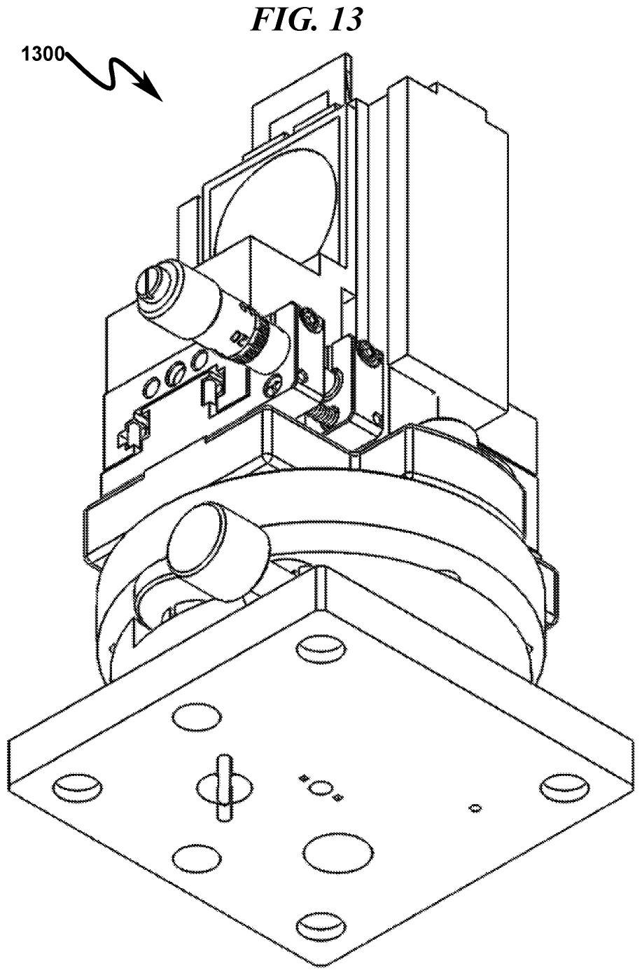

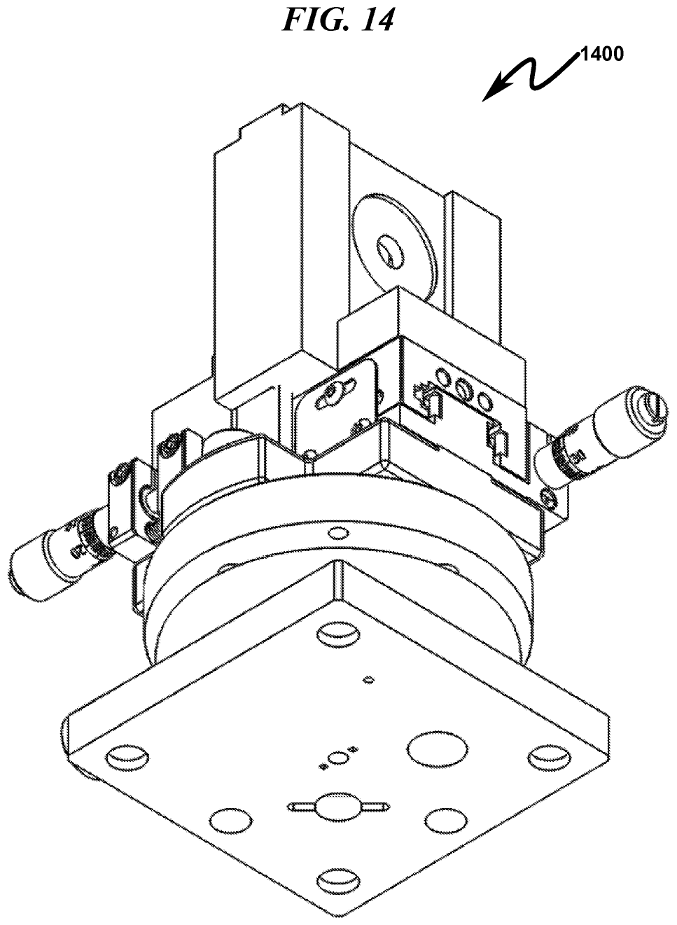

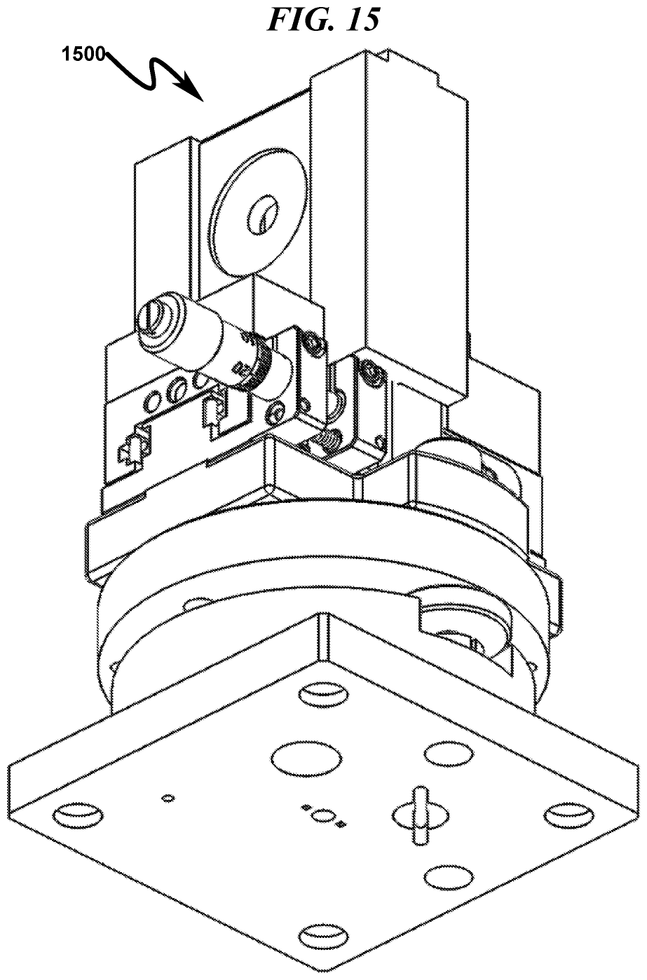

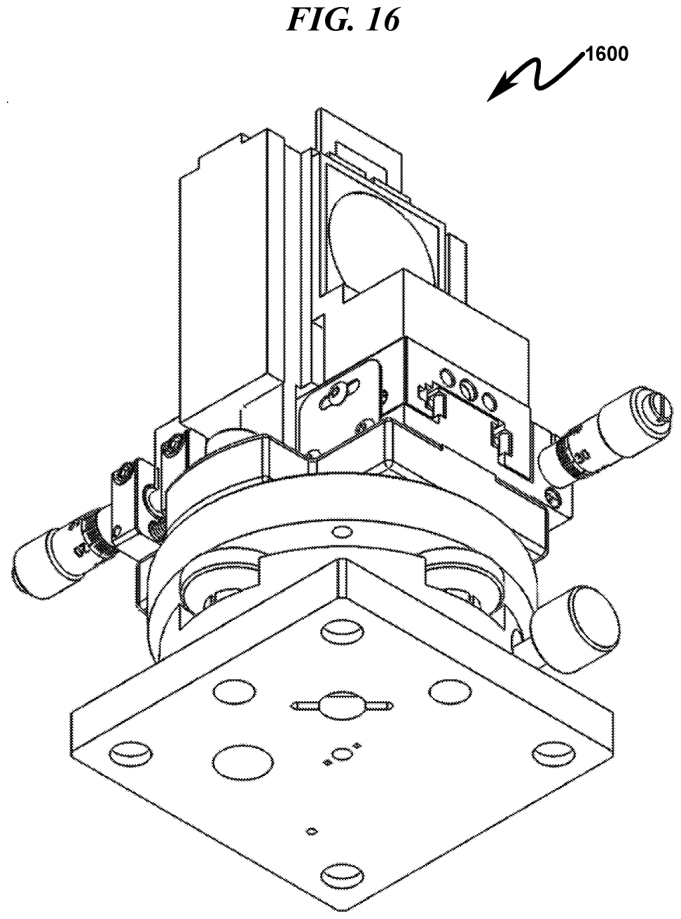

As previously discussed, an assembly view of a preferred exemplary invention embodiment is generally depicted in FIG. 3 (0300). Various assembled views of this preferred exemplary invention embodiment are generally depicted in FIG. 4 (0400)-FIG. 16 (1600).

### Optical Retention Framework (ORF) (1700)-(3200)

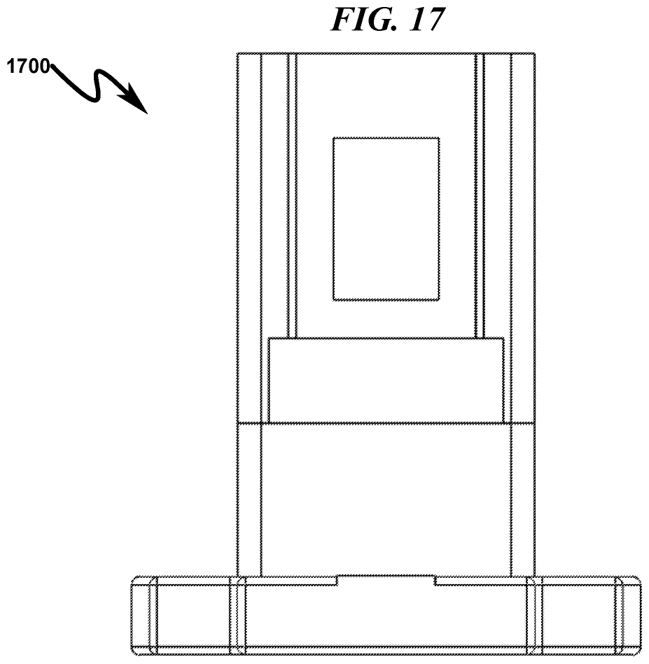

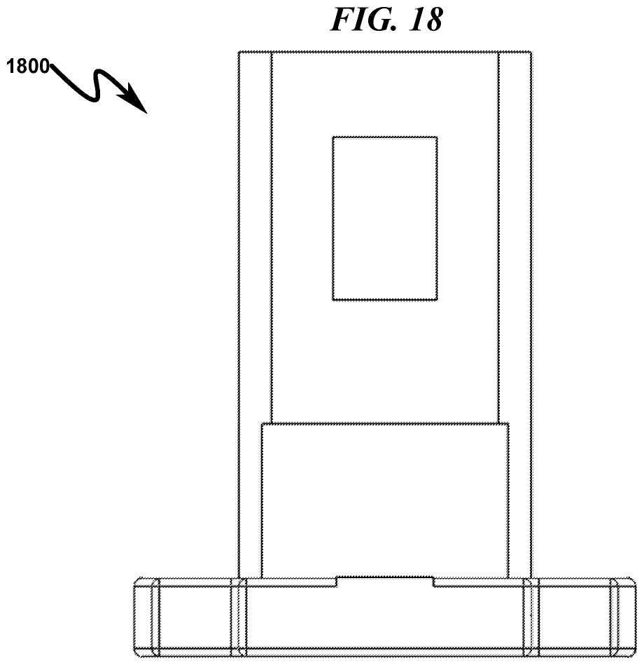

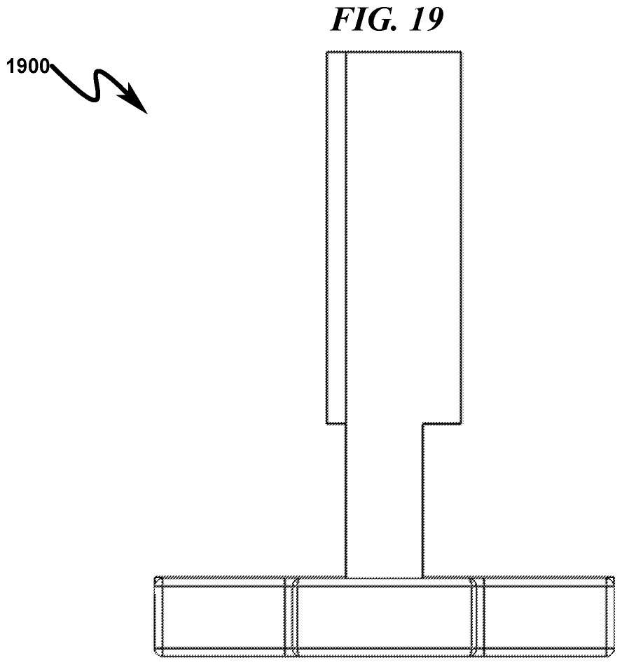

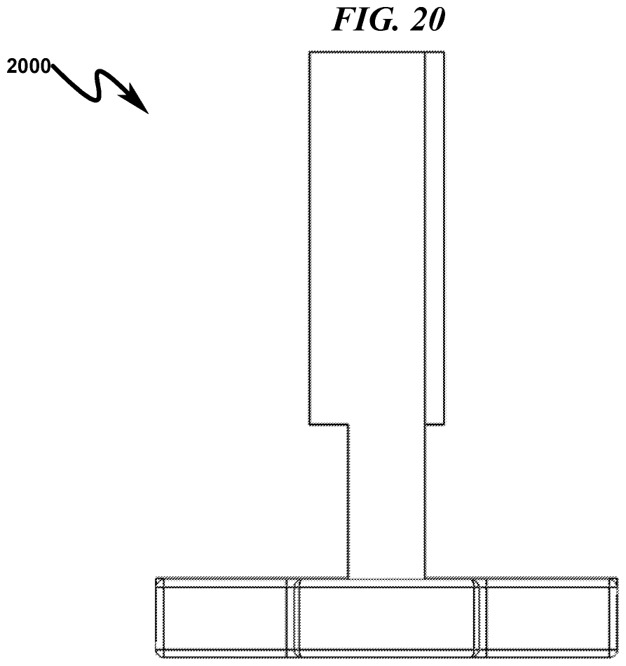

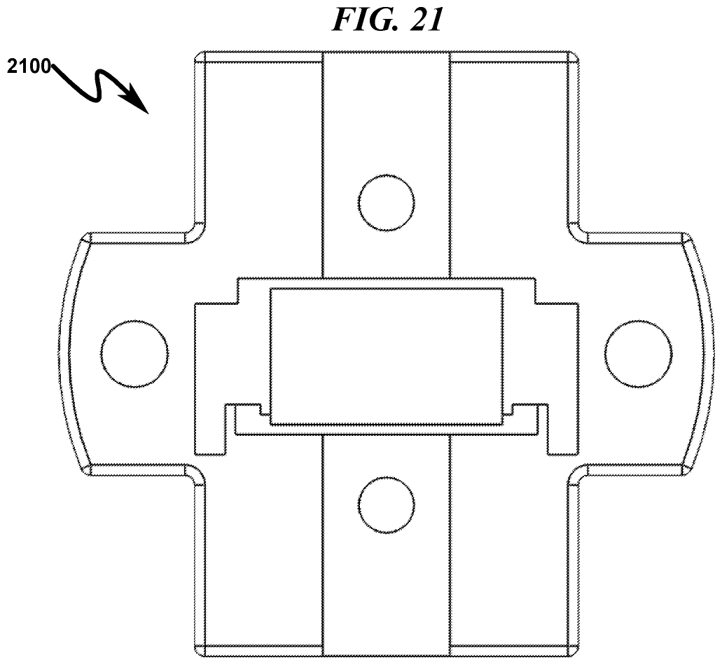

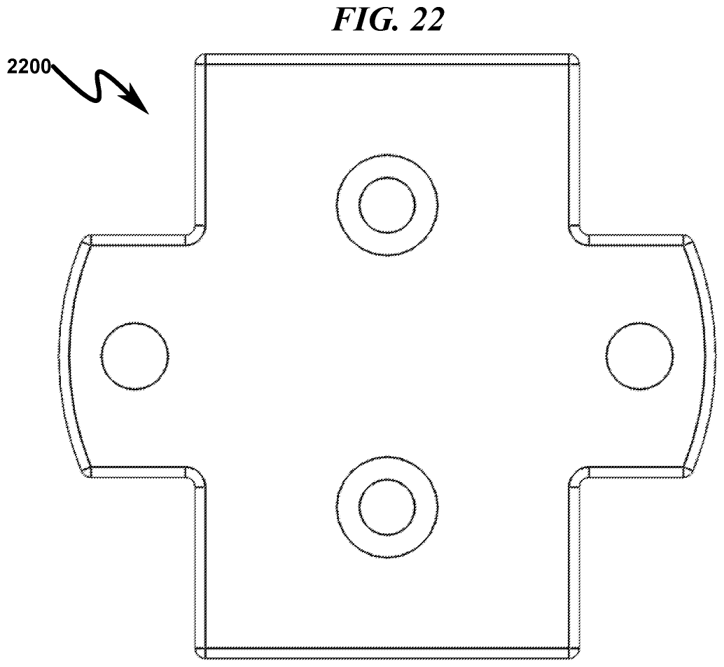

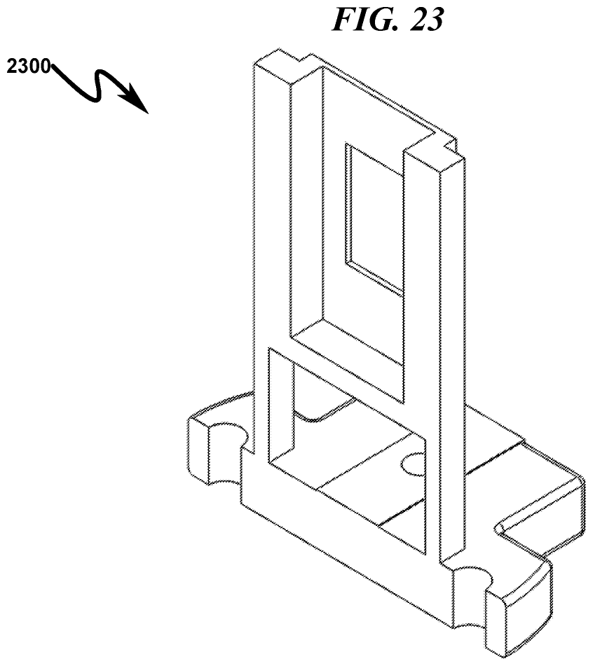

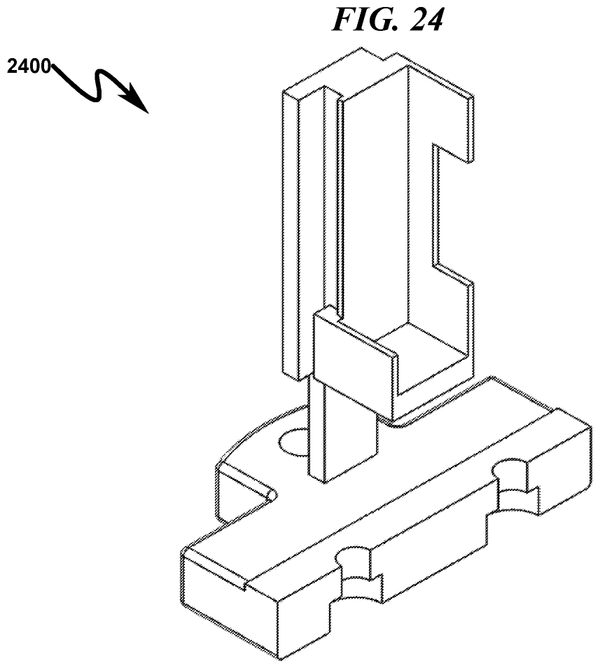

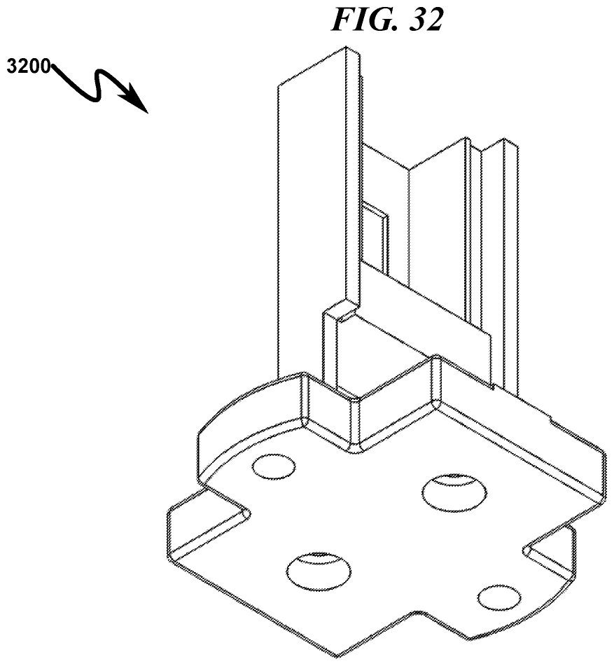

While the present invention may incorporate a variety of mechanisms for retaining optics within the overall OTA testing framework, many preferred invention embodiments employ an optical retention framework (ORF) as generally depicted in detail in FIG. 17 (1700)-FIG. 32 (3200).

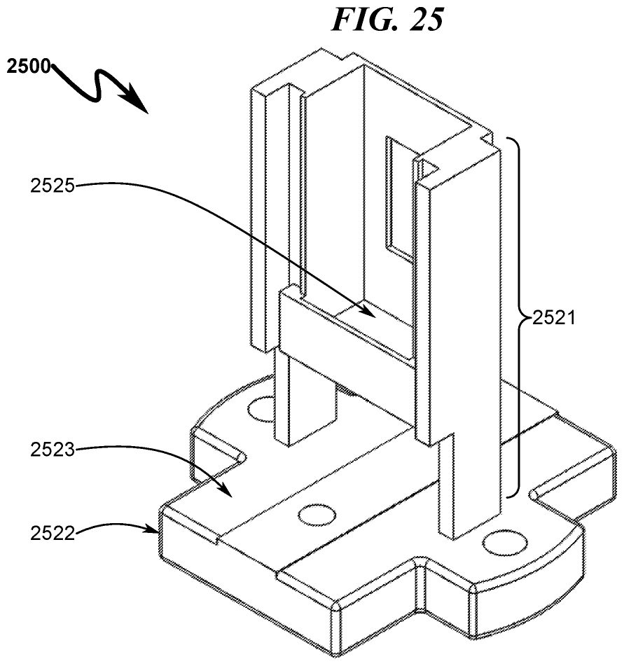

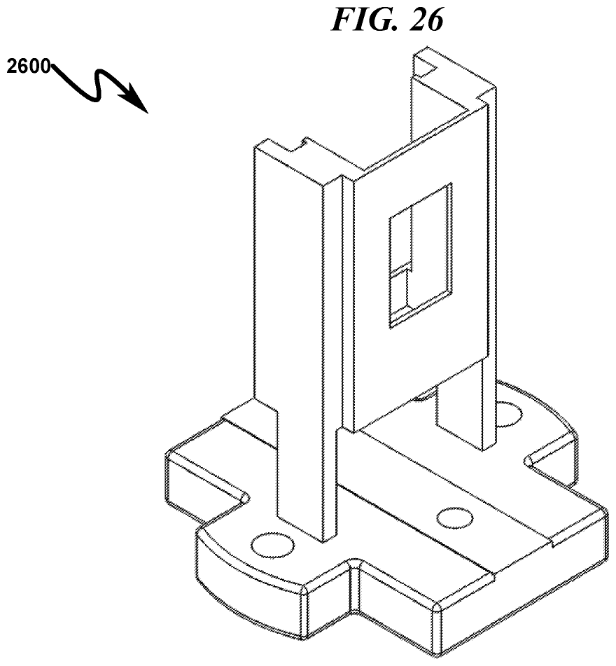

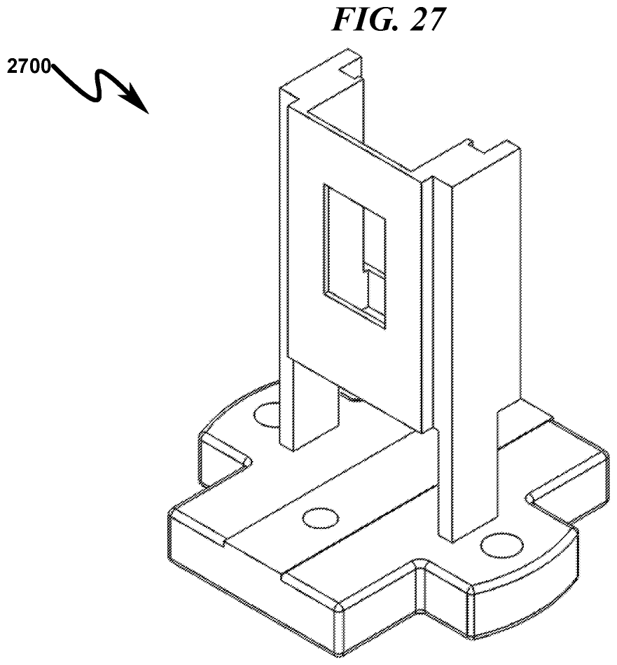

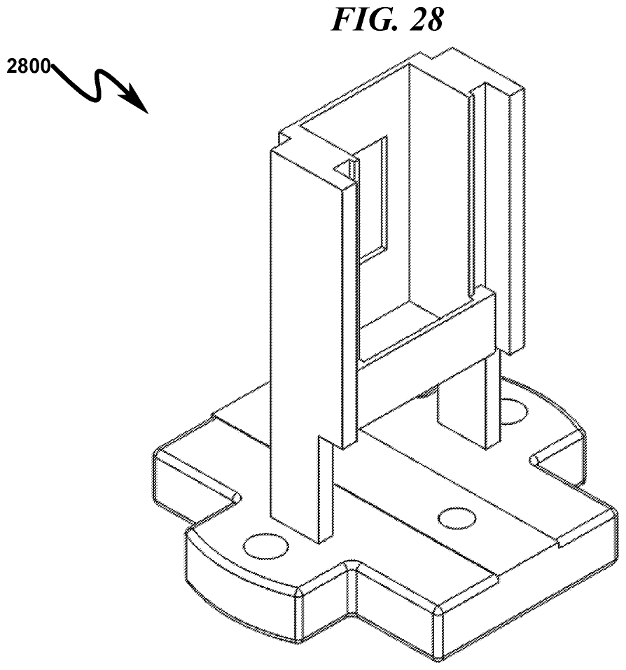

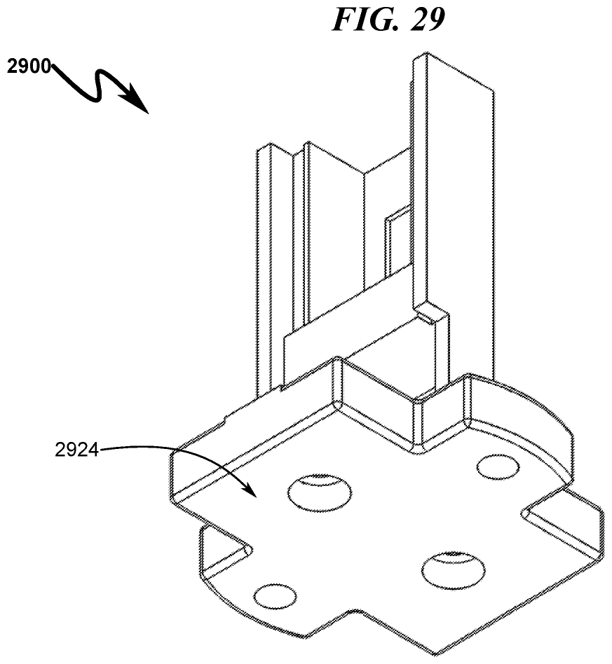

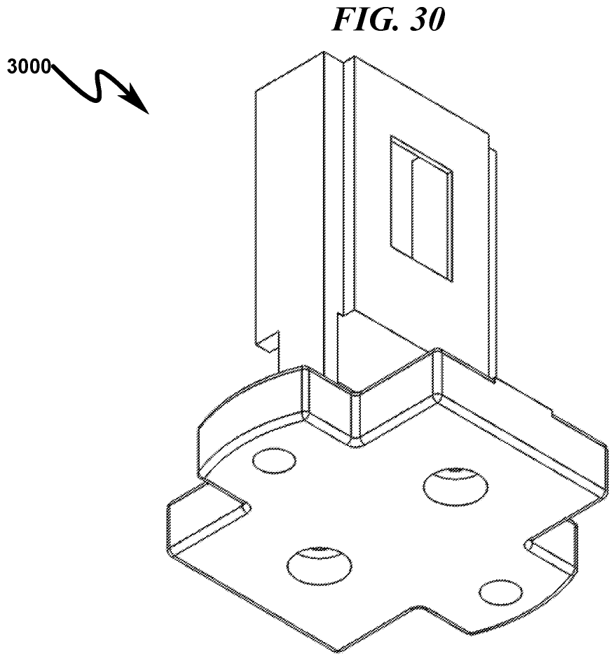

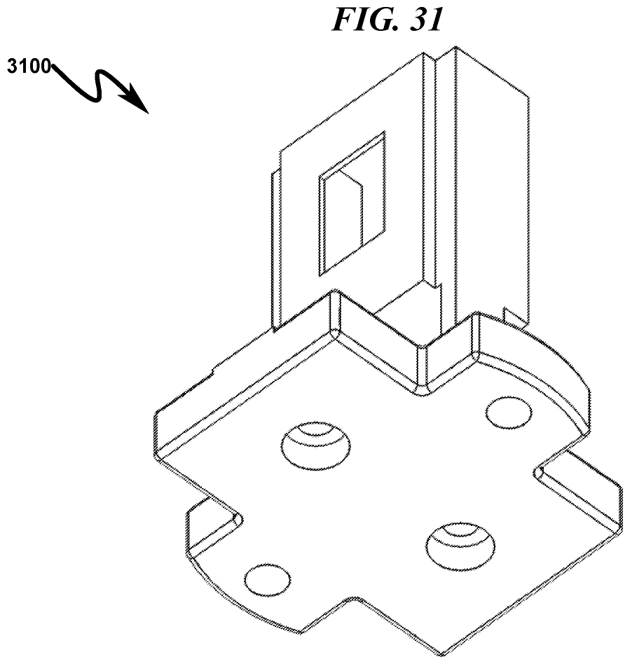

As generally depicted in FIG. 25 (2500) and FIG. 29 (2900), the ORF incorporates a cassette support tower (CST) (2521) perpendicularly attached to a retention framework base (RFB) (2522) having a top framework surface (TFS) (2523) and a bottom framework surface (BFS) (2924). The (CST) (2521) incorporates one or more vertical slots (2525) in which one or more lens cassette fixtures (LCF) may be inserted and retained.

### Corneal Lens Fixture (CLF) (3300)-(4800)

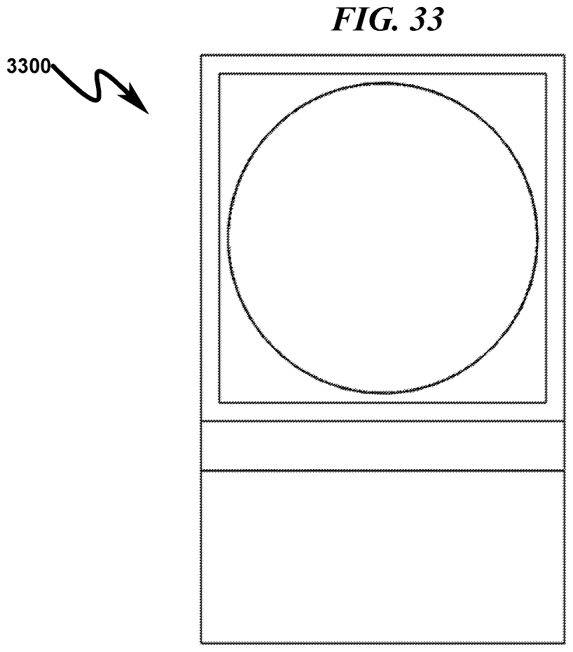

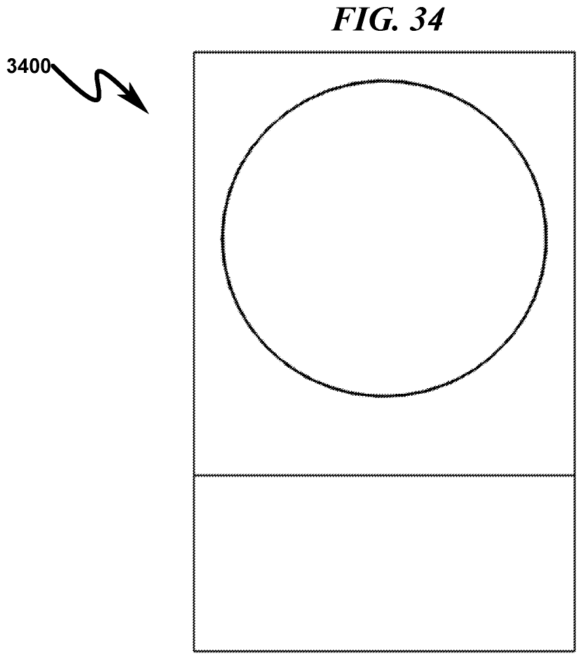

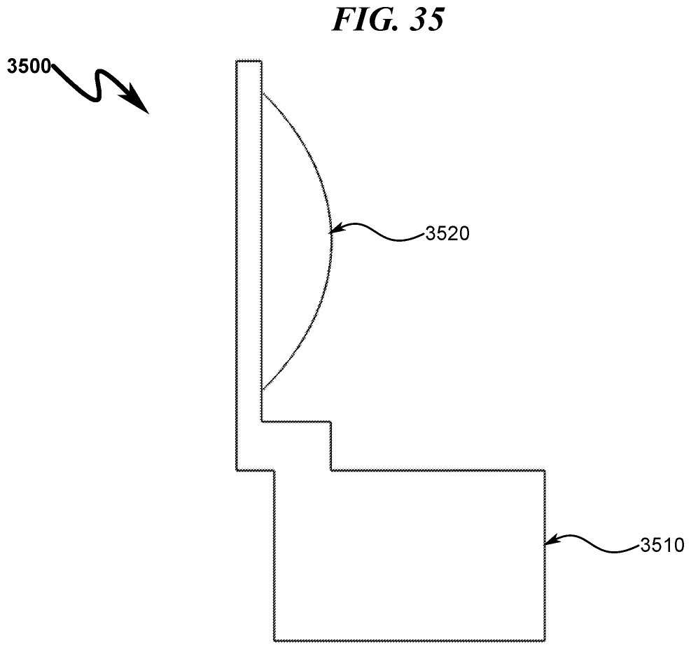

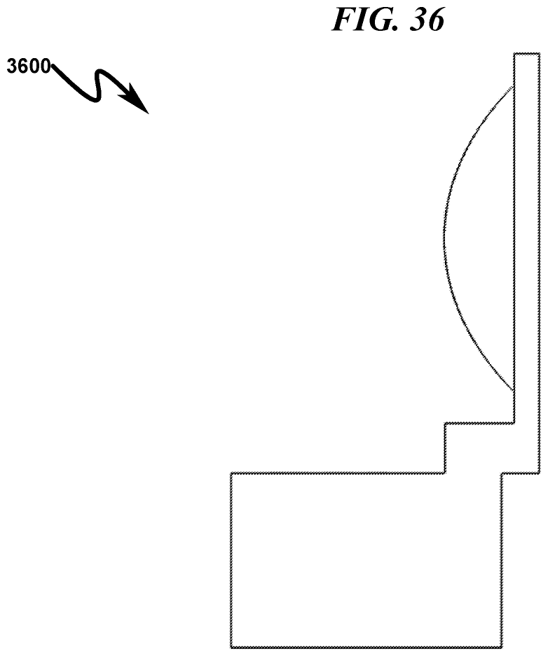

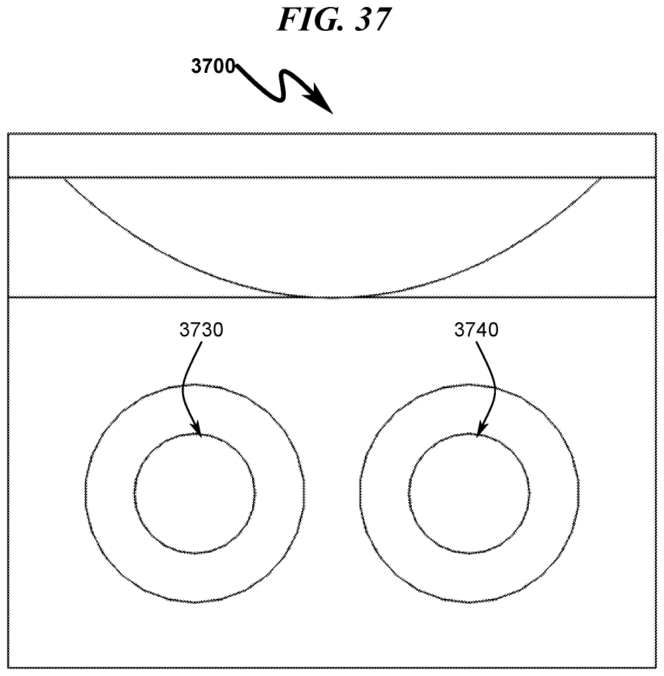

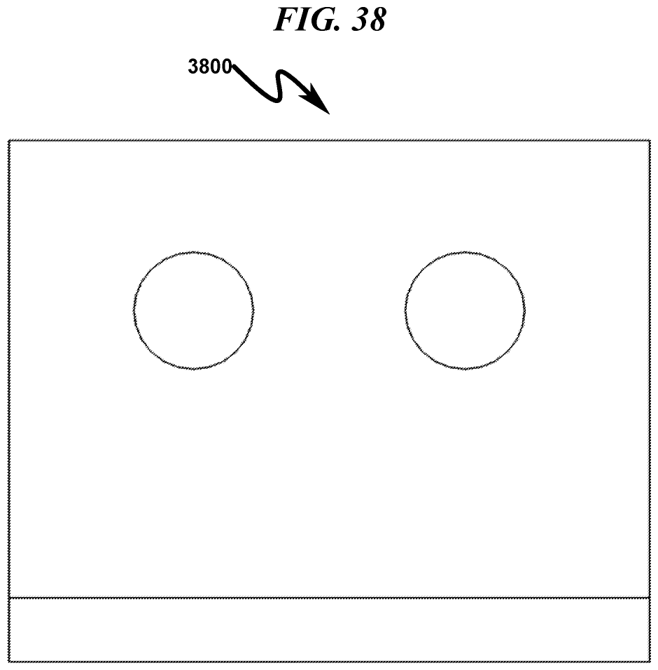

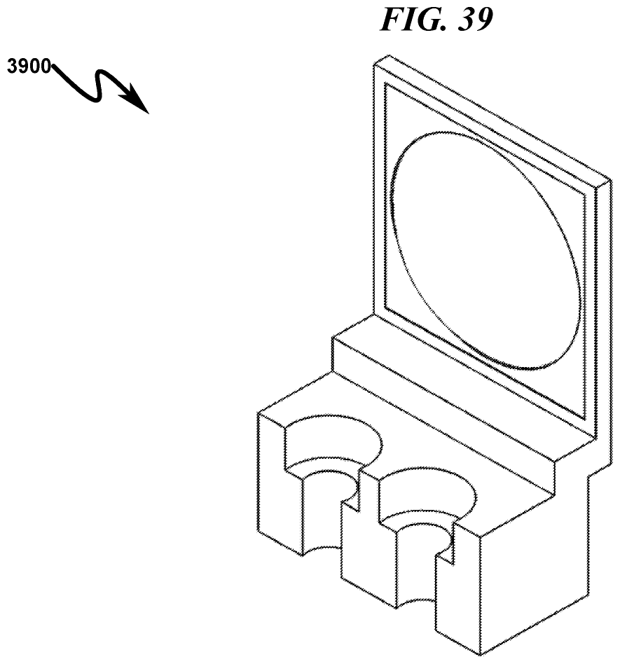

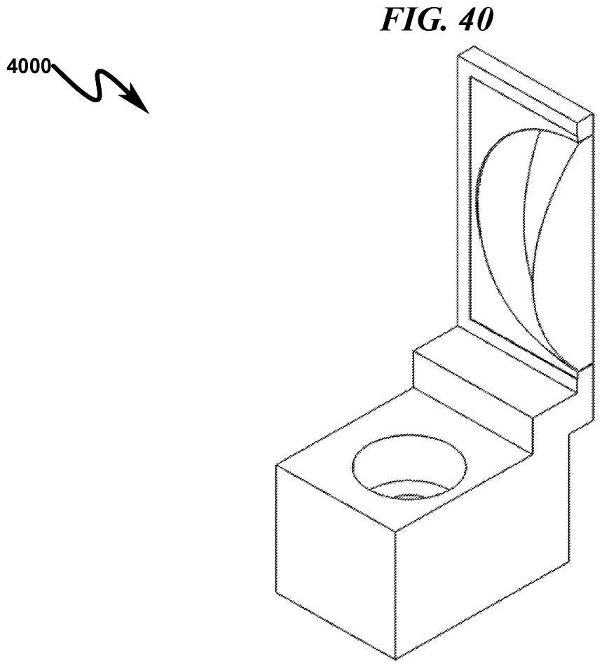

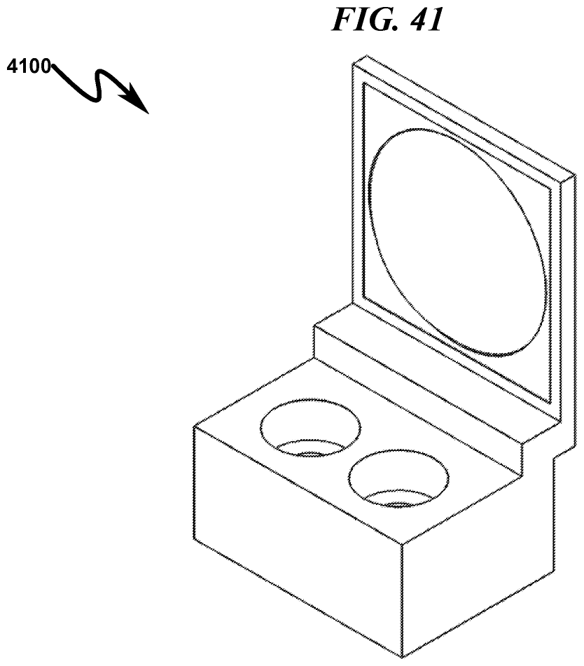

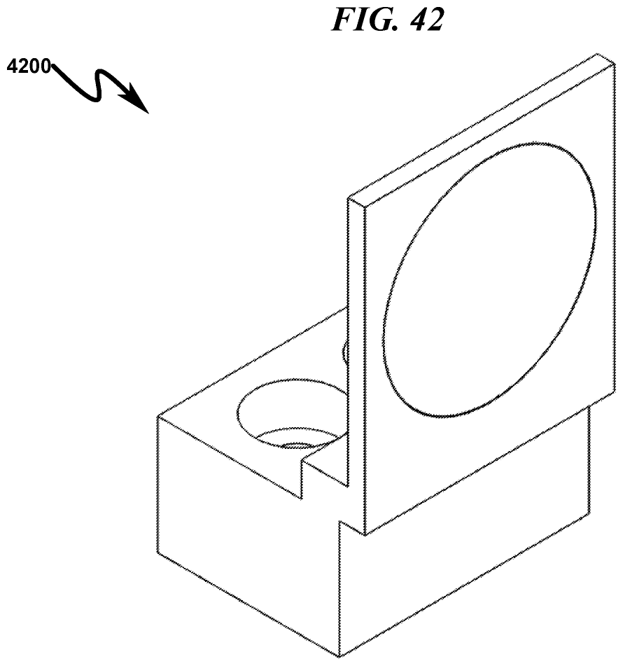

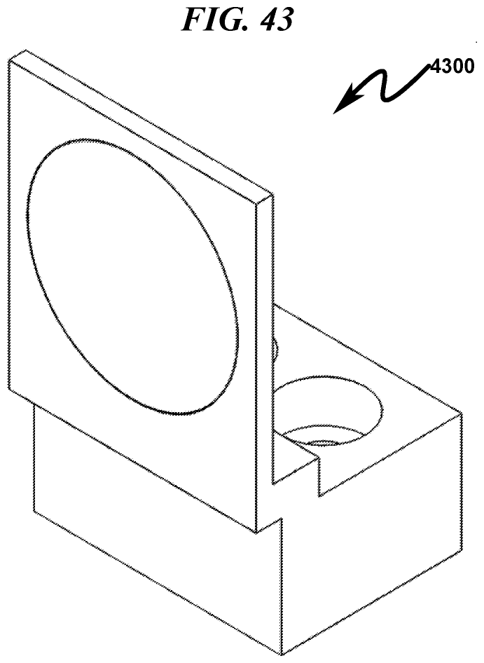

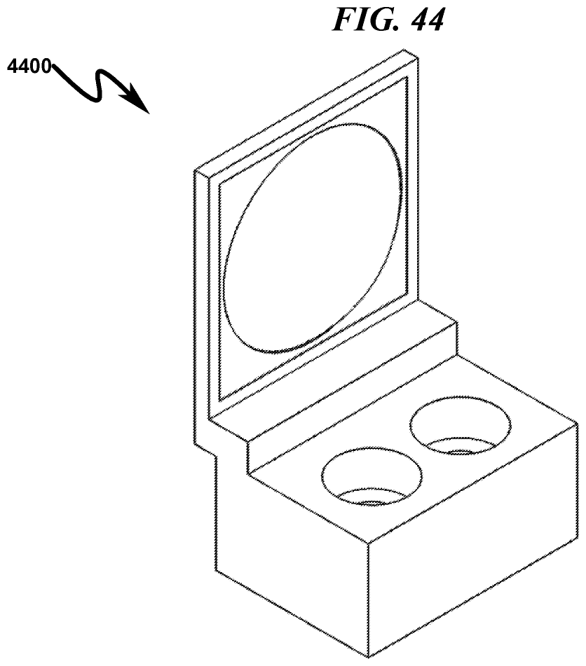

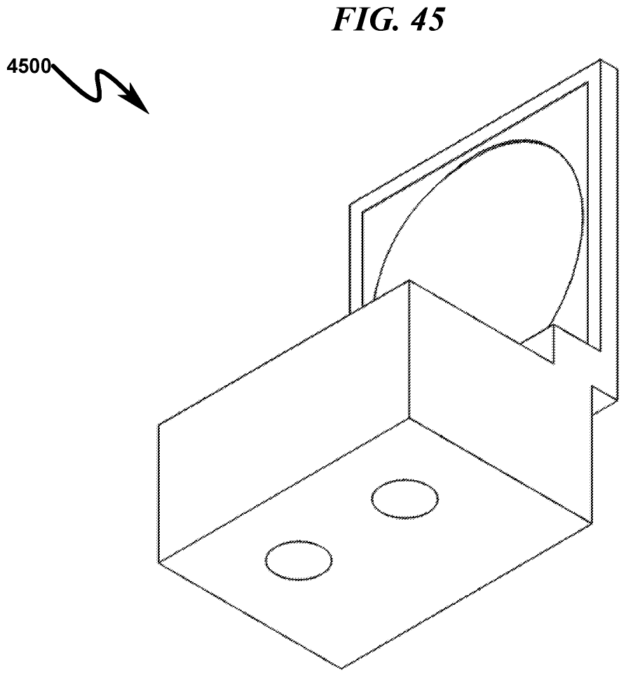

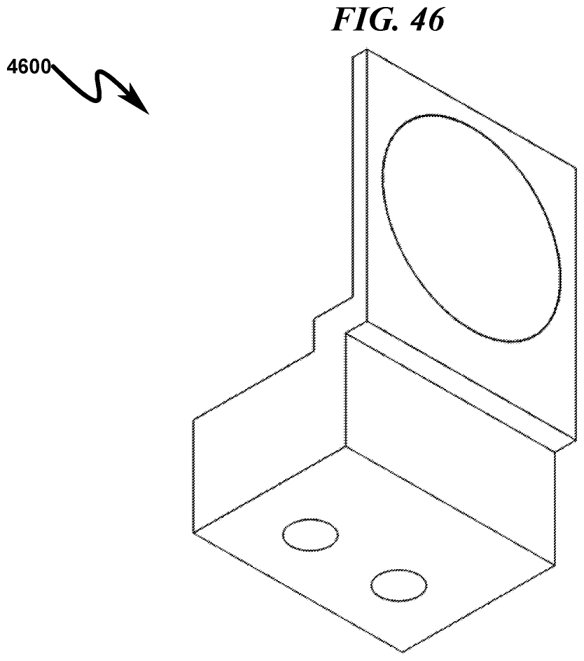

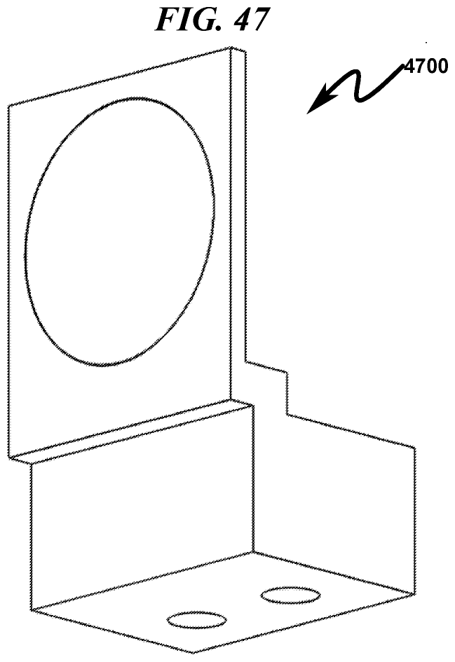

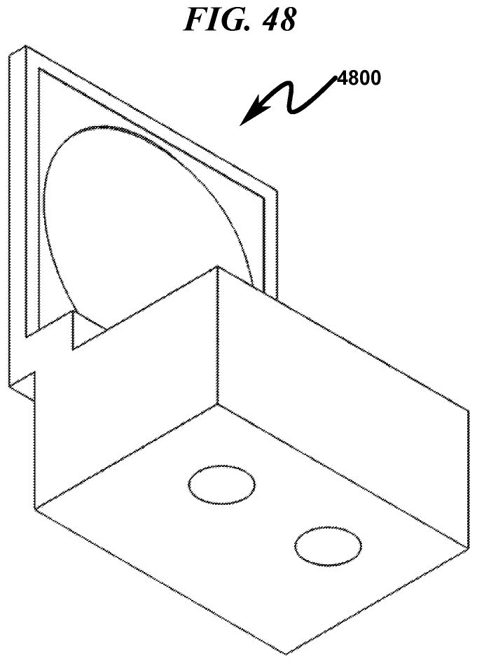

While the present invention may incorporate a variety of mechanisms for retaining an optical lens within the OTA testing framework, many preferred invention embodiments employ a corneal lens fixture (CLF) as generally depicted in detail in FIG. 33 (3300)-FIG. 48 (4800).

This exemplary CLF is illustrated incorporating a lens retention plate (LRP) (3510) fitted with an exemplary fixed lens (3520) and may incorporate a number of screw retention holes (3730, 3740) that are used to mate the CLF to the optical retention framework (ORF) via a longitudinal axis positioning platform (LAP). The corneal lens can be customized, and different materials can be used, acrylic, silicone, or other materials, to test different materials or customizations.

### Test Lens Fixture (TLF) (4900)-(6400)

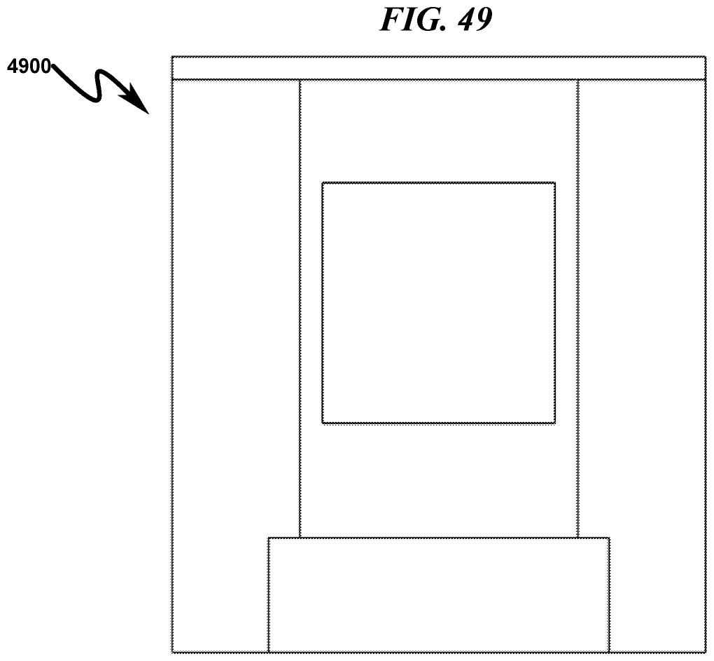

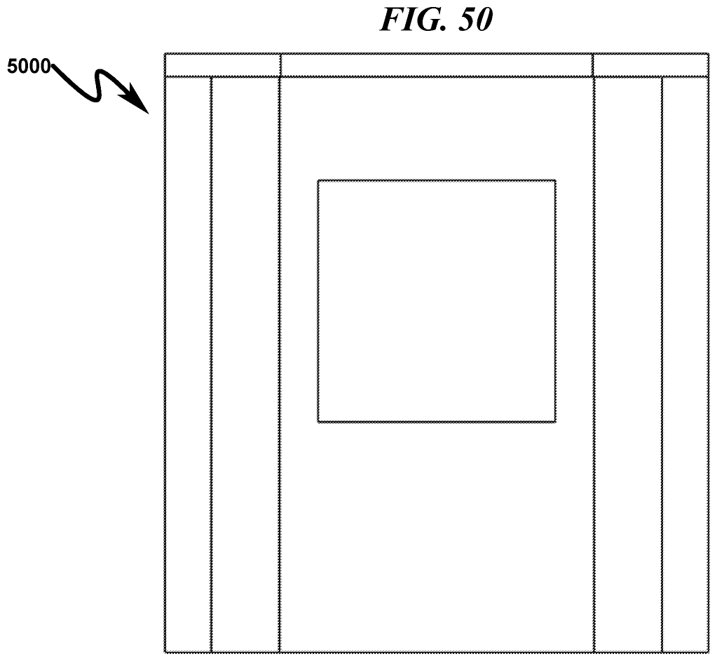

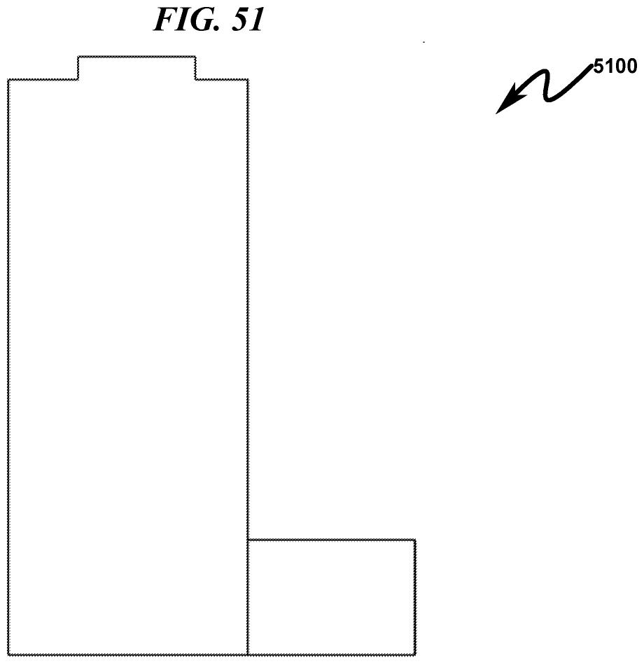

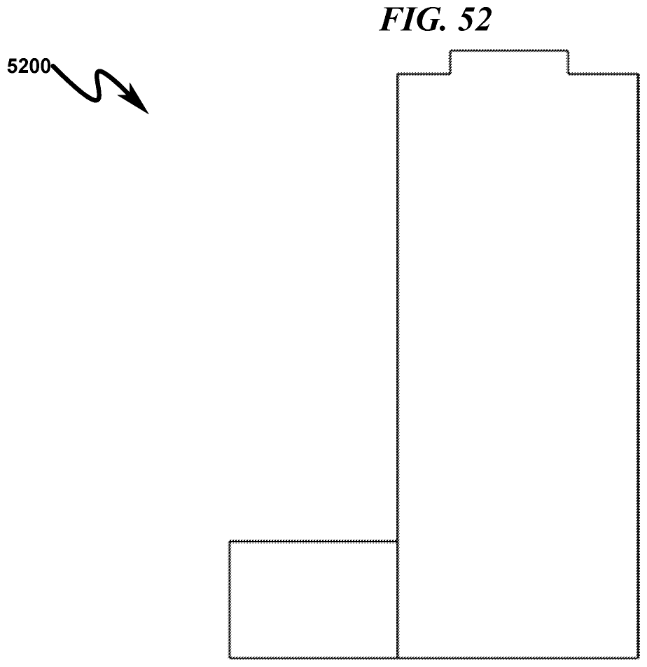

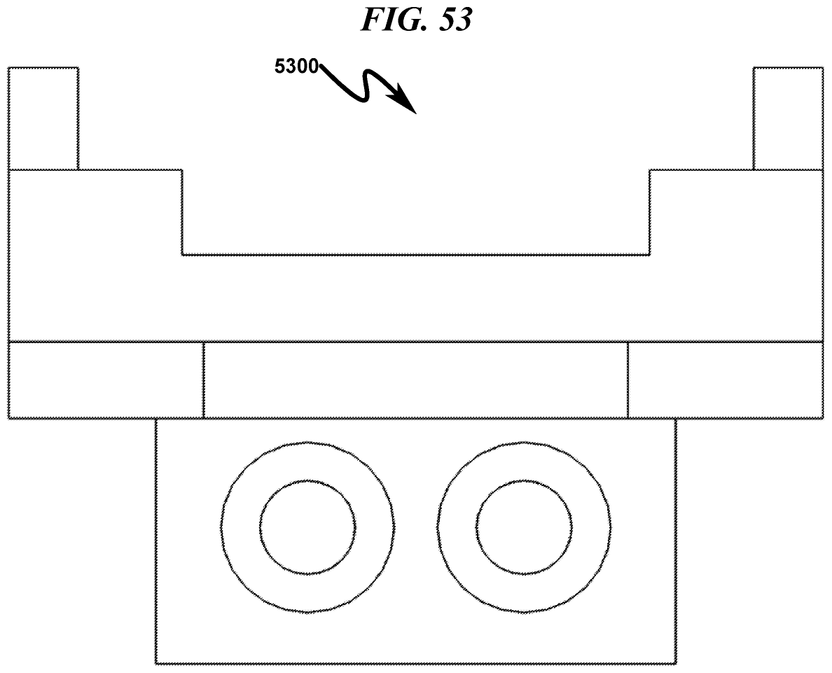

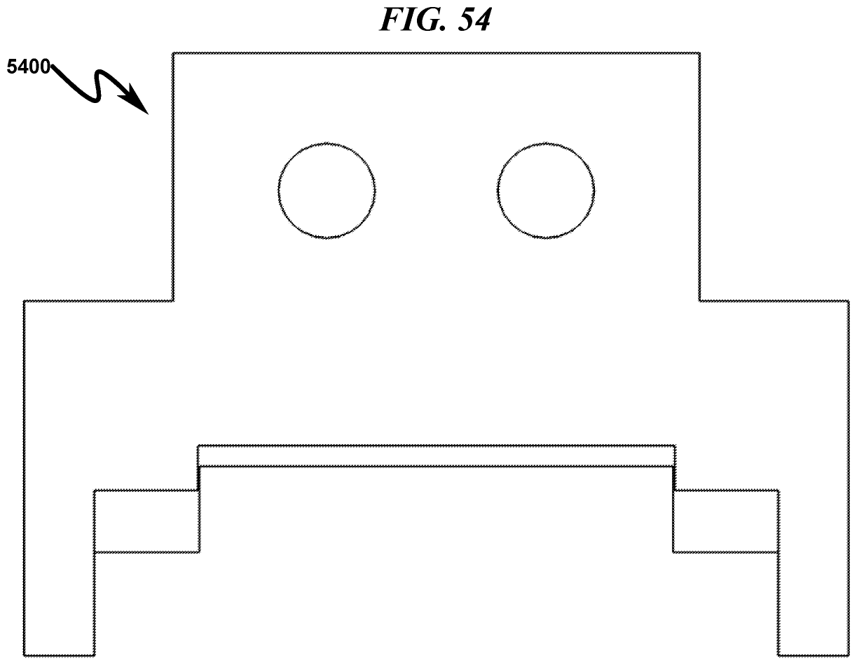

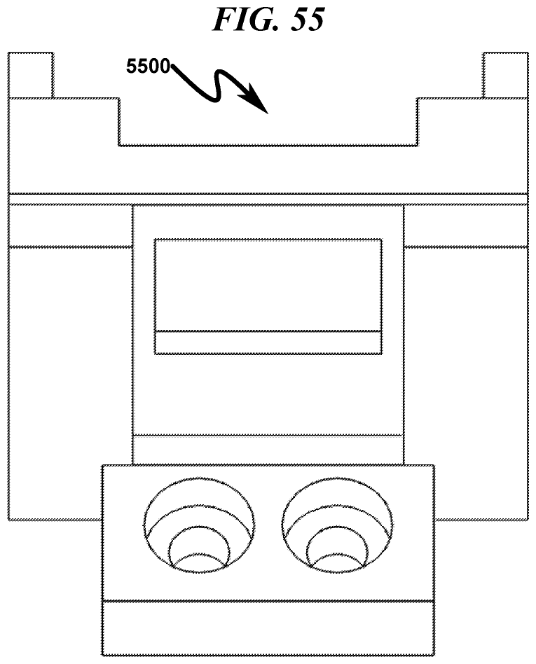

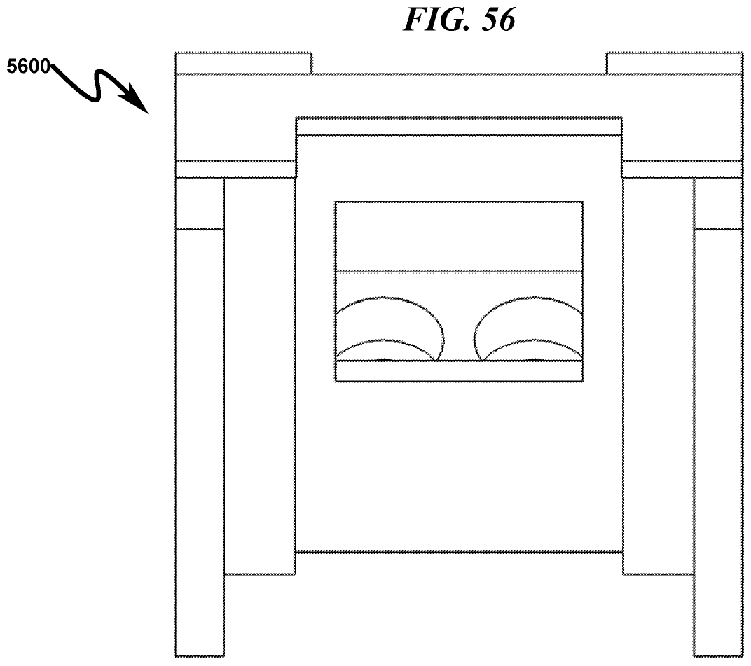

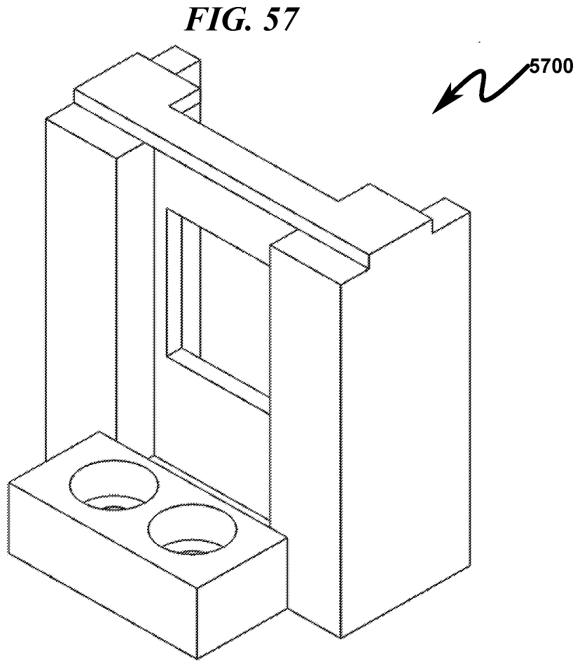

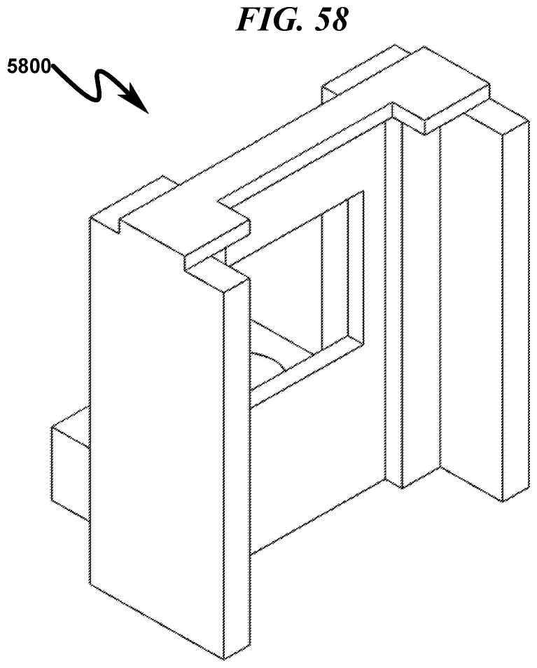

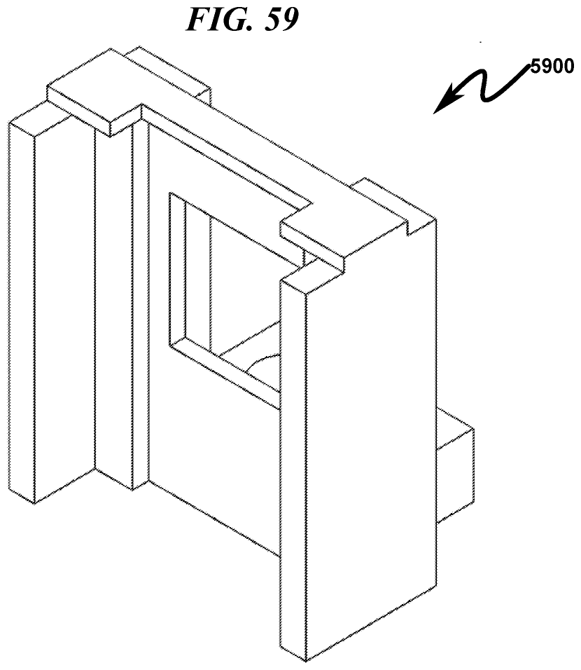

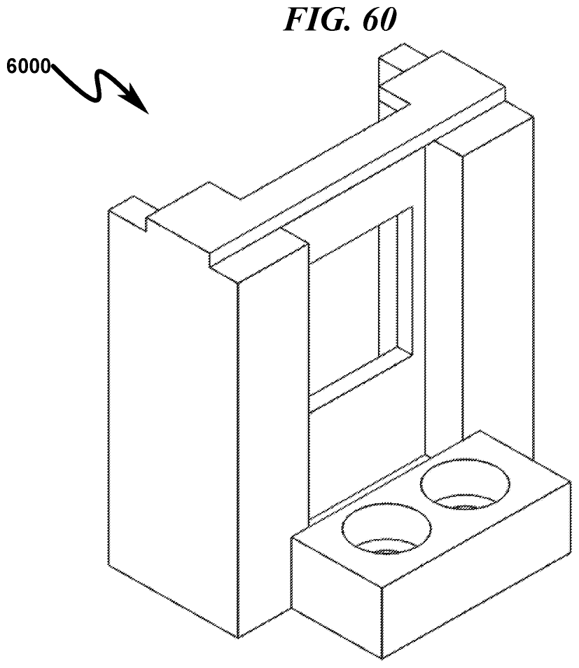

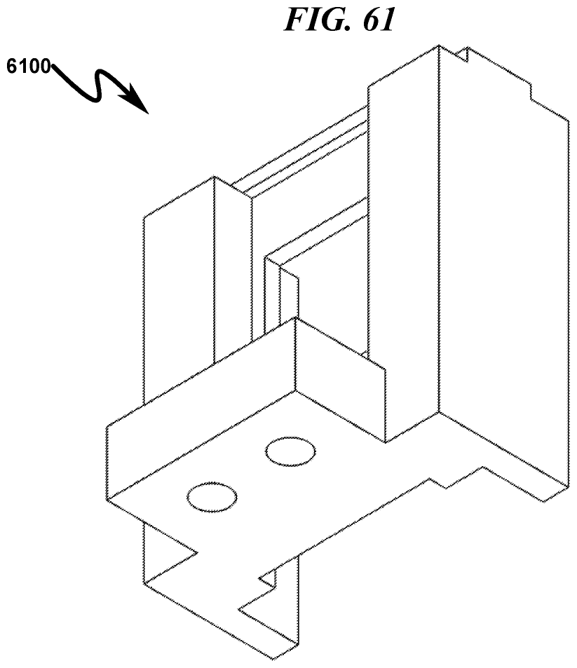

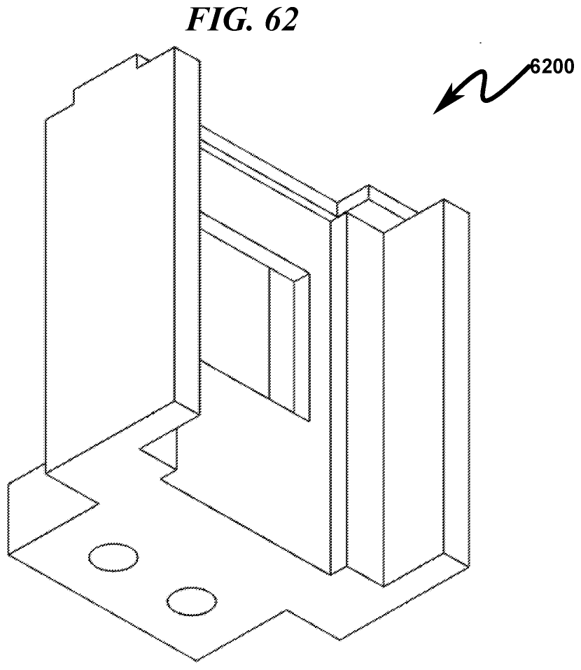

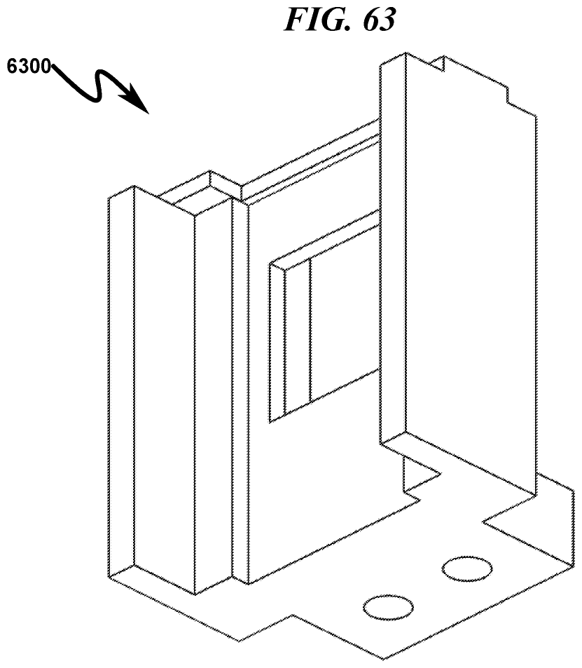

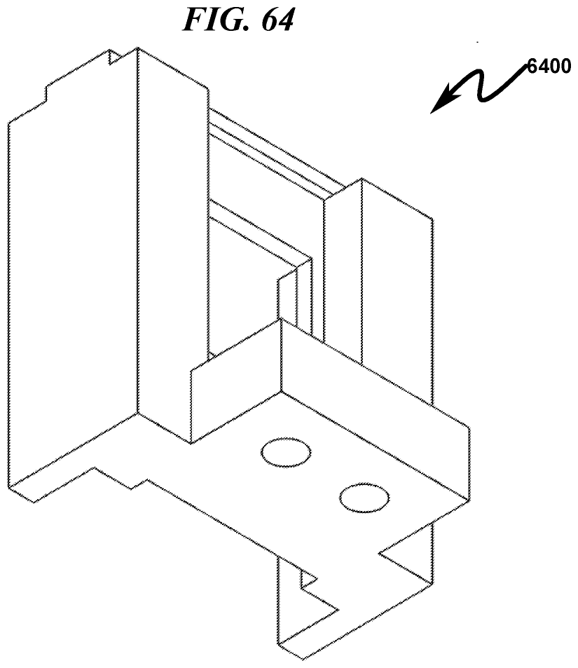

While the present invention may incorporate a variety of mechanisms for retaining a test optical lens within the OTA testing framework, many preferred invention embodiments employ a test lens fixture (TLF) as generally depicted in detail in FIG. 49 (4900)-FIG. 64 (6400).

This exemplary ALF is illustrated incorporating means for allowing the lens cassette fixture (LCF) that incorporates an IOL/LUT lens fixture (ILF) or lens under test fixture (LUF) to be placed along the LOA and adjusted via use of the various LAP longitudinal adjustments provided in the system.

### Lens Cassette Fixture (LCF)/Pupil Lens Fixture (PLF)(6500)-(8000)

While the present invention may incorporate a variety of mechanisms for testing and substituting an optical lens within the OTA testing framework, many preferred invention embodiments employ a lens cassette fixture (LCF) and/or pupil lens fixture (PLF) as generally depicted in detail in FIG. 65 (6500)-FIG. 80 (8000). One skilled in the art will recognize that there are a wide variety of ways in which to implement retention of the pinhole or light block device (POL) within the context of the present invention.

### Axial Positioning Platform (APP) (8100)-(10400)

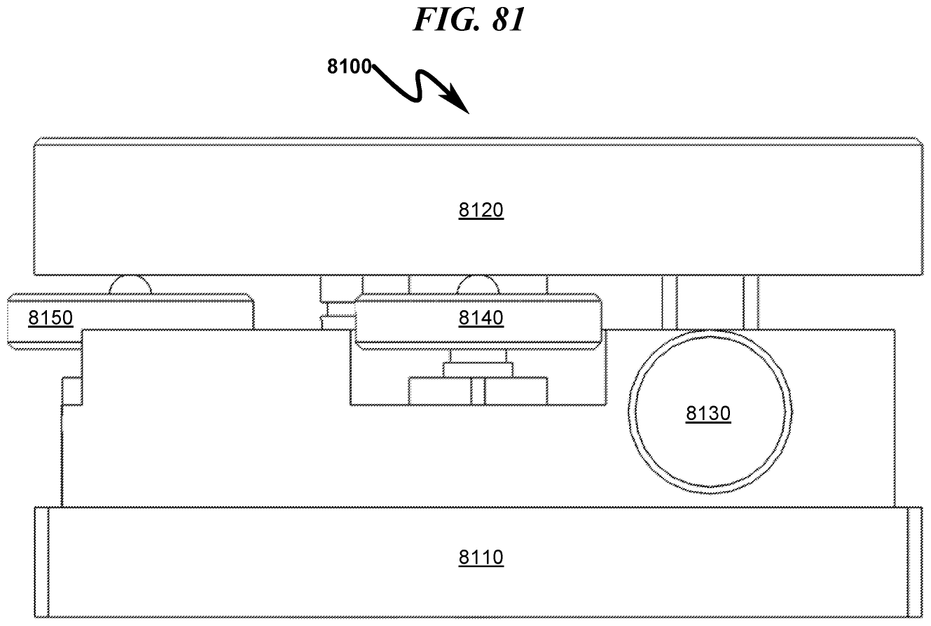

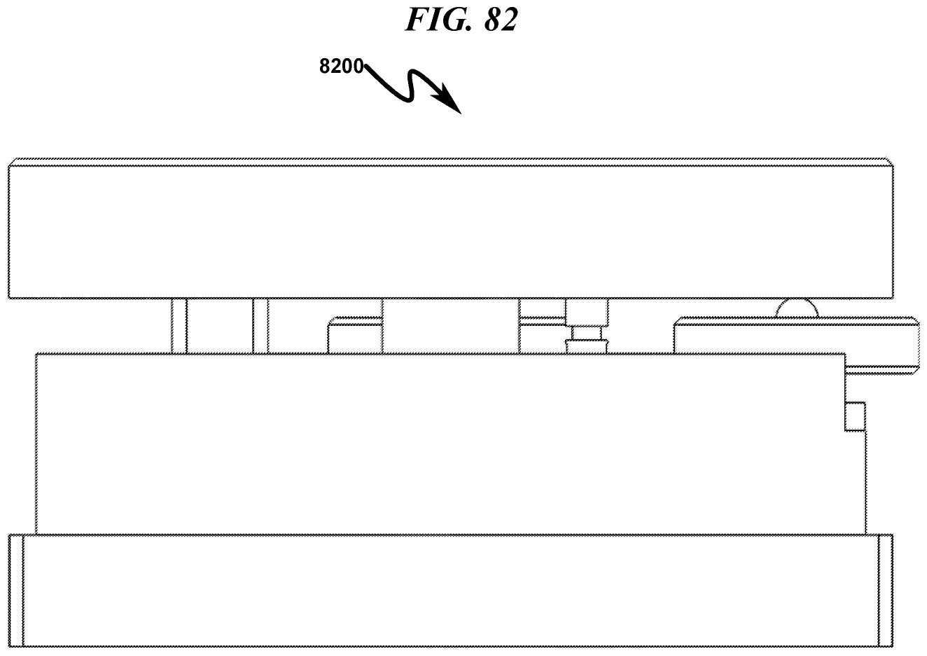

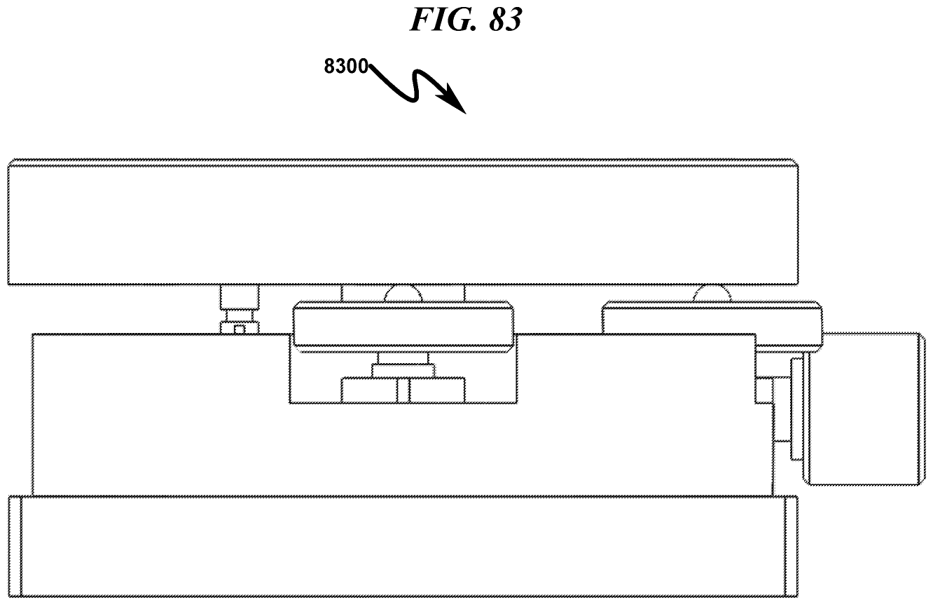

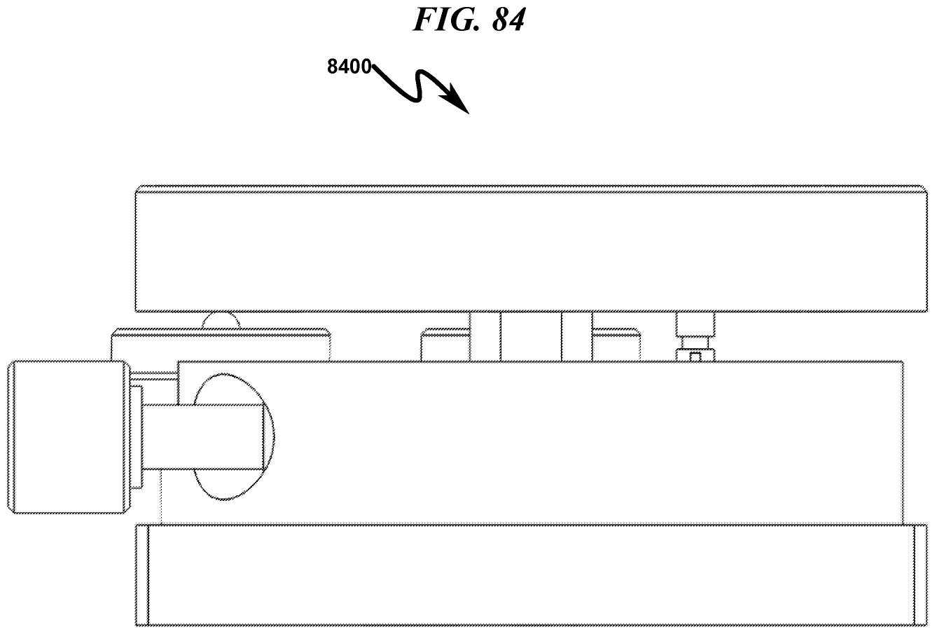

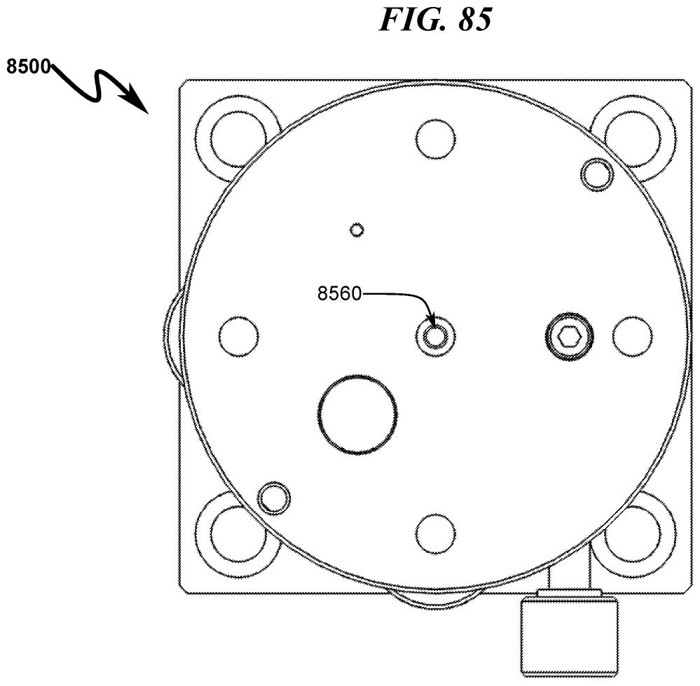

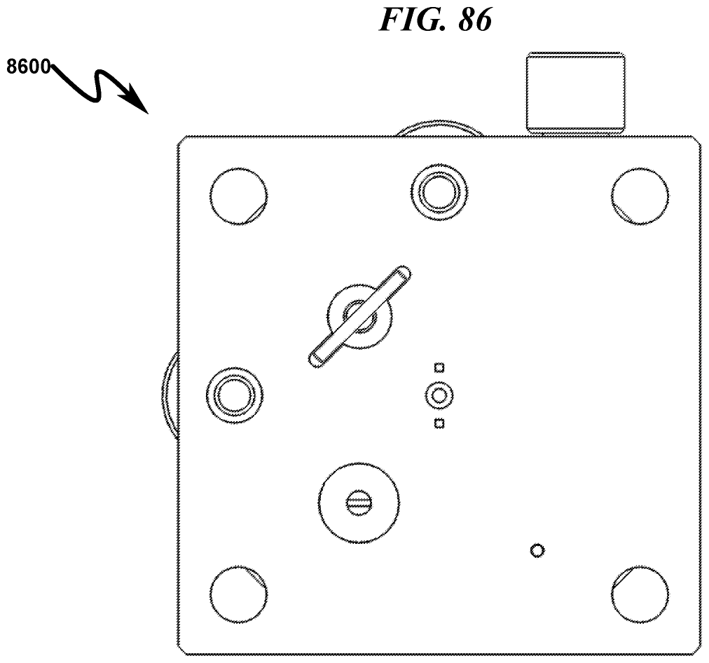

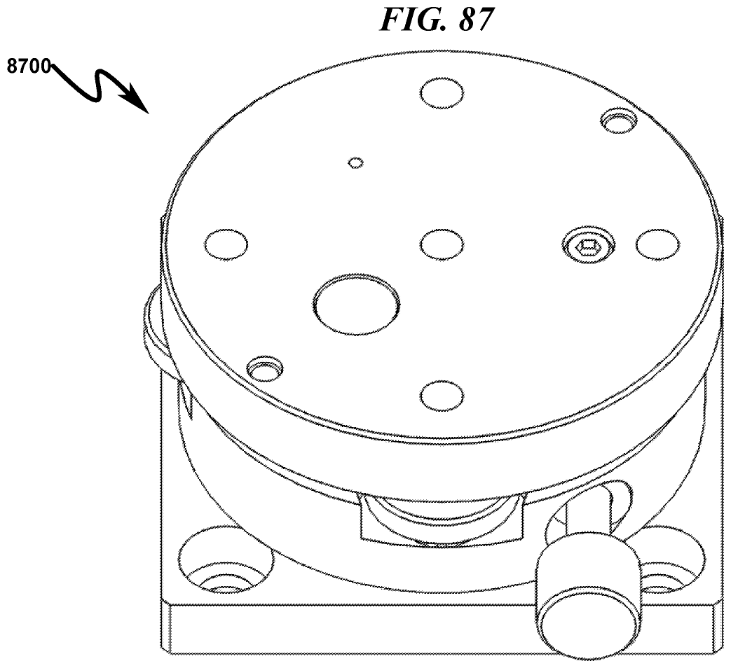

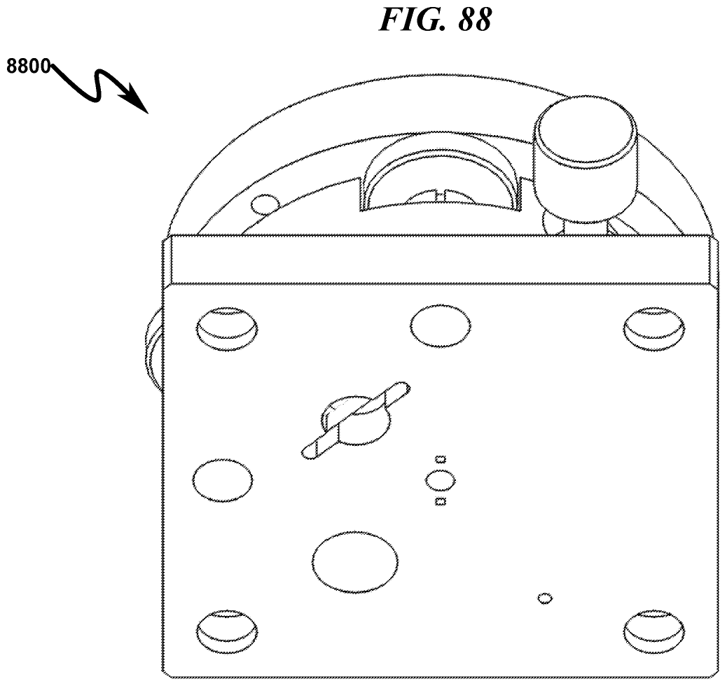

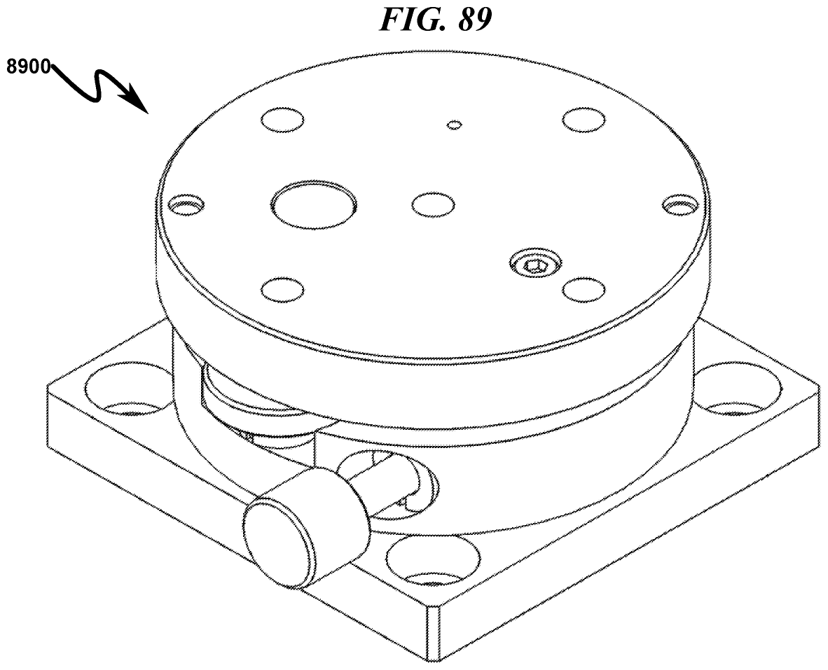

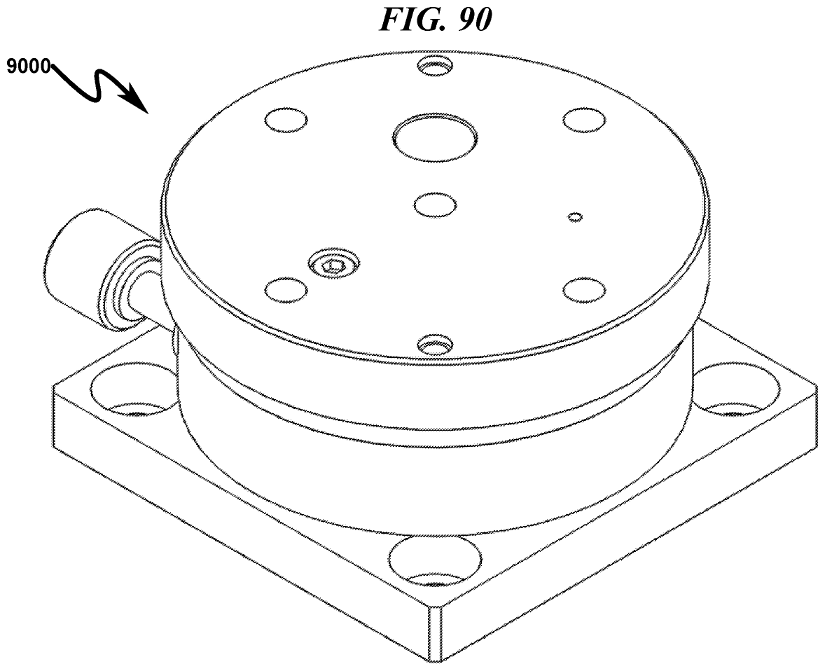

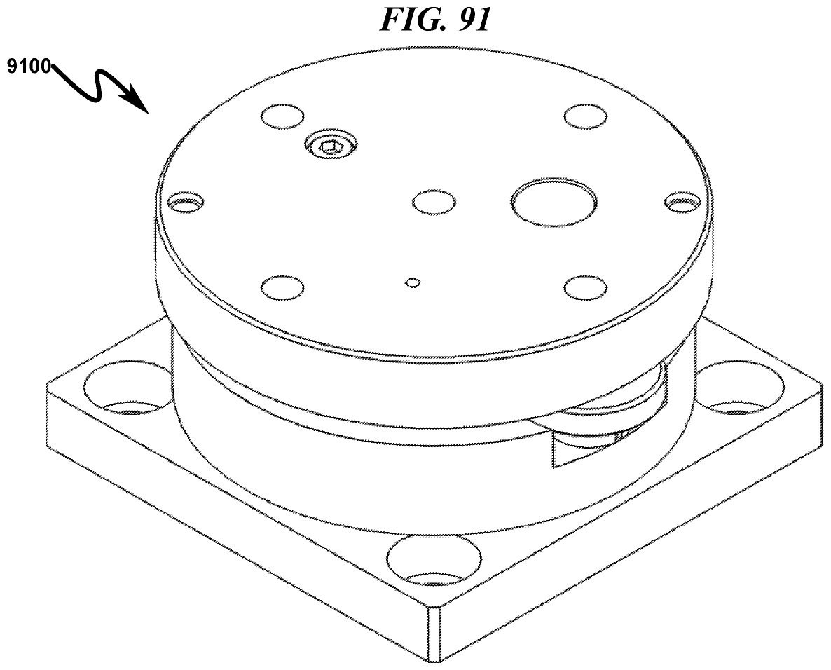

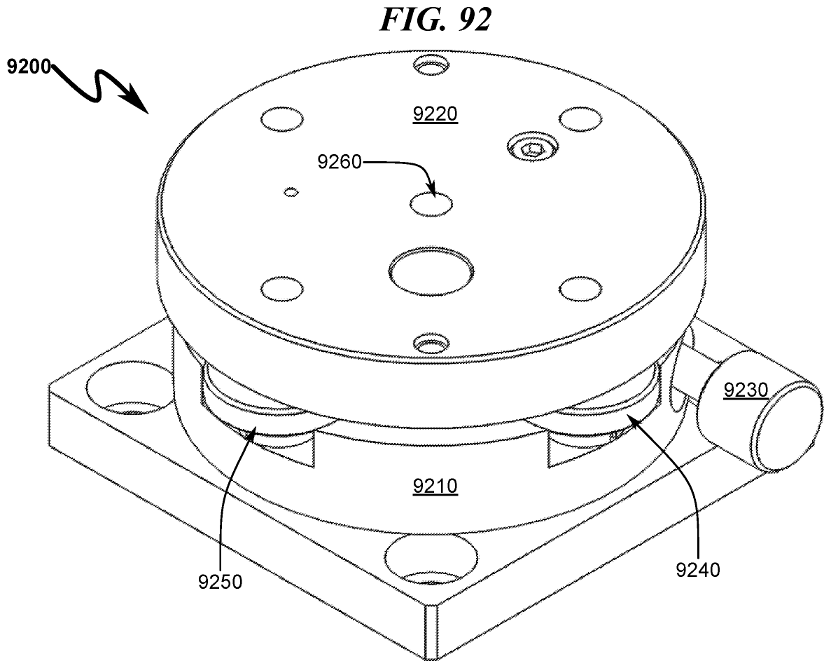

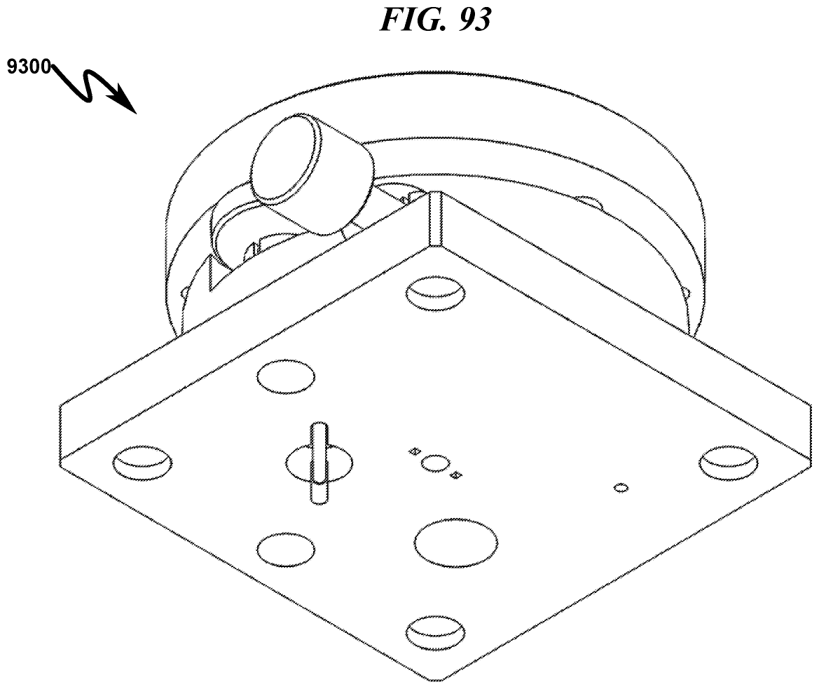

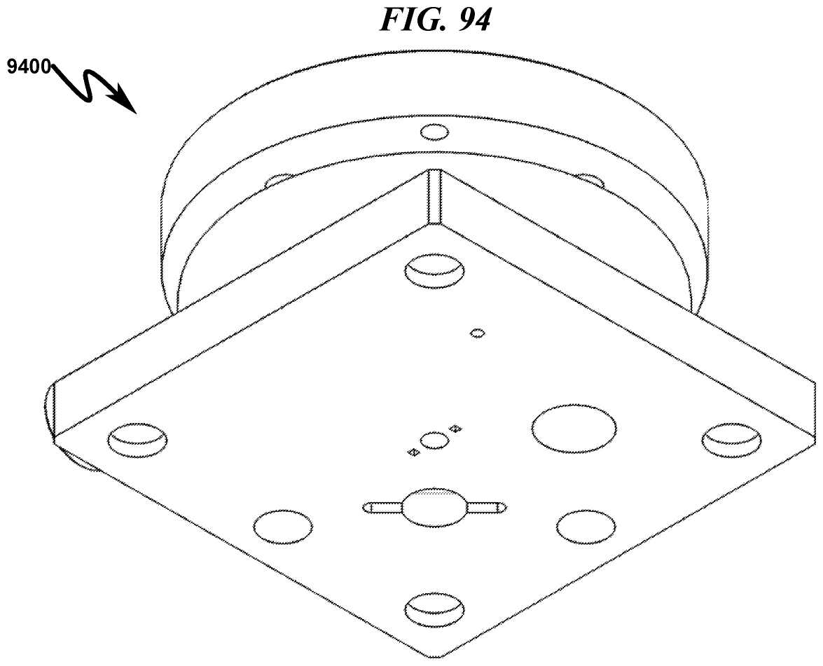

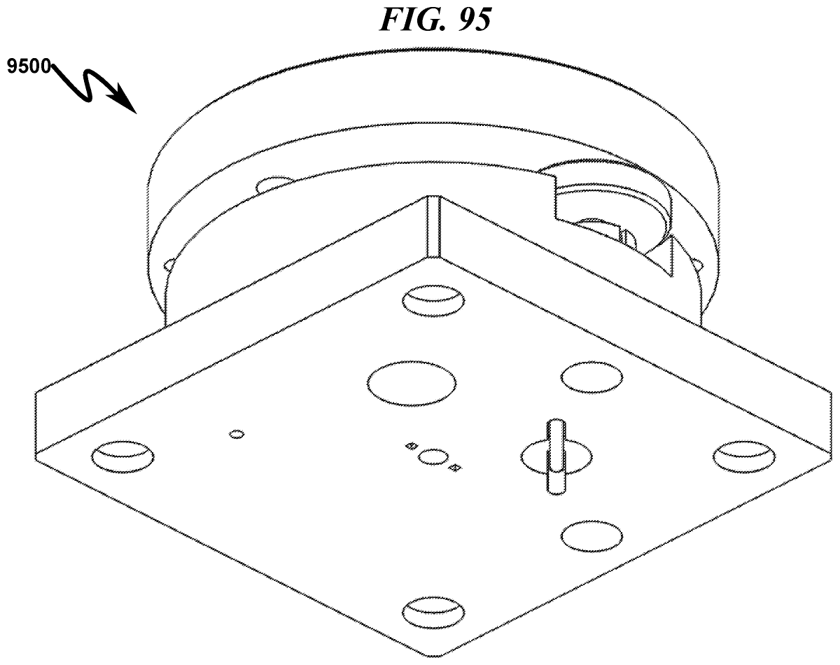

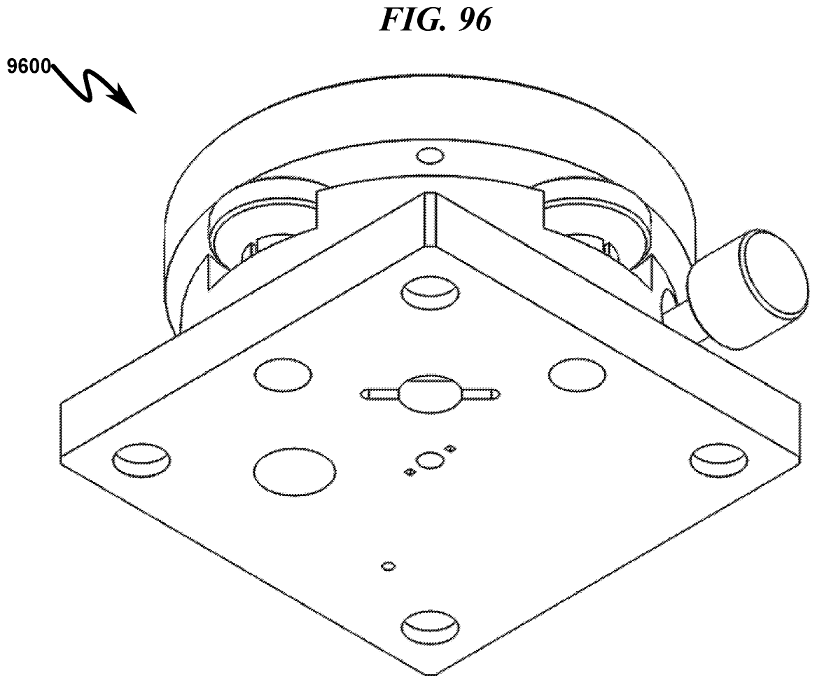

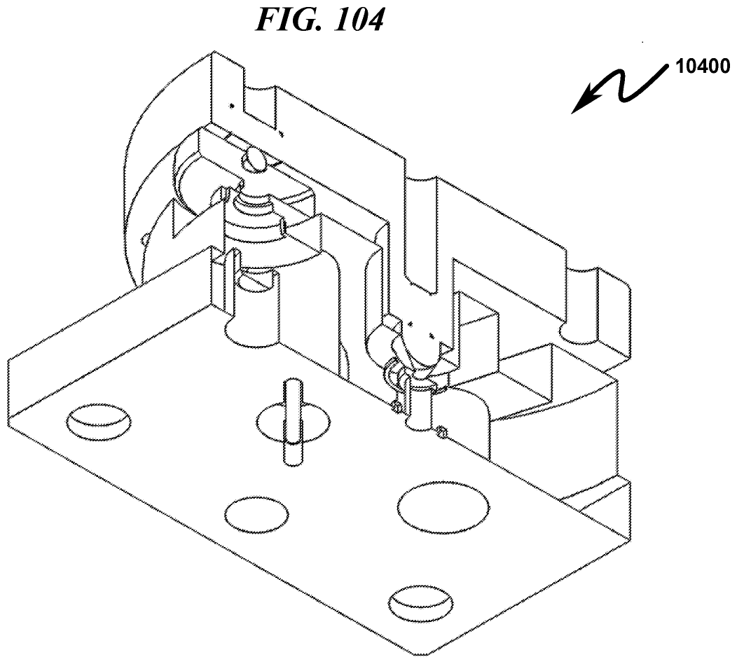

While the present invention may be mounted on a variety of base platforms, many preferred invention embodiments employ an axial positioning platform (APP) as generally depicted in detail in FIG. 81 (8100)-FIG. 104 (10400). However the axial positioning platform can be mounted vertically, horizontally, or can be used to evaluate tip/tilt positioning issues.

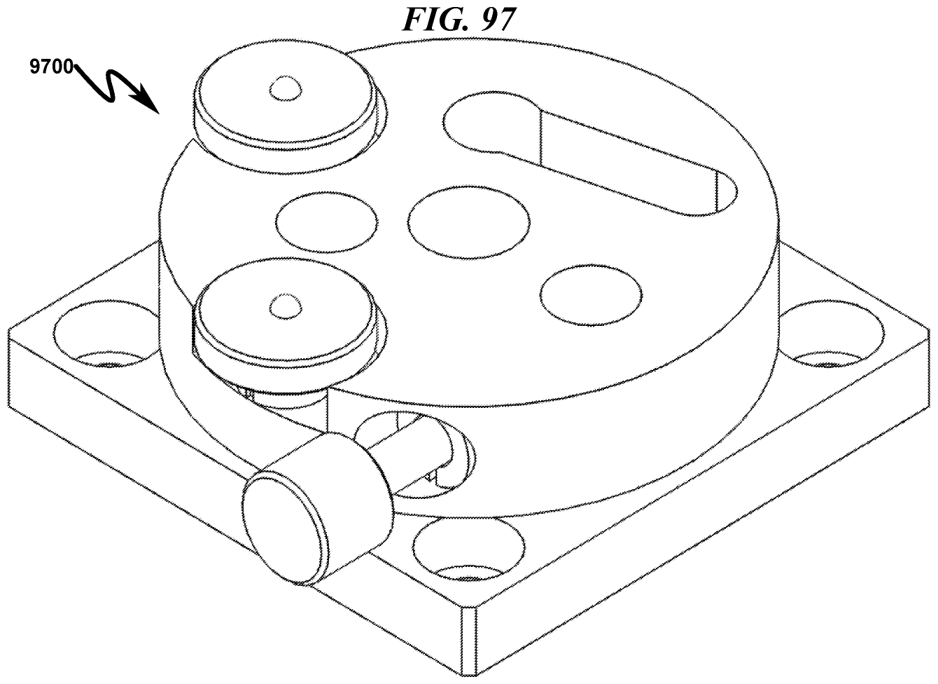

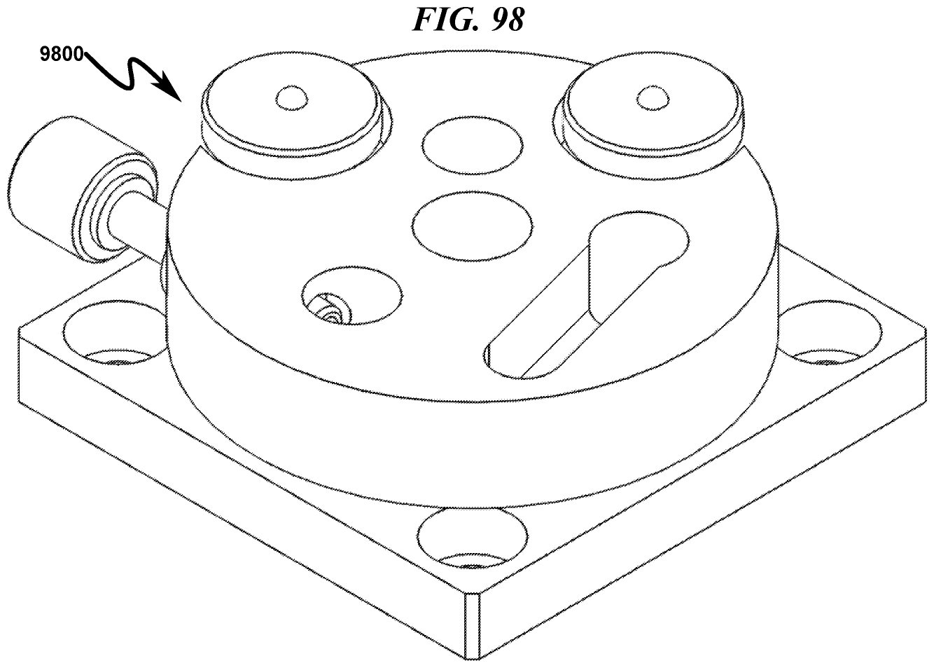

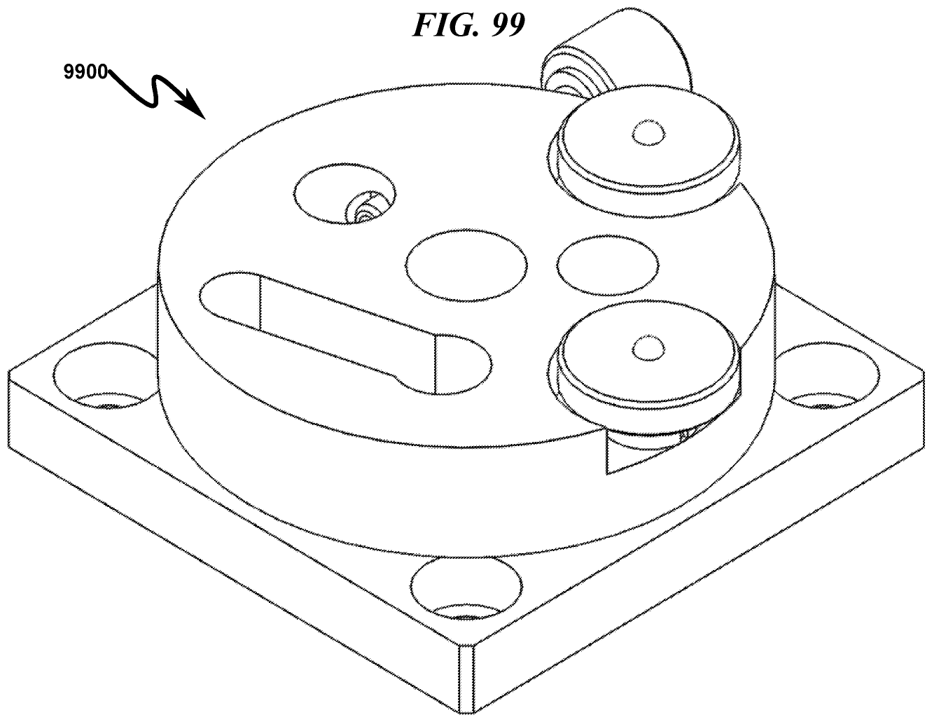

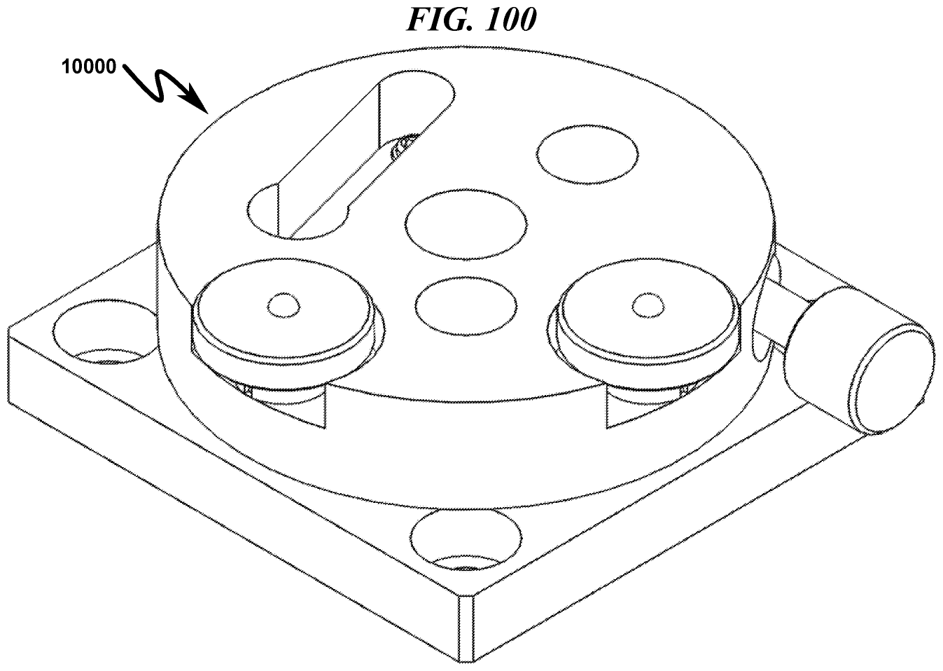

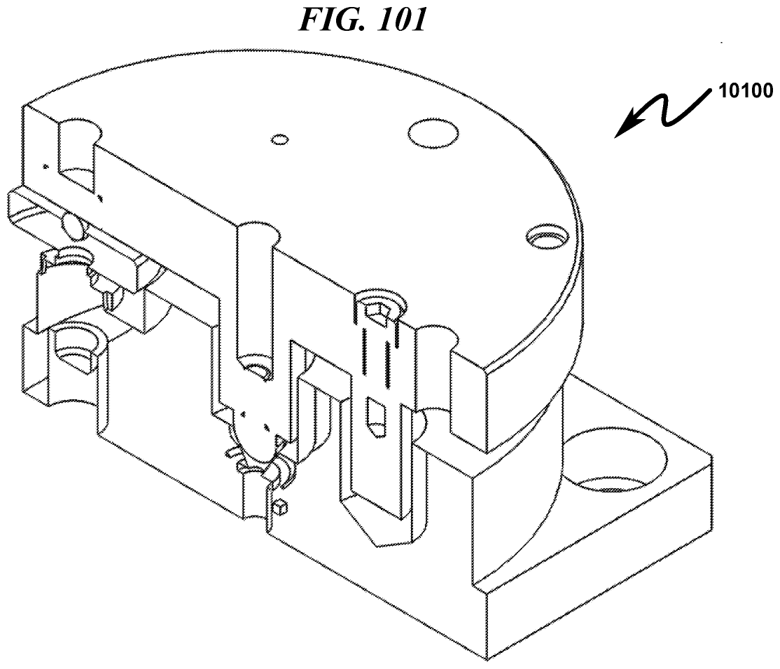

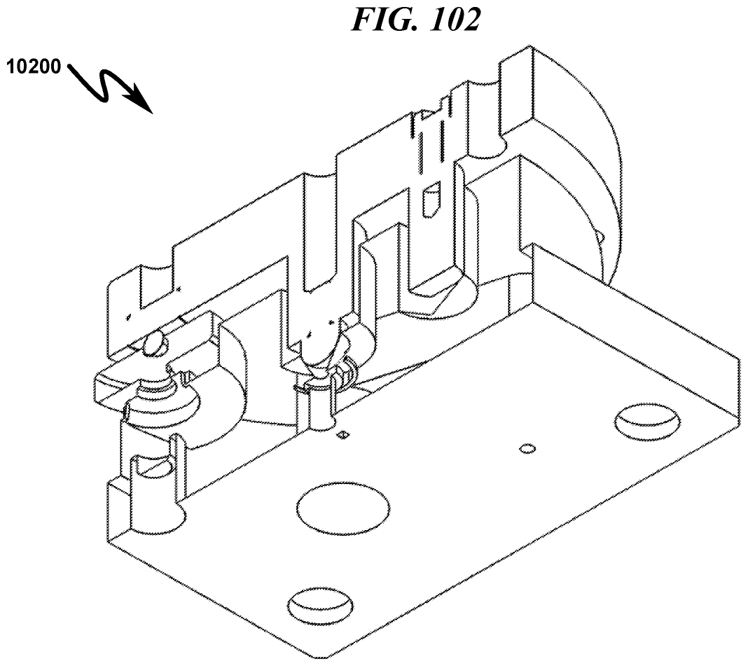

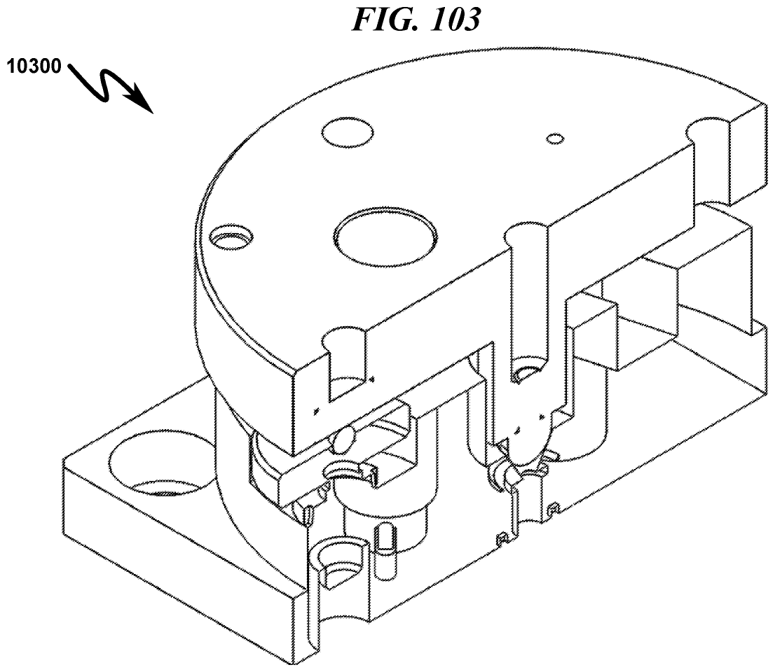

The APP depicted herein is a general purpose vertical axis positioner that employs an axial base platform (ABP) (8110, 9210) supporting an axial support platform (ASP) (8120, 9220) through a series of mechanical connections that include a manual rotational actuator (MRA) (8130, 9230) that rotates the axial support platform (ASP) (8120, 9220) about the axial base platform (ABP) (8110, 9210) through a commonly connected vertical axis (8560, 9260). Tip (8140, 9240) and tilt (8150, 9250) adjustment controls allow the axial support platform (ASP) (8120) to be tipped/tilted as required about the vertical rotation axis (8560, 9260) connecting the axial base platform (ABP) (8110) and axial support platform (ASP) (8120). FIG. 97 (9700)-FIG. 104 (10400) illustrate a series of detail assembly views in which various components of the APP are removed/hidden to show assembly details and internal construction of the APP.

The use of this general purpose APP configuration (8100-10400) allows proper alignment of the lens structures within the OTA with respect to external light/laser sources to permit proper calibration and testing of the overall optical system employing the IOL under evaluation.

As mentioned previously, in some preferred embodiments the mechanical adjustment controls for the APP may be implemented using electric motor servos under digital computer control executing machine instructions read from a computer-readable medium.

### Longitudinal Axis Positioning Platform (LAP) (10500)-(12800)

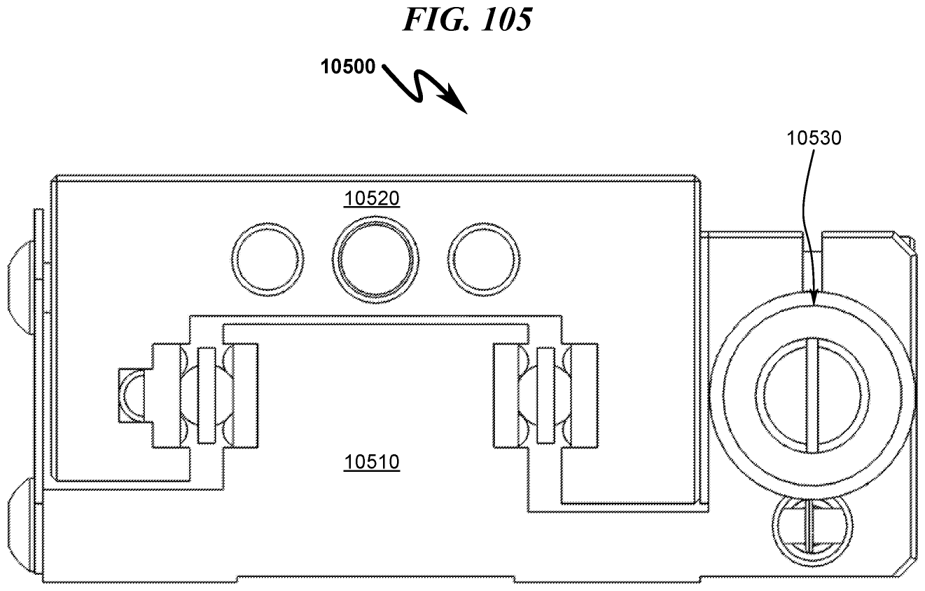

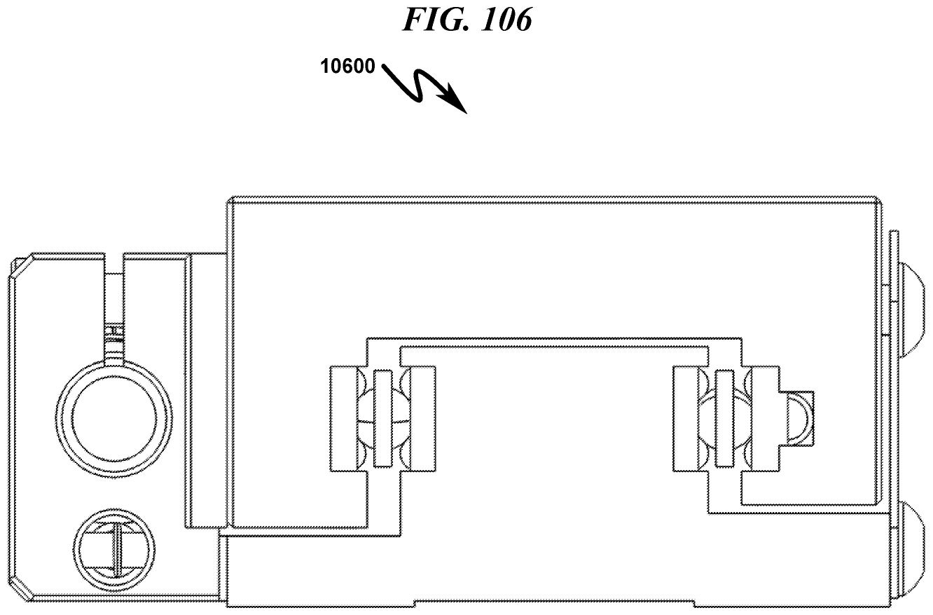

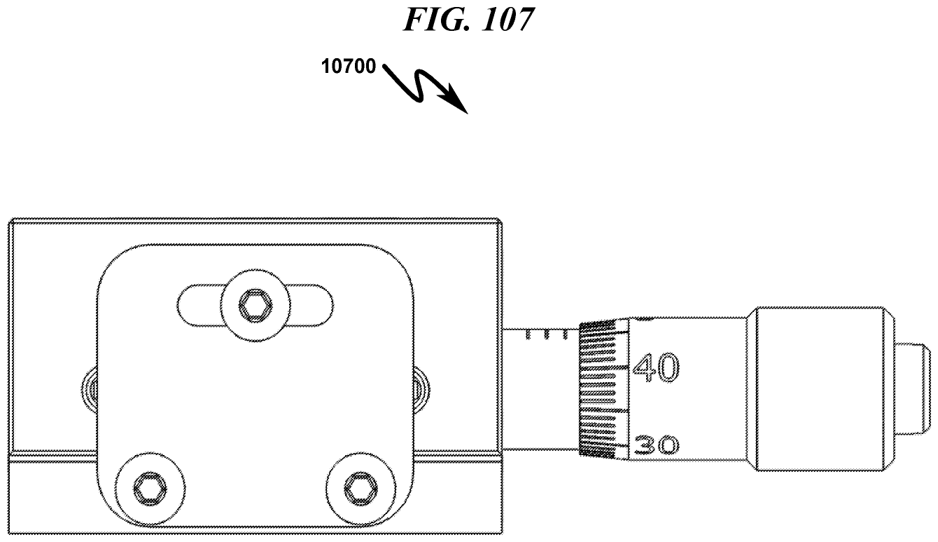

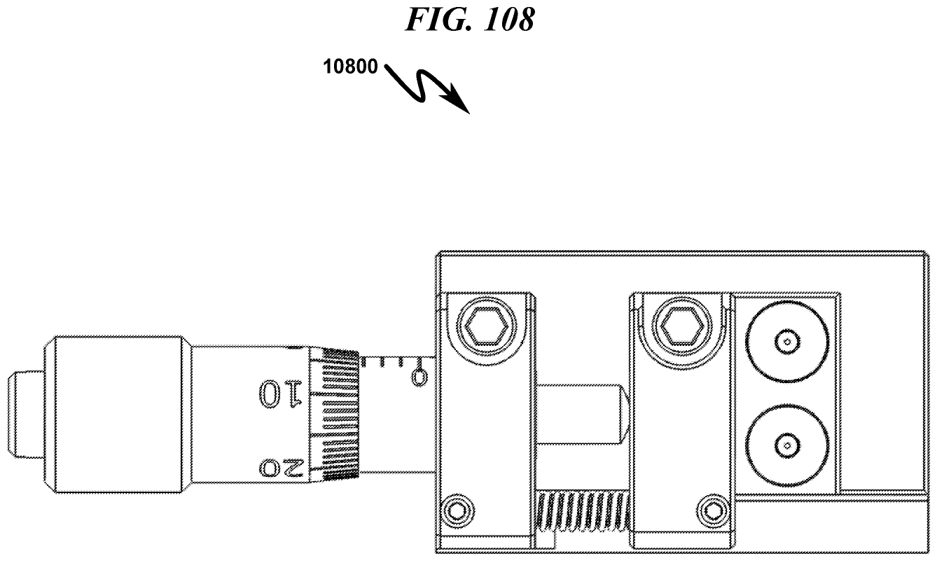

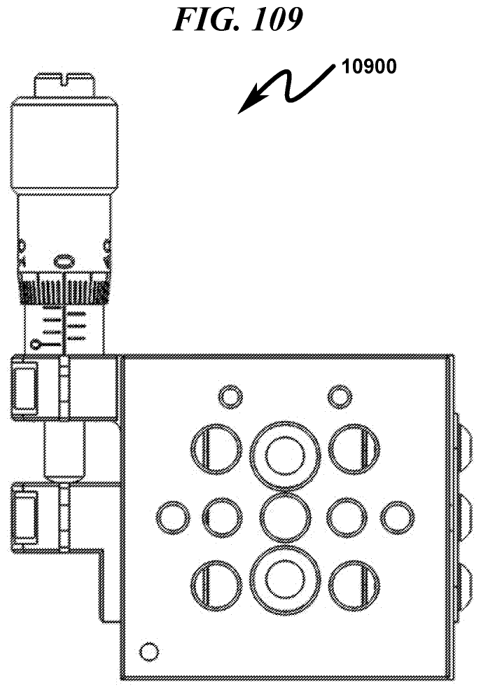

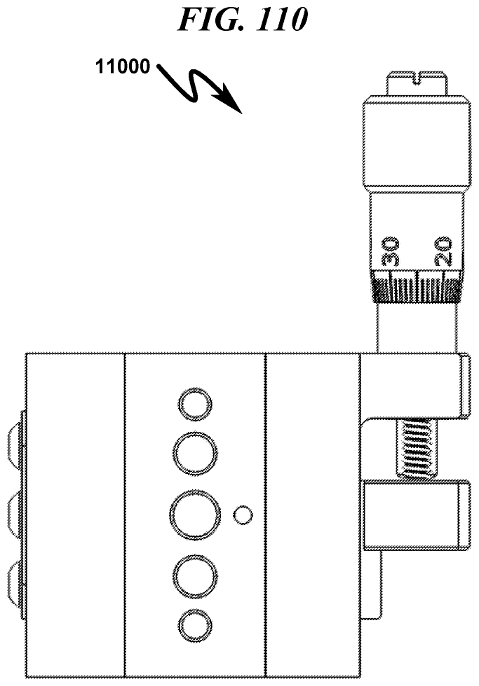

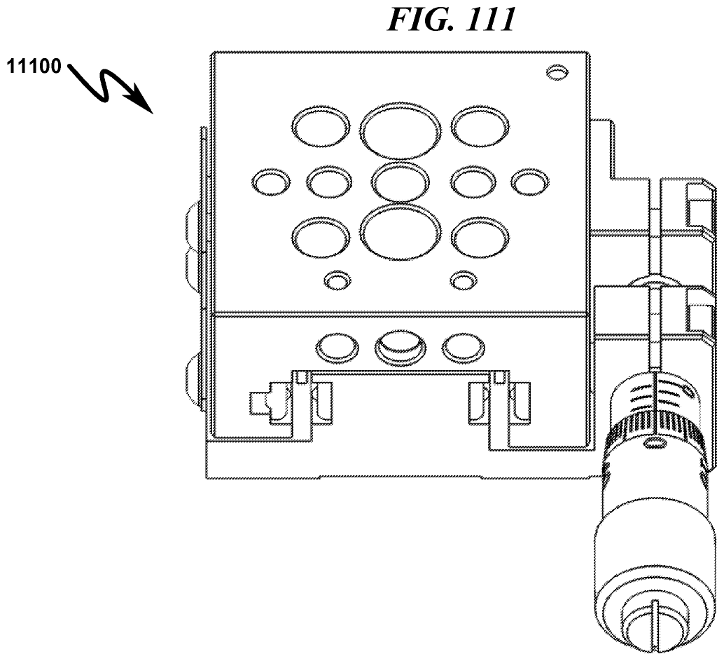

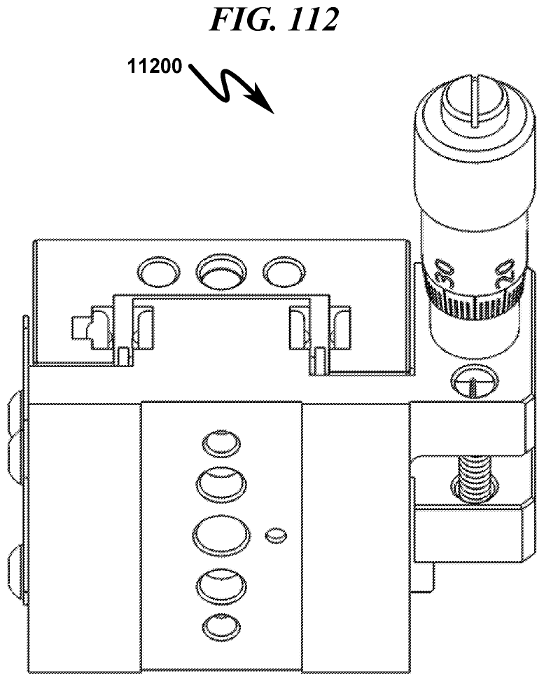

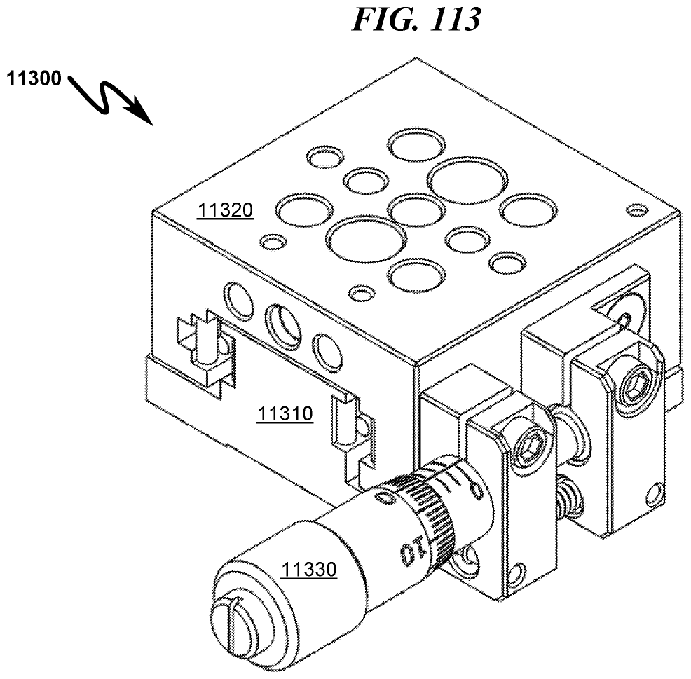

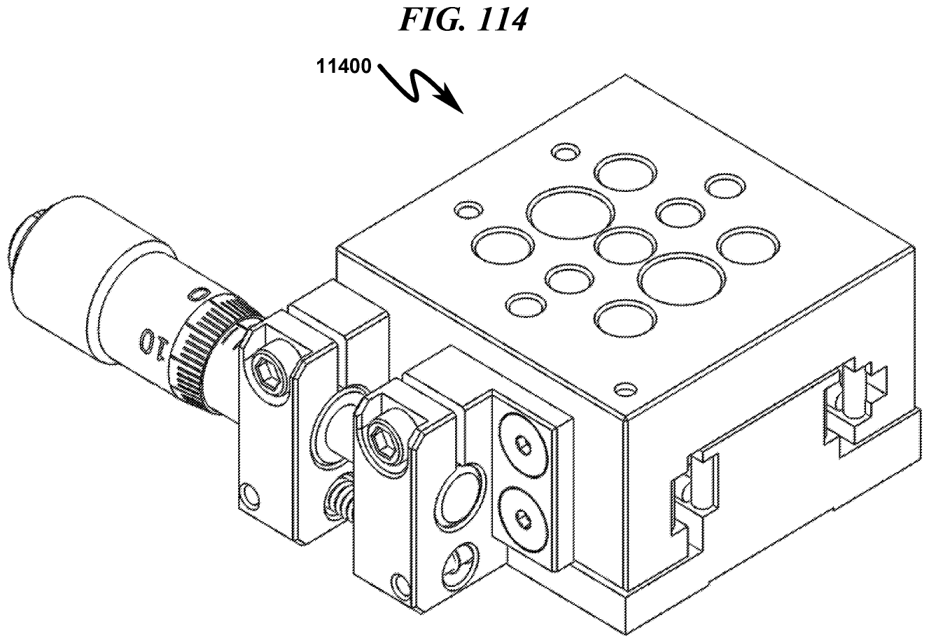

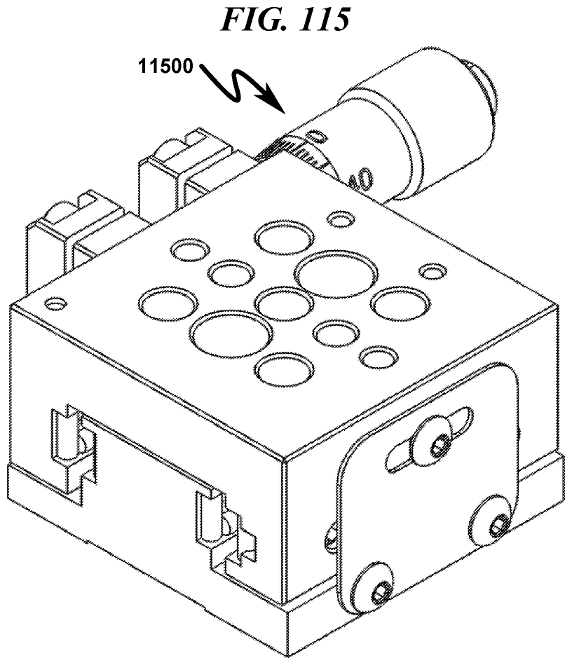

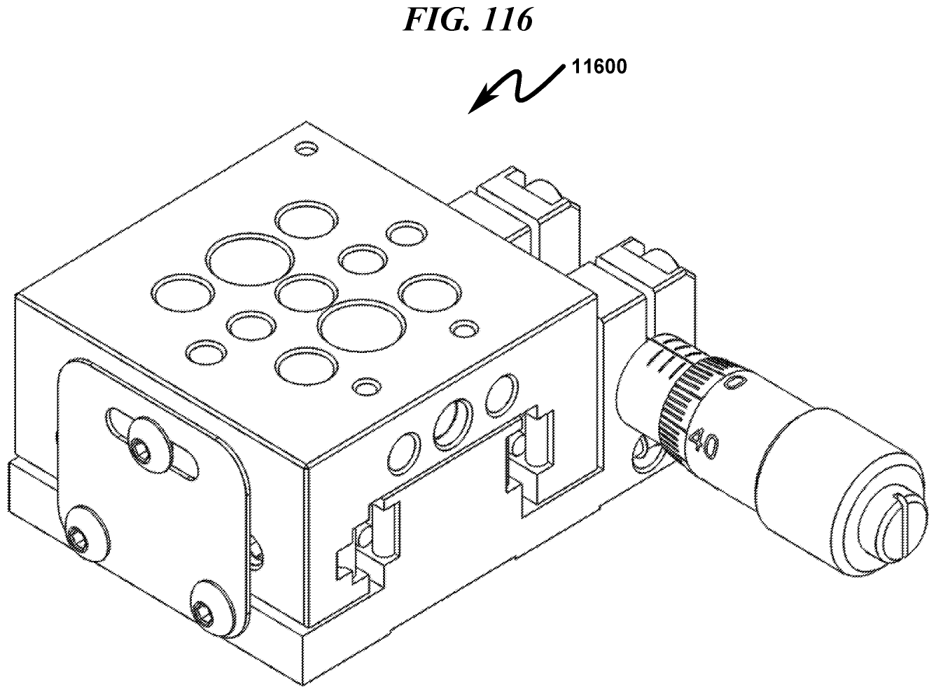

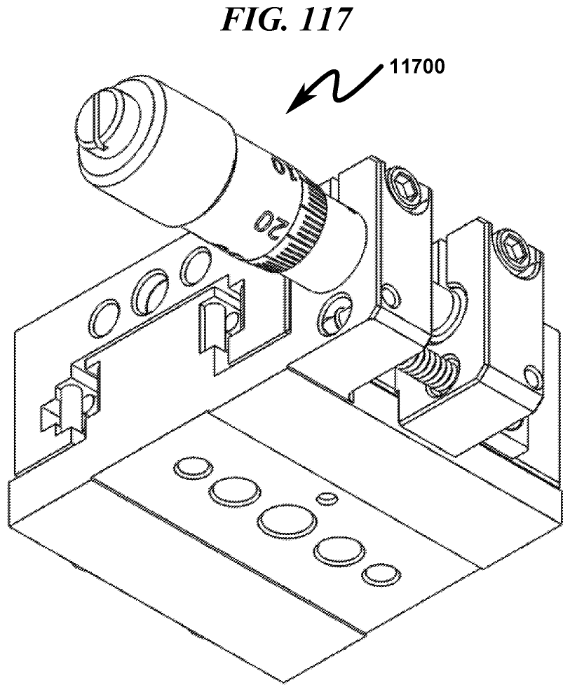

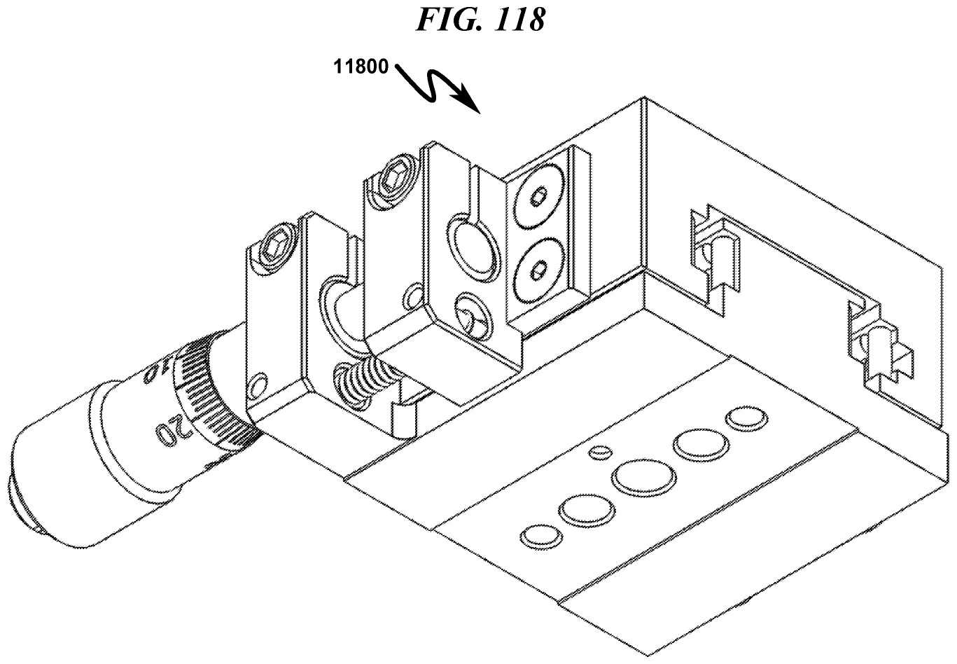

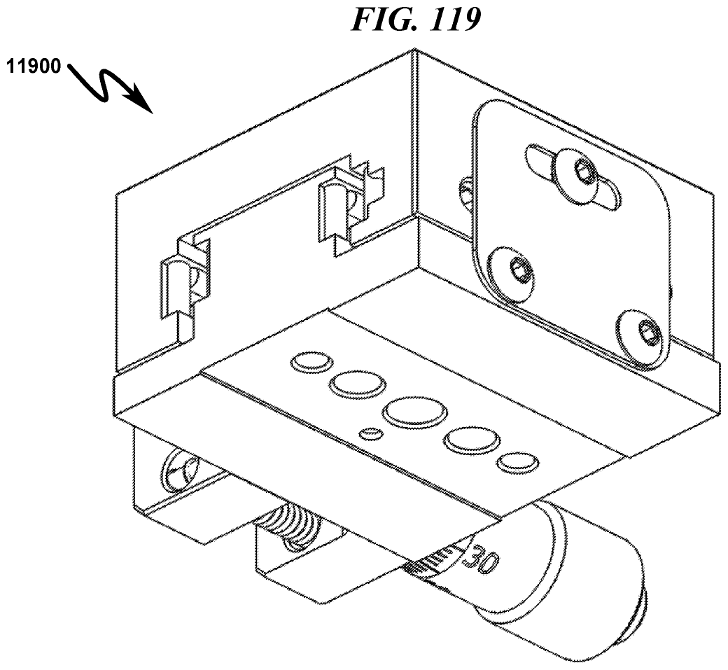

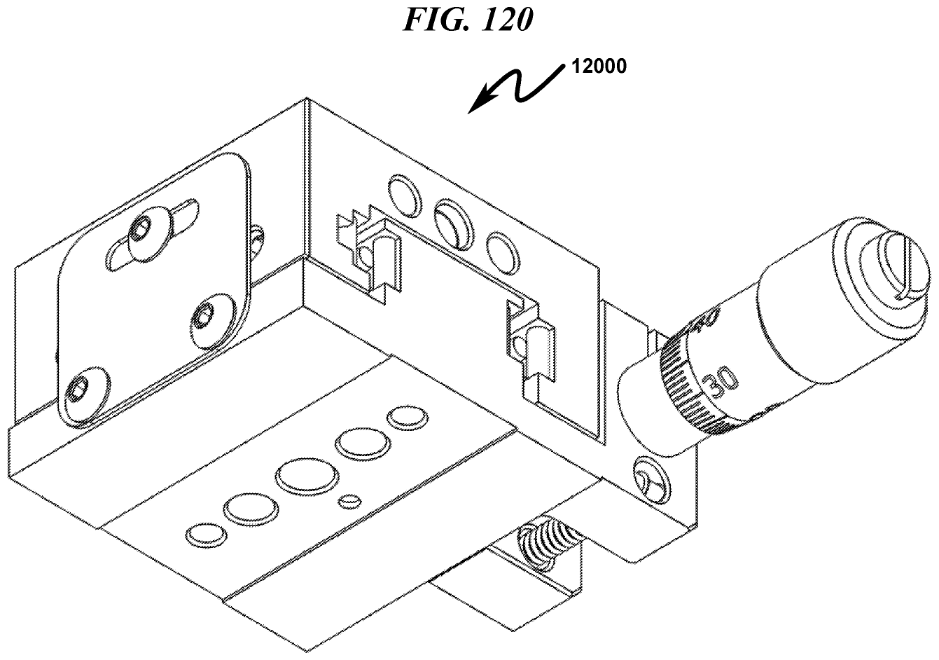

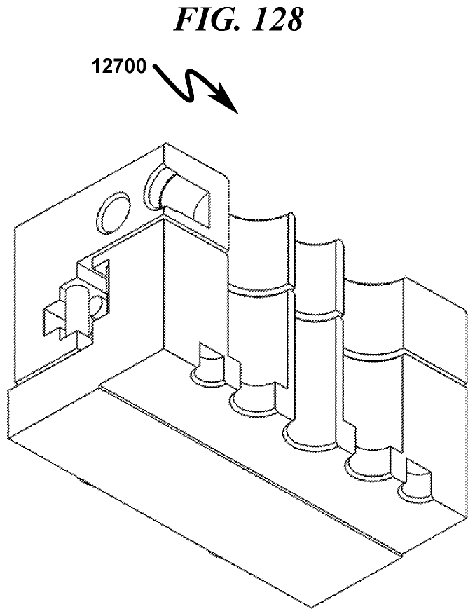

While the present invention may utilize a variety of mechanisms to affect longitudinal positioning of a variety of optics within the overall OTA, many preferred invention embodiments employ a micrometer-based longitudinal axis positioning platform (LAP) as generally depicted in detail in FIG. 105 (10500)-FIG. 128 (12800).

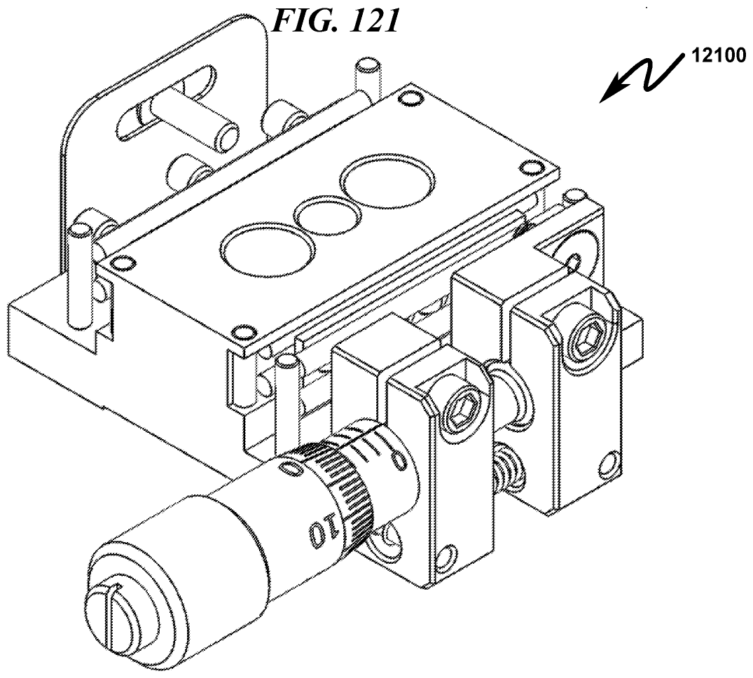

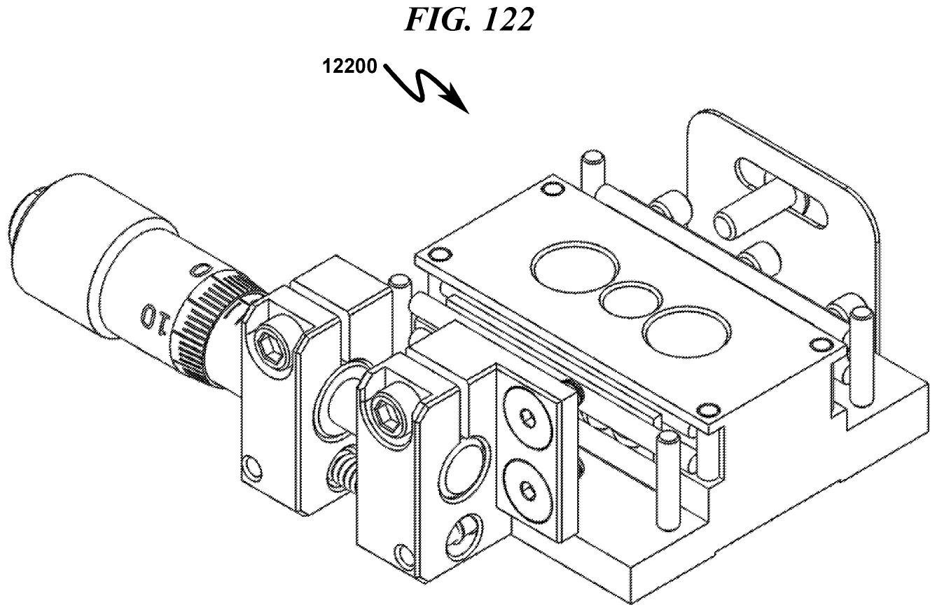

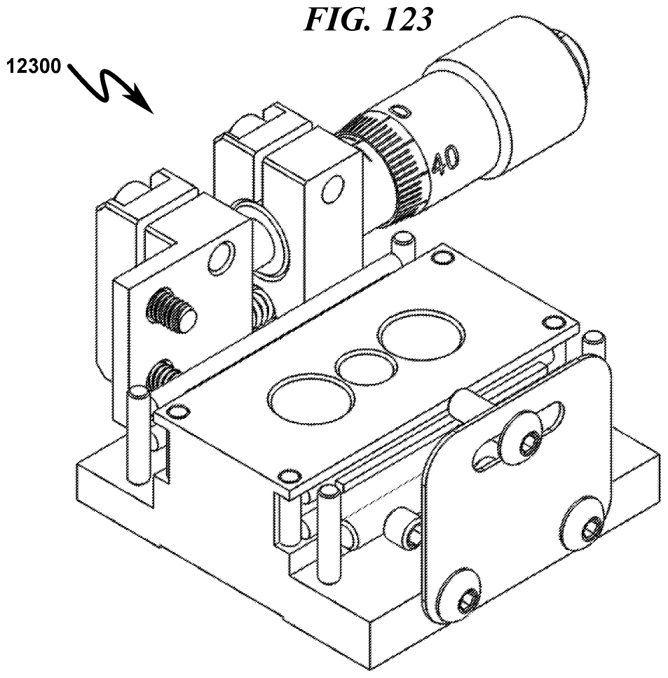

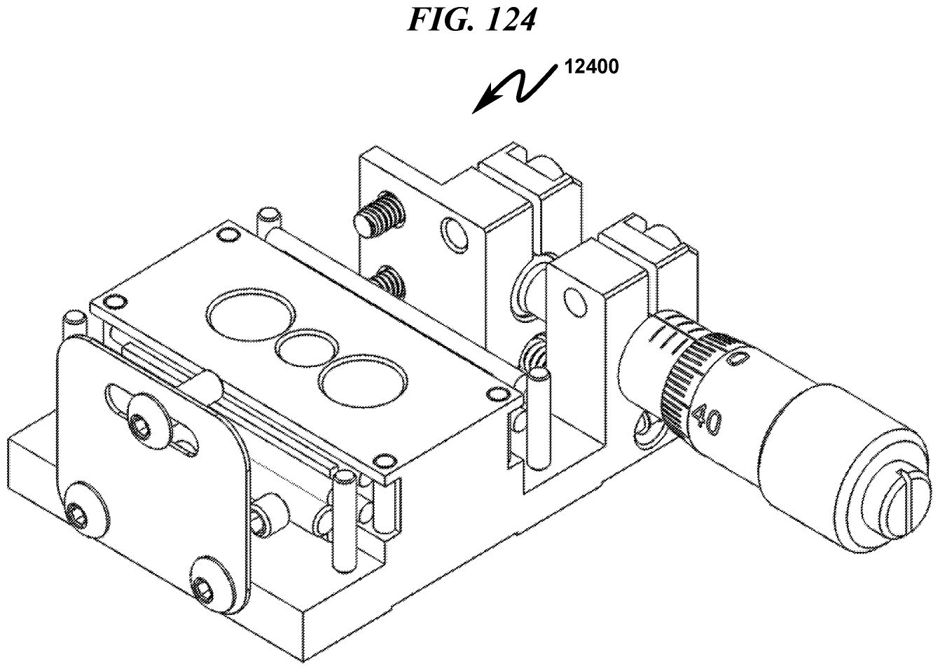

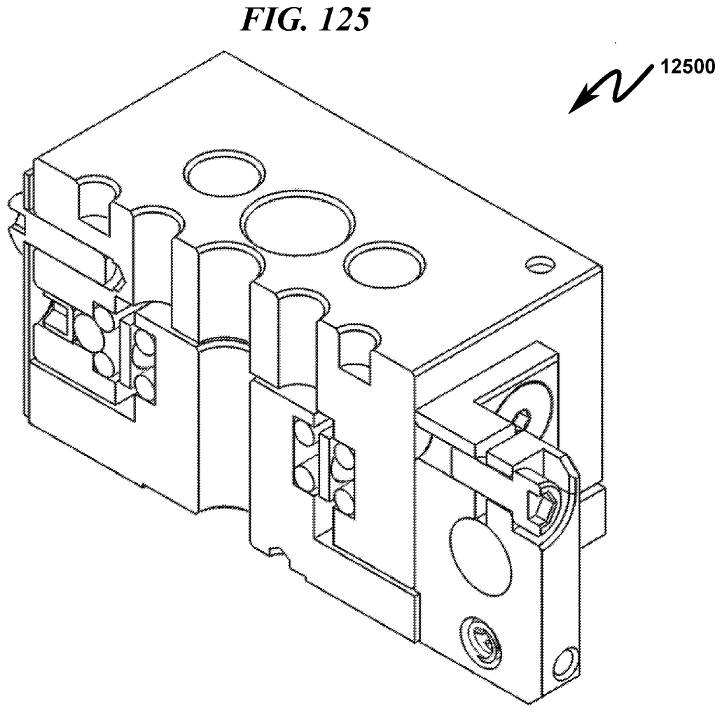

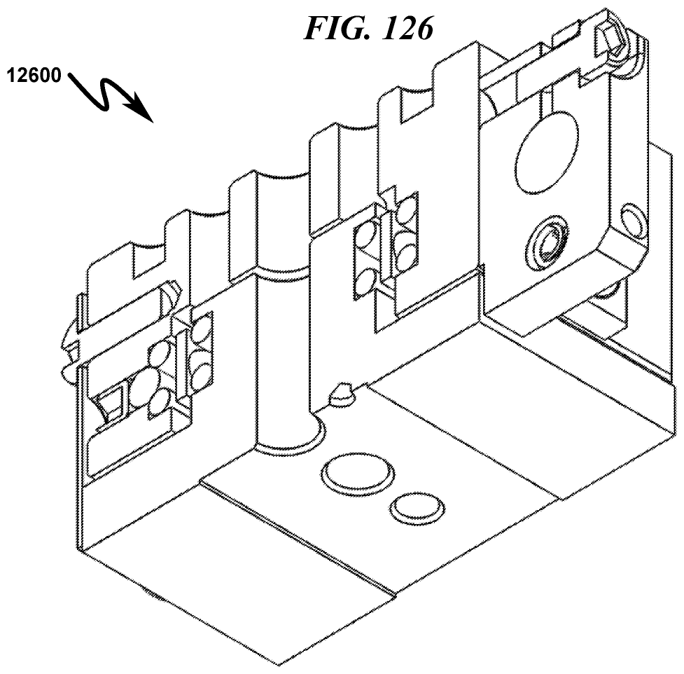

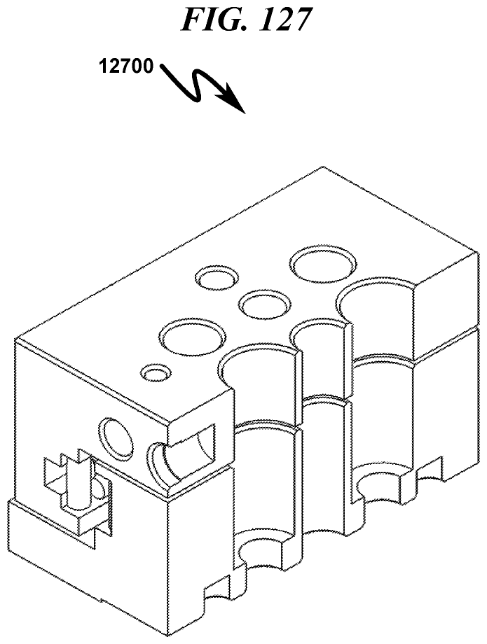

The LAP depicted herein is a general purpose longitudinal axis positioner that employs a base support plate (BSP) (10510, 11310) supporting a top support plate (TSP) (10520, 11320) through a series of mechanical connections that include a manual movement actuator (MMA) (10530, 11330) that actuates controlled movement and positioning of the top support plate (TSP) (10520, 11320) along a longitudinal axis and along a parallel plane with respect to the base support plate (BSP) (10510, 11310). FIG. 121 (12100)-FIG. 128 (12800) illustrate a series of detail assembly views in which various components of the LAP are removed/hidden to show assembly details and internal construction of the LAP.

The use of this general purpose LAP configuration (10500-12800) allows proper spacing of the lens structures within the OTA with respect to external light/laser sources along a common longitudinal axis to permit proper calibration and testing of the overall optical system employing the IOL (or other item to be tested such as the cornea or natural lens) under evaluation. While preferred embodiments of the present invention are depicted using two identical LAP preferred exemplary embodiments as generally depicted in FIG. 105 (10500)-FIG. 128 (12800), the present invention is not limited to this configuration and the LAPs used in a given invention embodiment may differ in construction without loss of generality in the overall invention scope.

As mentioned previously, in some preferred embodiments the mechanical adjustment controls for the LAP may be implemented using electric motor servos under digital computer control executing machine instructions read from a computer-readable medium.

### Optional Configuration—APP Absent (12900)-(13600)

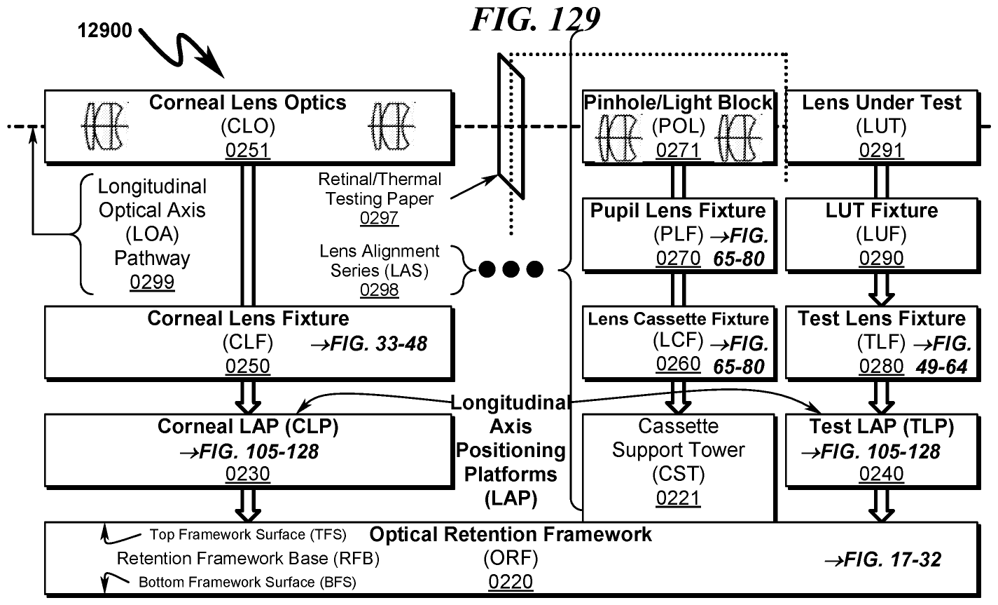

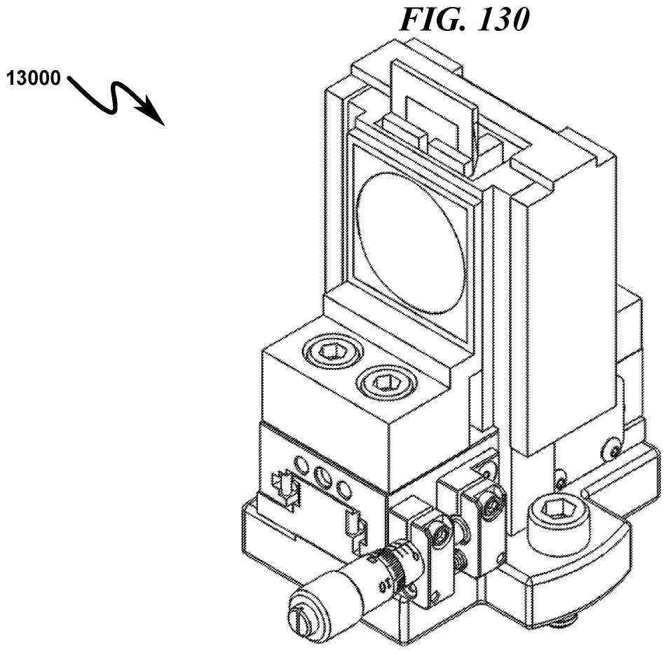

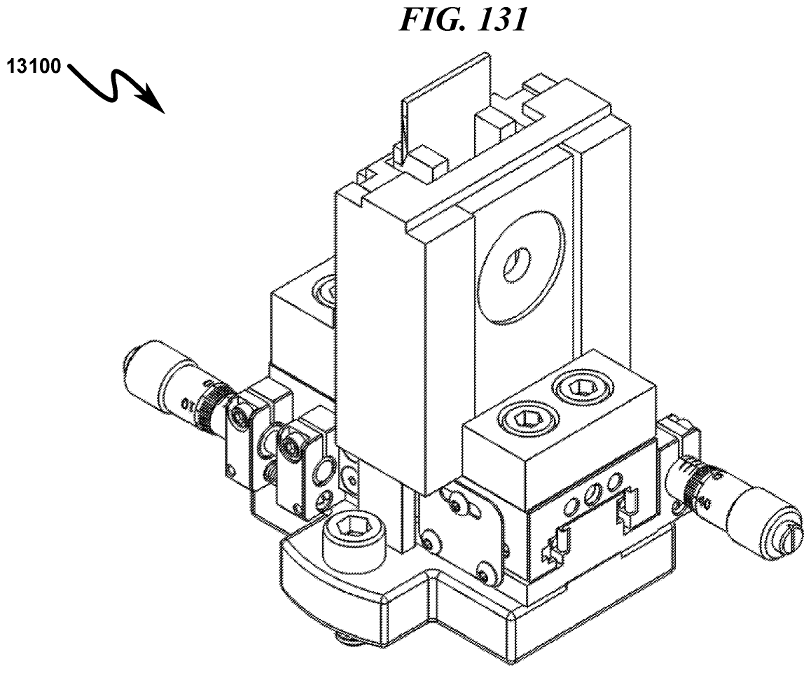

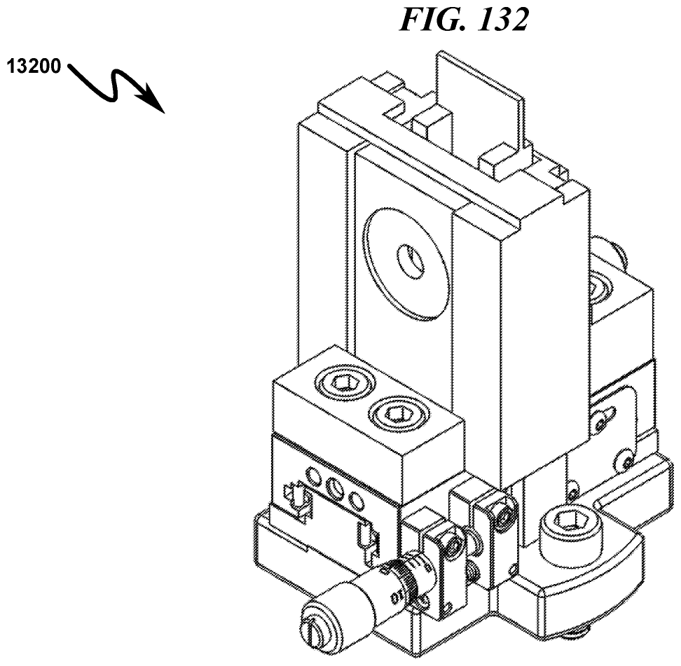

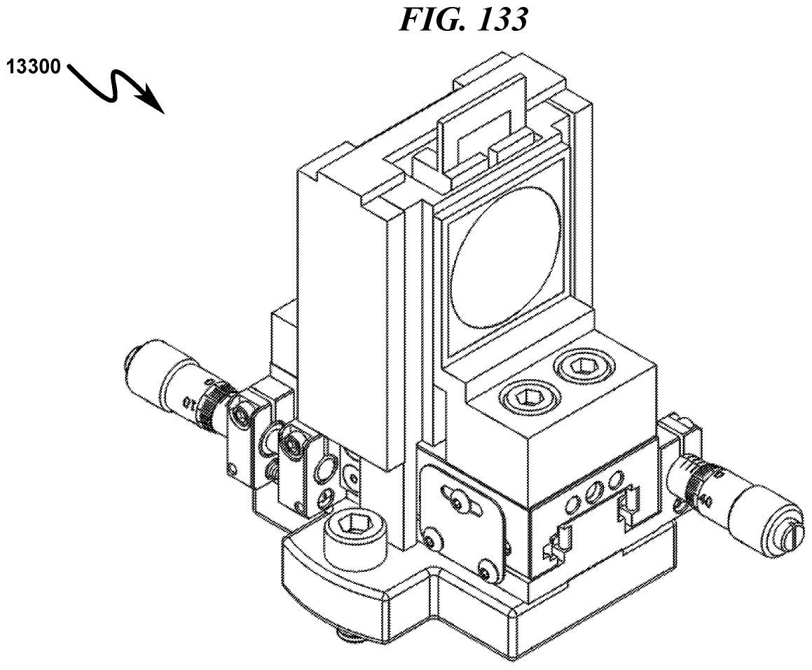

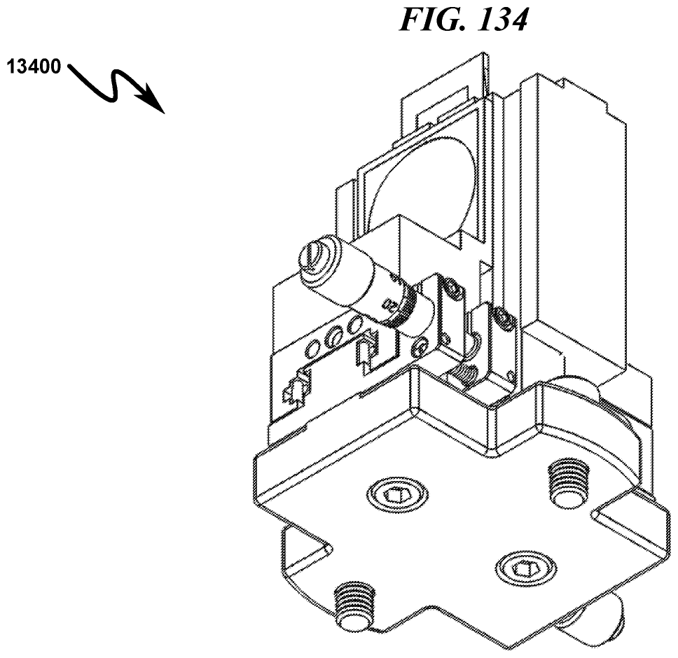

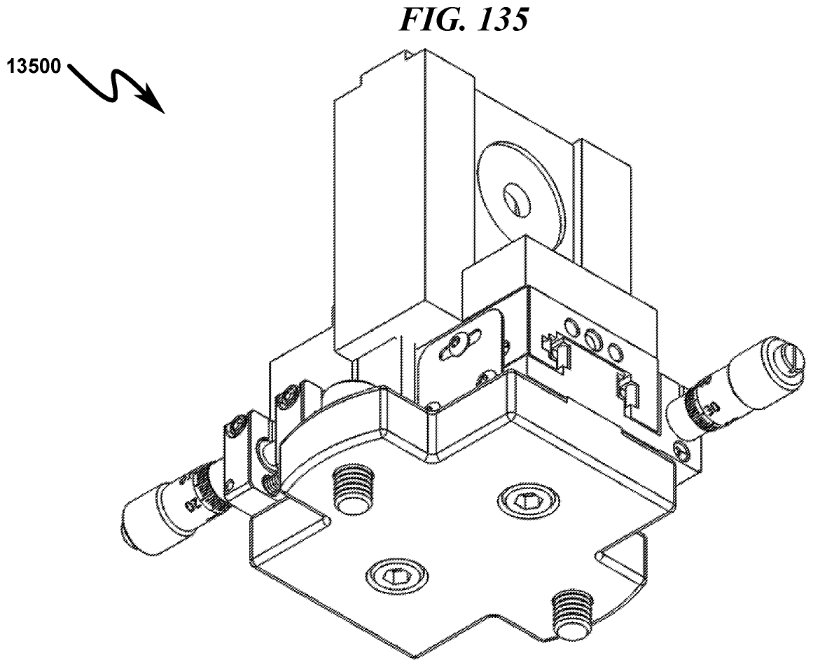

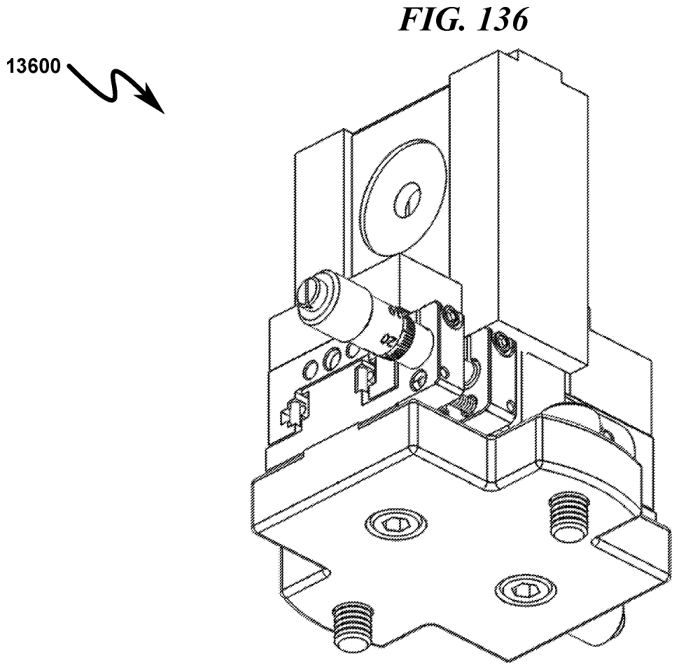

The present invention may omit one or more of the elements depicted in FIG. 2 (0200) as generally depicted in the system block diagram and resulting images depicted in FIG. 129 (12900)-FIG. 136 (13600). In this optional embodiment configuration the APP is absent from the overall construction with remaining elements present as previously discussed herein.

### Optional Configuration—APP+PLF+PLO Absent (13700)-(14400)

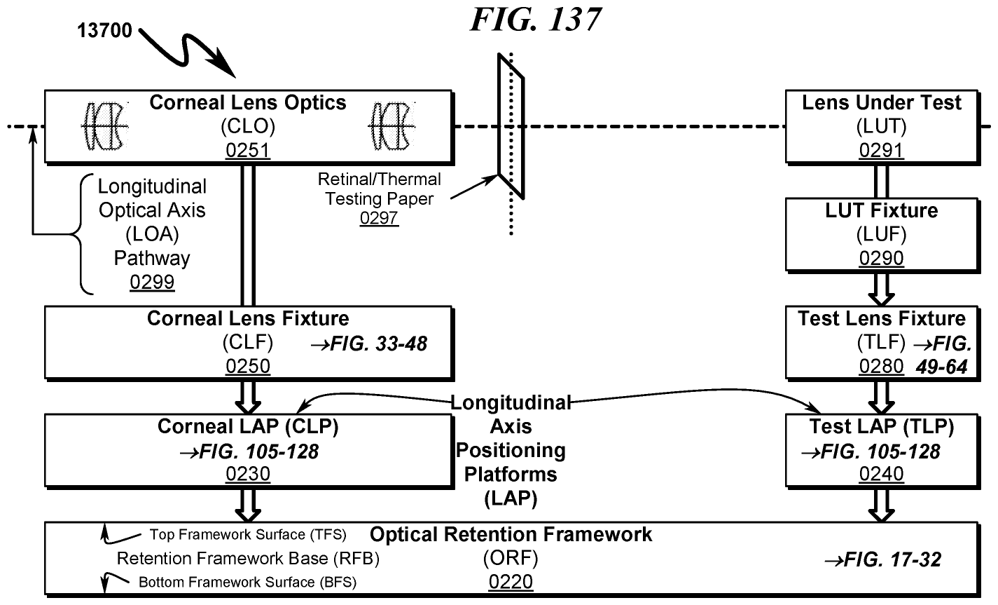

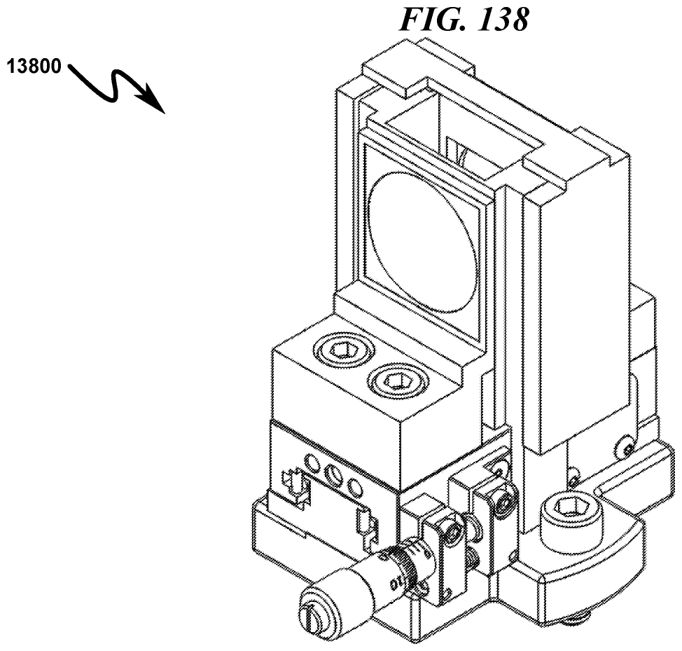

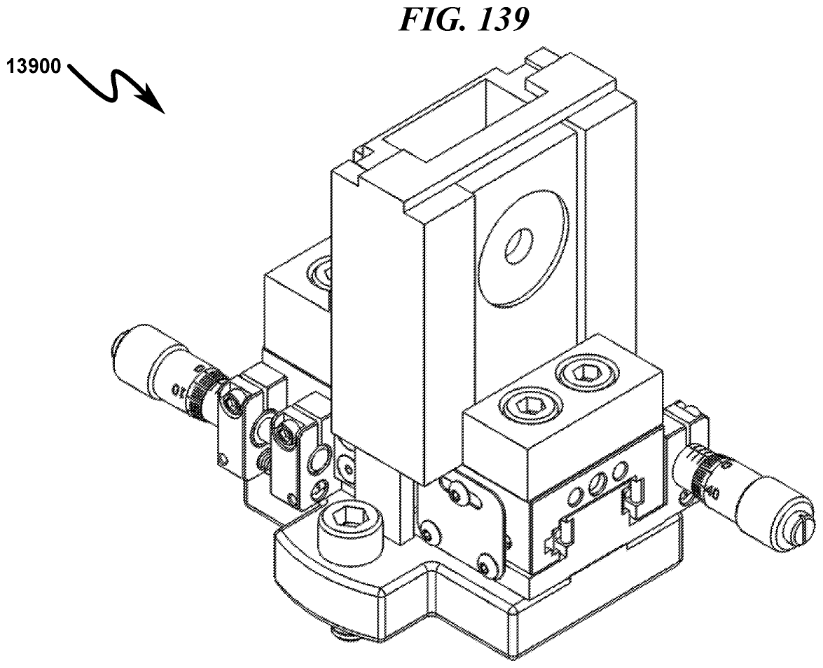

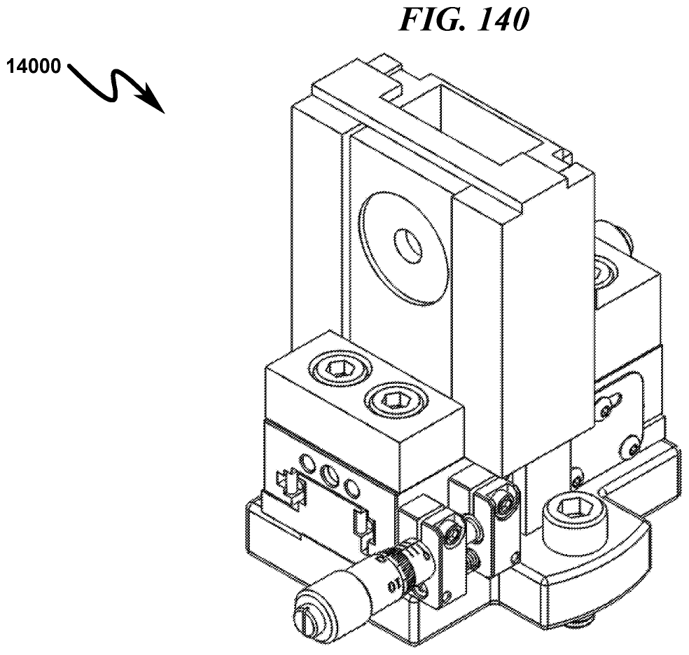

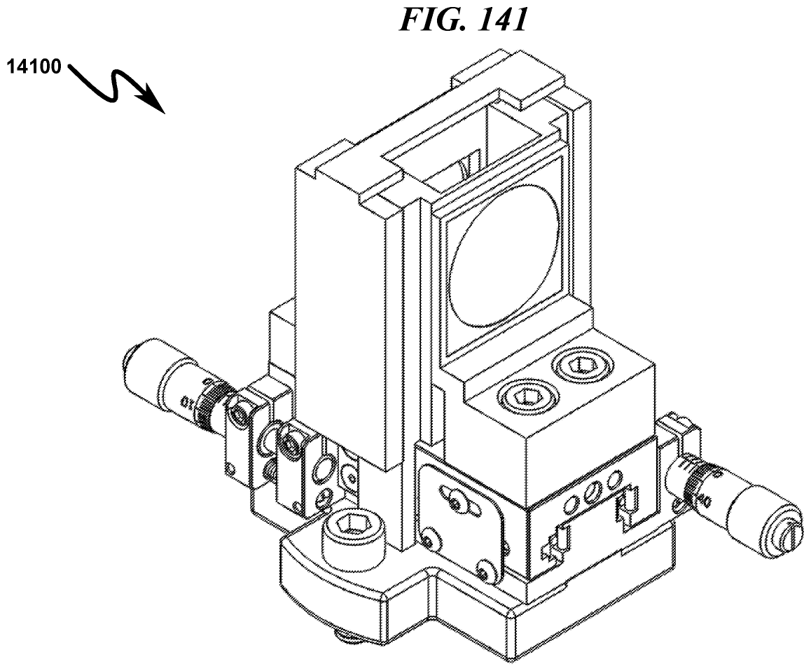

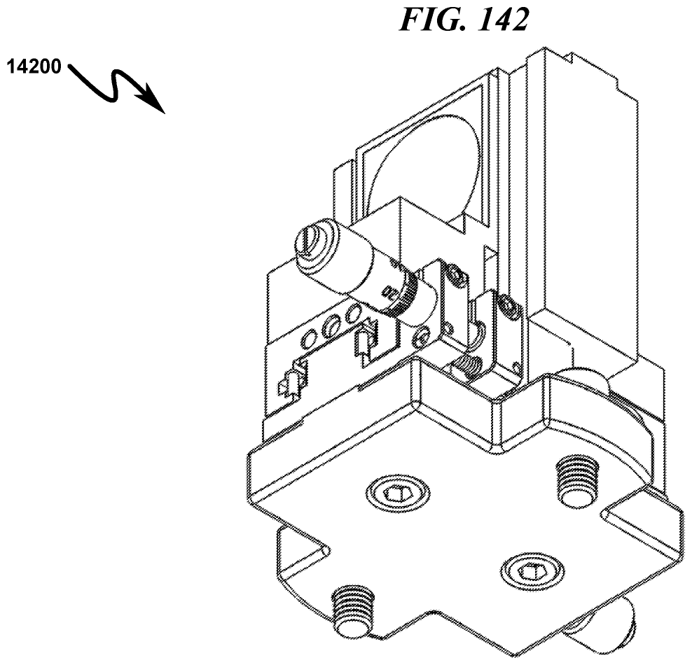

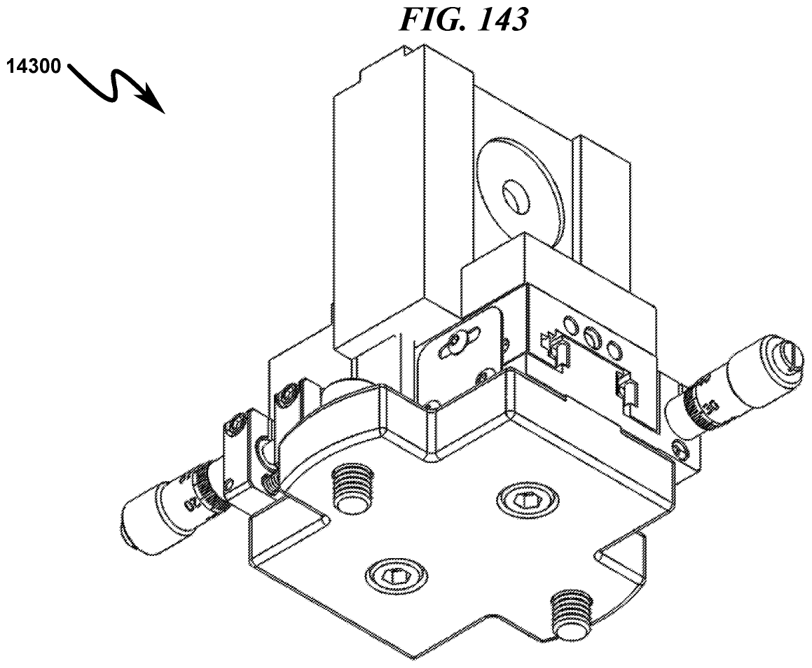

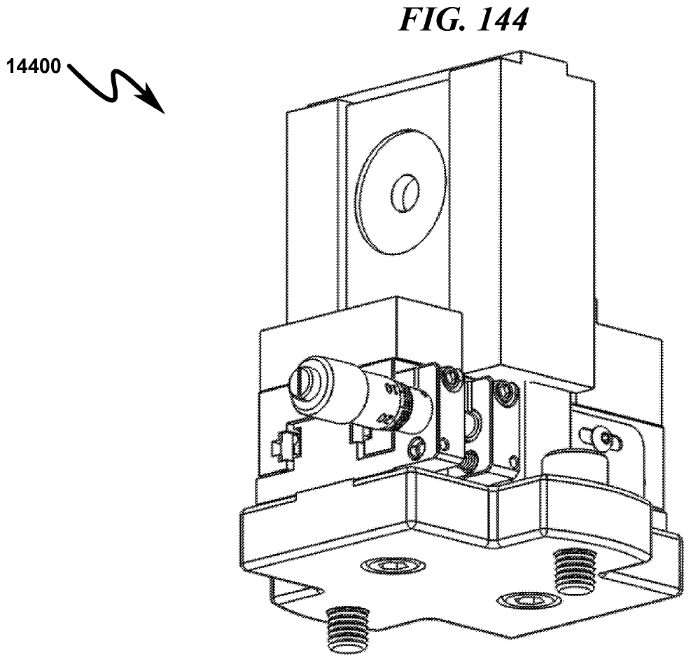

The present invention may omit one or more of the elements depicted in FIG. 2 (0200) as generally depicted in the system block diagram and resulting images depicted in FIG. 137 (13700)-FIG. 144 (14400). In this optional embodiment configuration the APP+PLF+PLO are absent from the overall construction with remaining elements present as previously discussed herein.

### Optional Configuration—APP+PLF+PLO+TLP Absent (14500)-(15200)

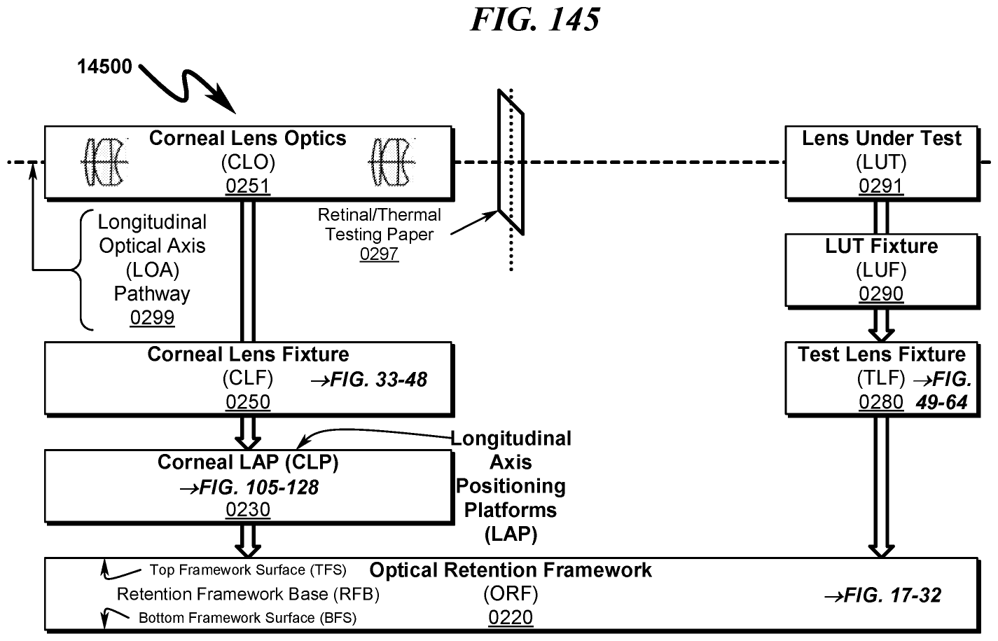

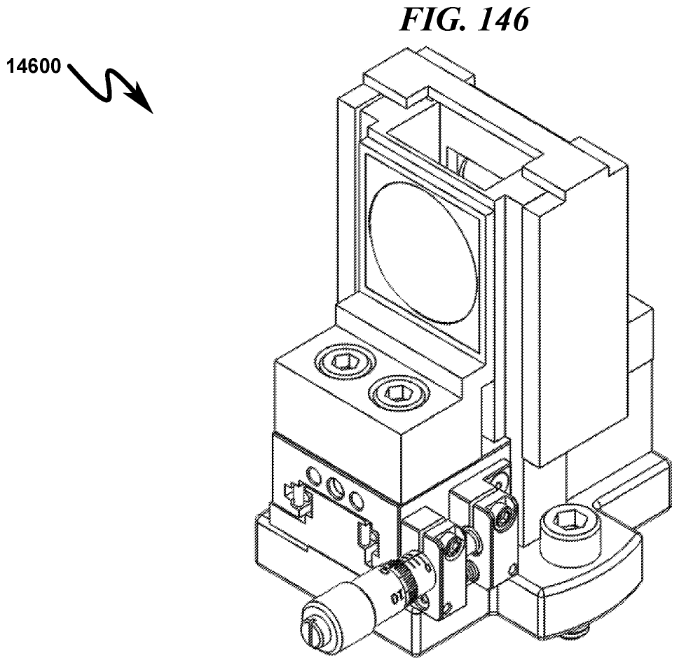

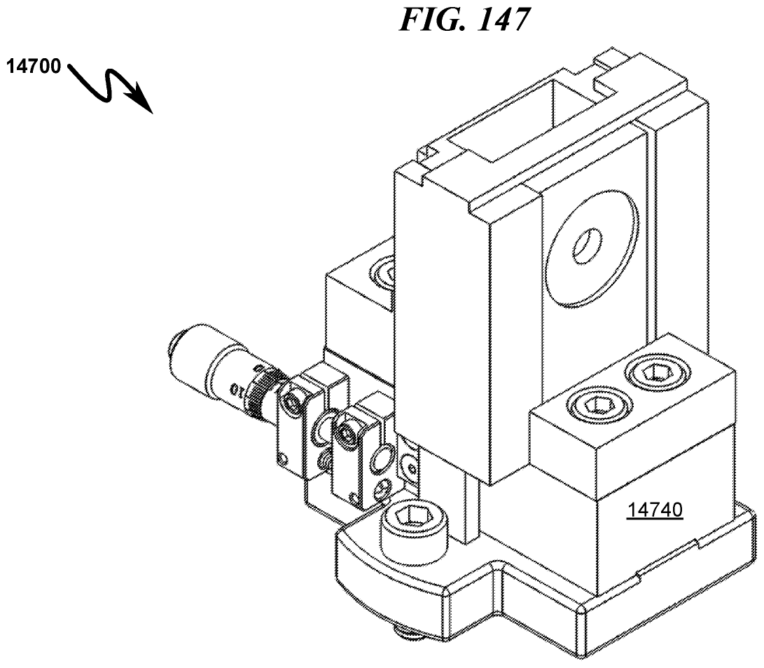

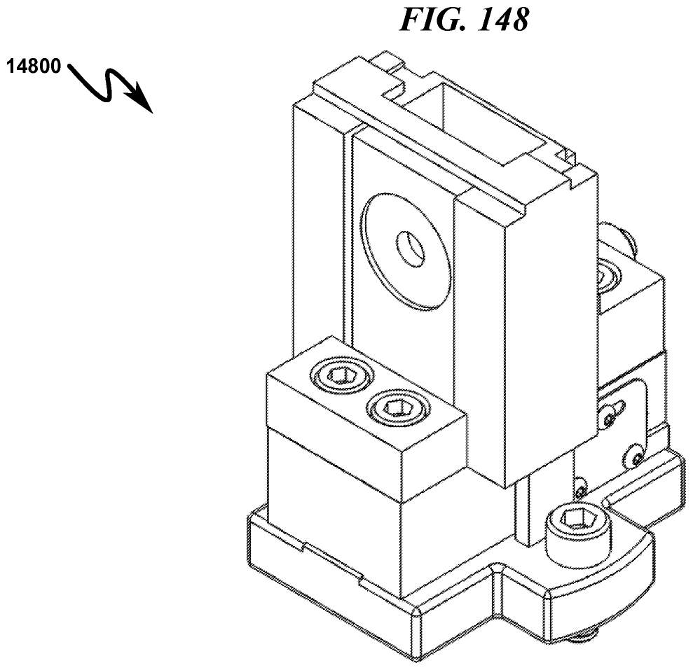

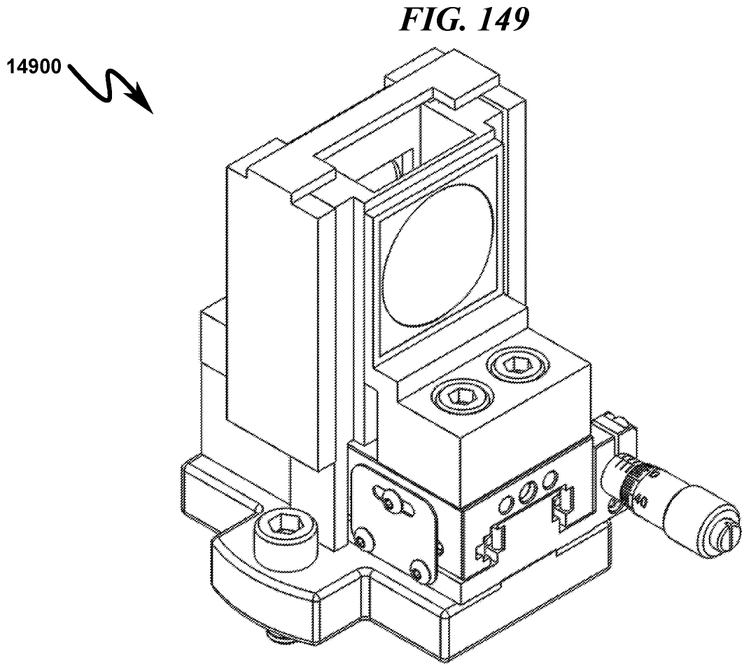

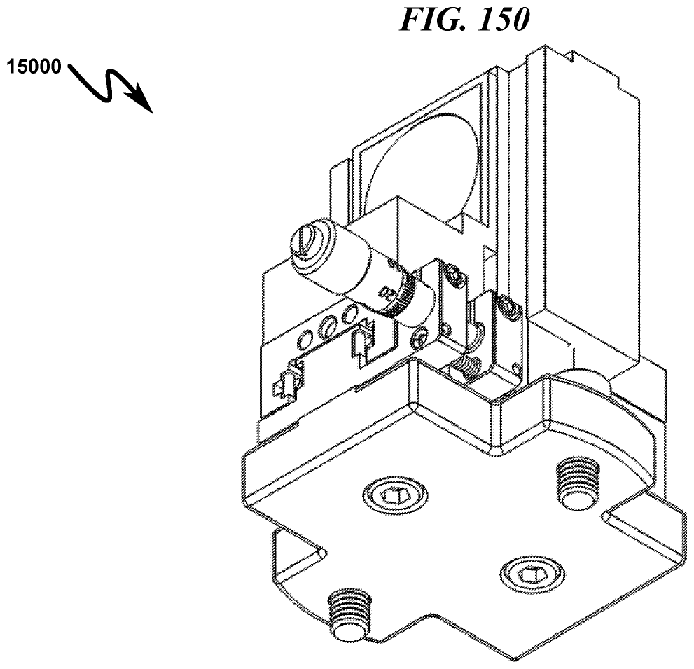

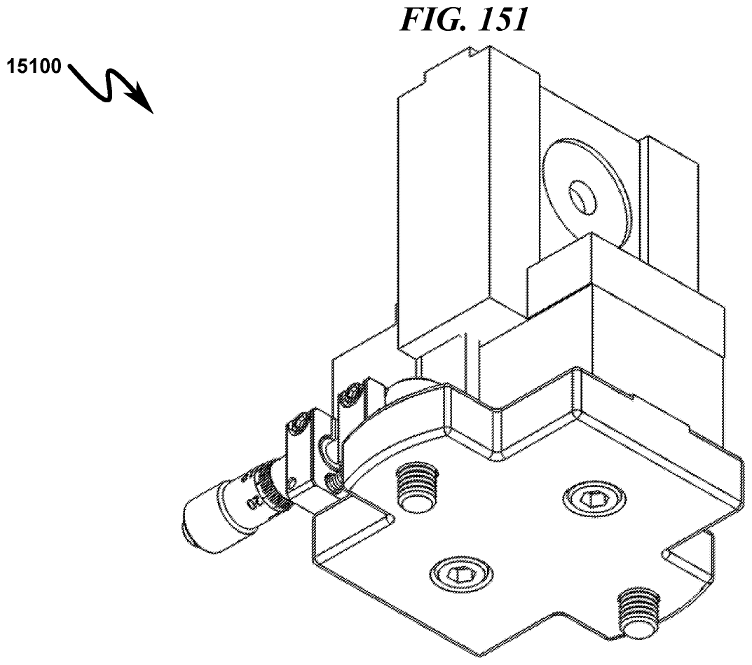

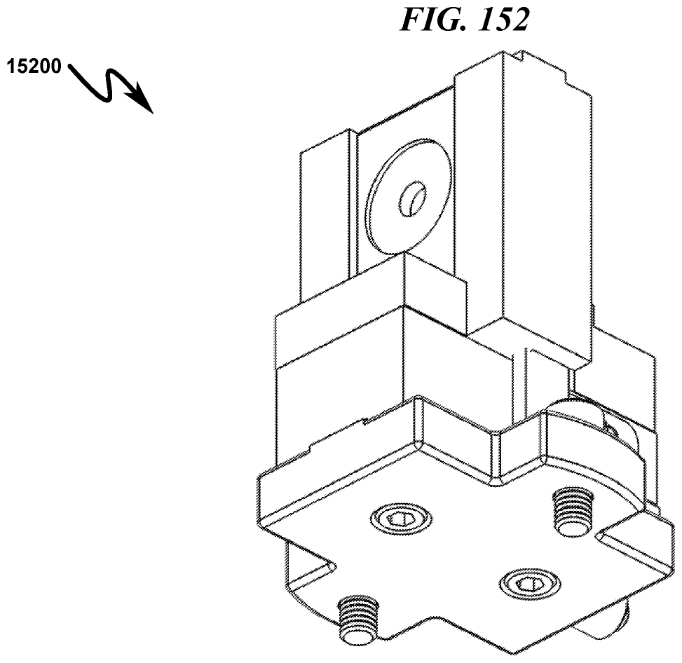

The present invention may omit one or more of the elements depicted in FIG. 2 (0200) as generally depicted in the system block diagram and resulting images depicted in FIG. 145 (14500)-FIG. 152 (15200). In this optional embodiment configuration the APP+PLF+PLO+TLP are absent from the overall construction with remaining elements present as previously discussed herein. As shown in this depicted configuration, the TLP has been replaced with a fixed spacer block (14740). However, one skilled in the art will recognize that this fixed spacer block (14740) may be integrated into the TLF with no loss of invention function.

### Optional Configuration—APP+TLP+TLF Absent (15300)-(16000)

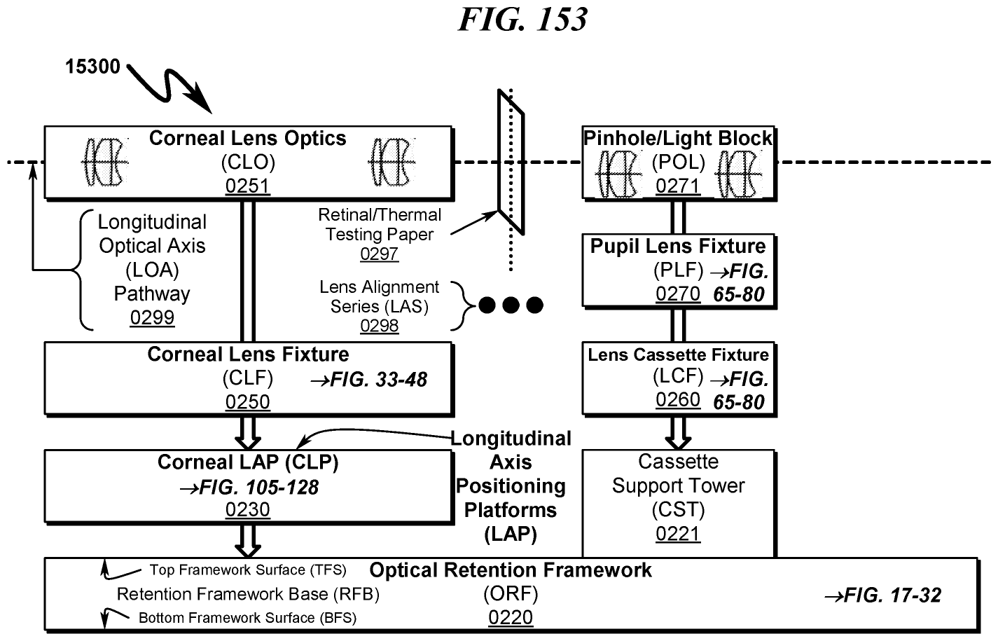

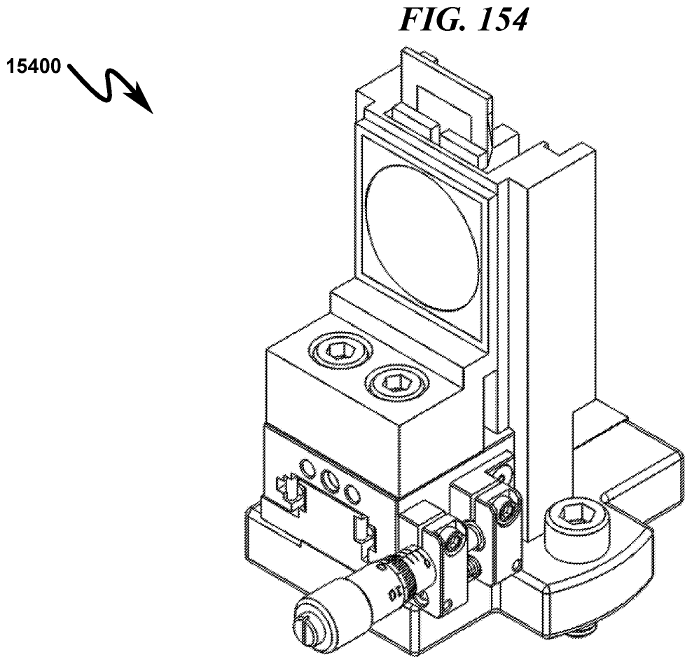

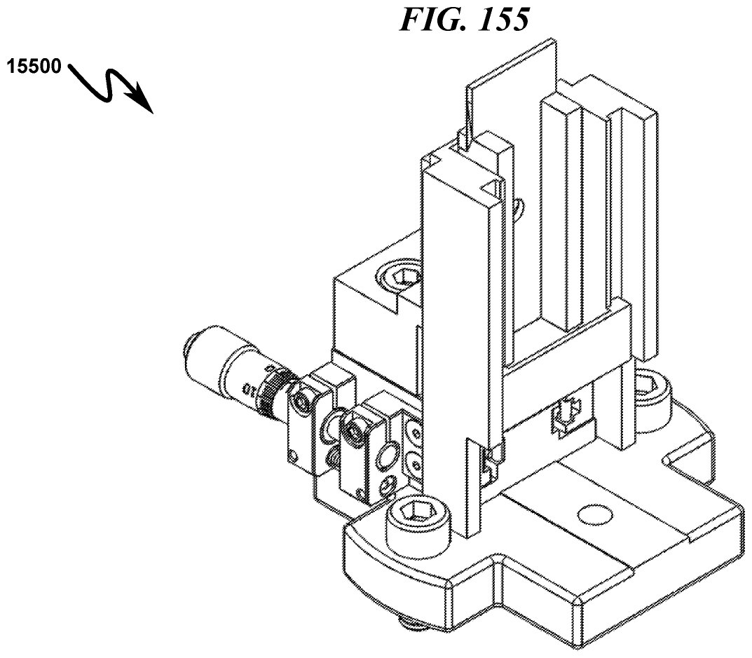

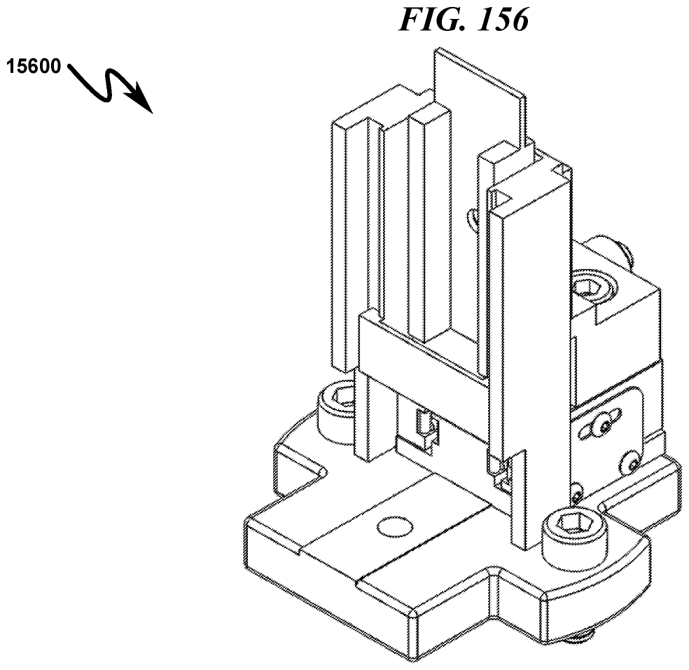

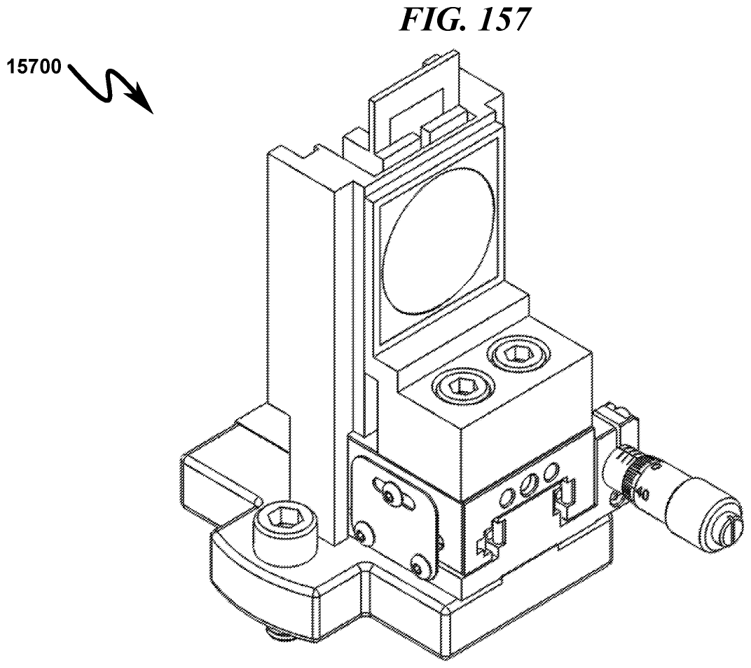

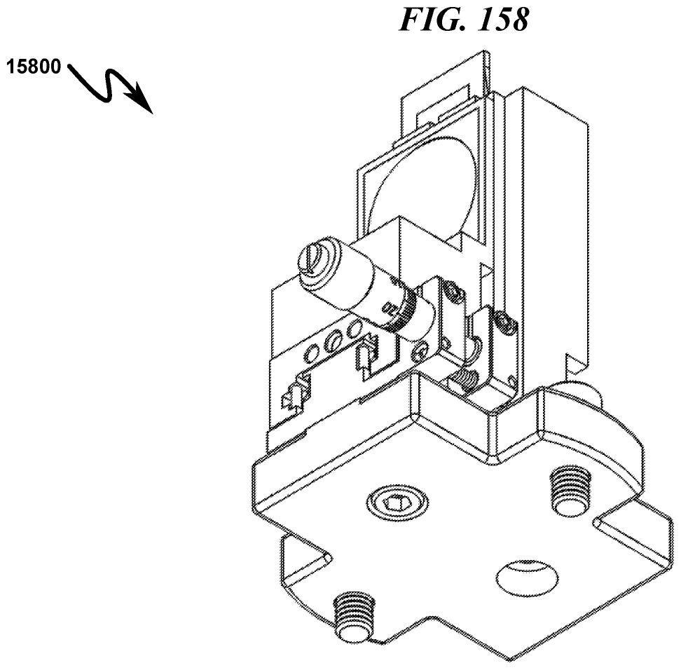

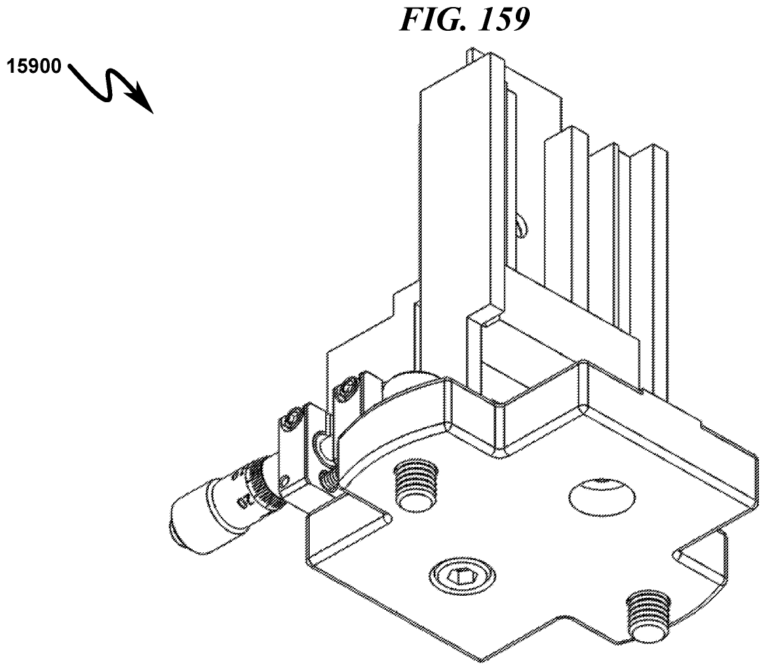

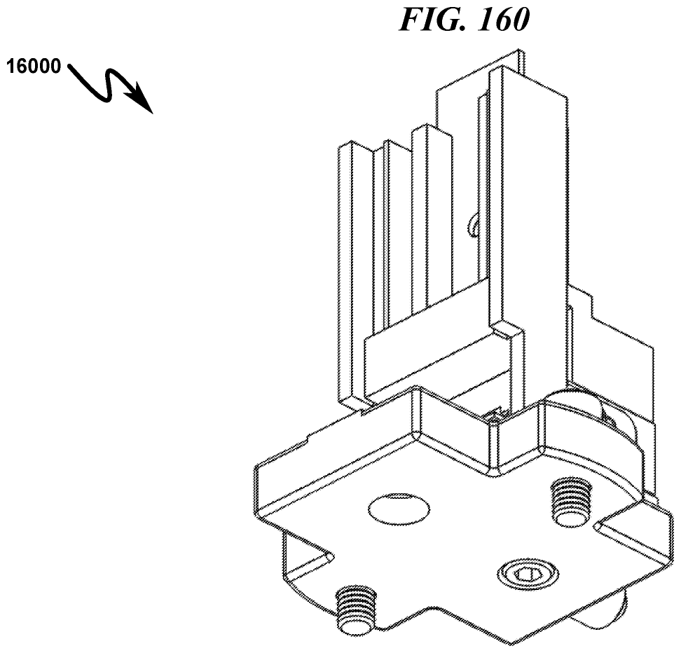

The present invention may omit one or more of the elements depicted in FIG. 2 (0200) as generally depicted in the system block diagram and resulting images depicted in FIG. 153 (15300)-FIG. 160 (16000). In this optional embodiment configuration the APP+TLP+TLF are absent from the overall construction with remaining elements present as previously discussed herein.

### Combinations of Construction Anticipated

The present invention anticipates that combinations of the previously discussed optional configurations may be present in one or more preferred invention embodiments with one or more of the invention elements omitted based on application context.

### Method Overview (16100)

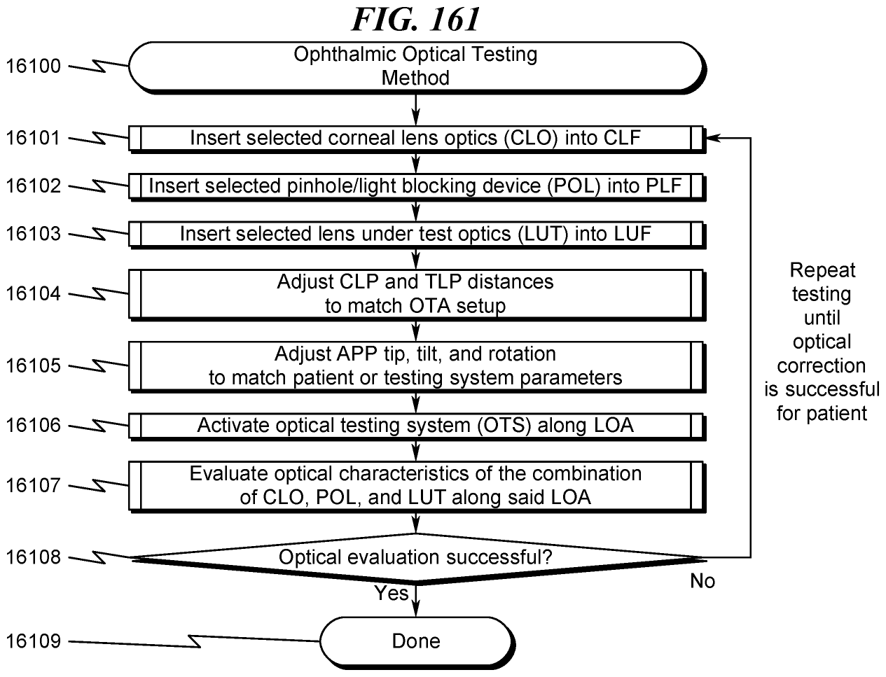

The present invention method may be broadly generalized as an optical testing method as generally depicted in the flowchart of FIG. 161 (16100), the method used in conjunction with an optical testing system, the system comprising:
(a) axial positioning platform (APP);
(b) optical retention framework (ORF);
(c) corneal longitudinal axis positioning platform (CLP);
(d) corneal lens fixture (CLF);
(e) corneal lens optics (CLO);
(f) lens cassette fixture (LCF);
(g) pupil lens fixture (PLF);
(h) pinhole or light block device (POL);
(i) test longitudinal axis positioning platform (TLP);
(j) test lens fixture (TLF);
(k) lens under test fixture (LUF); and
(l) lens under test (LUT);

wherein:
the APP comprises an axial base platform (ABP) and an axial support platform (ASP);
the APP allows tip, tilt, and vertical axial adjustment of the ASP with respect to the ABP;
the ORF comprises a retention framework base (RFB) having a top framework surface (TFS) and a bottom framework surface (BFS) and a cassette support tower (CST) perpendicular to the TFS;
the BFS is mechanically coupled to the ASP;
the CLP comprises a corneal top movable surface (CTS) and a corneal bottom base surface (CBS);
the CBS is mechanically coupled to the TFS;
the CLF comprises a corneal mating surface (CMS) and retains the CLO held in perpendicular alignment with the CMS;
the CMS is mechanically coupled to the CTS;
the PLO is retained within the PLF;
the PLF is retained within the LCF;
the LCF is supported within a slot contained in the CST;
the TLP comprises a test top movable surface (TTS) and a test bottom base surface (TBS);
the TBS is mechanically coupled to the TFS;
the IOL is retained by the LUF;
the LUF is retained within a slot of the TLF;
the TLF is mechanically coupled to the TTS;
the CLO, the PLO, and the IOL are aligned along a common longitudinal optical axis (LOA);
the LOA is parallel to the TFS;
the CLP allows longitudinal parallel movement of the CTS with respect to the LOA; and
the TLP allows longitudinal parallel movement of the TTS with respect to the LOA;

the method comprising the steps of:
(1) inserting selected corneal lens optics (or custom optic) (CLO) into the CLF (16101);
(2) inserting selected pinhole or light block device (POL) into the PLF (16102);
(3) inserting selected test intraocular lens (IOL) into the LUF (16103);
(4) adjusting CLP and TLP distances to match the to match the setup parameters of the OTA (16104);
(5) adjusting APP tip, tilt, and rotation to match the patient eye characteristics (or the parameters of the testing system to be employed) (16105);
(6) activating an optical test system along the LOA (16106);
(7) evaluating the optical characteristics of the combination of the CLO, the PLO, and the IOL along the LOA (16107); and
(8) determining if the optical evaluation is successful, and if not, repeating steps (1)-(7) until the evaluation generates a successful optical correction suitable for the patient (16108).
   This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Alternative Methods (16200)-(16800)

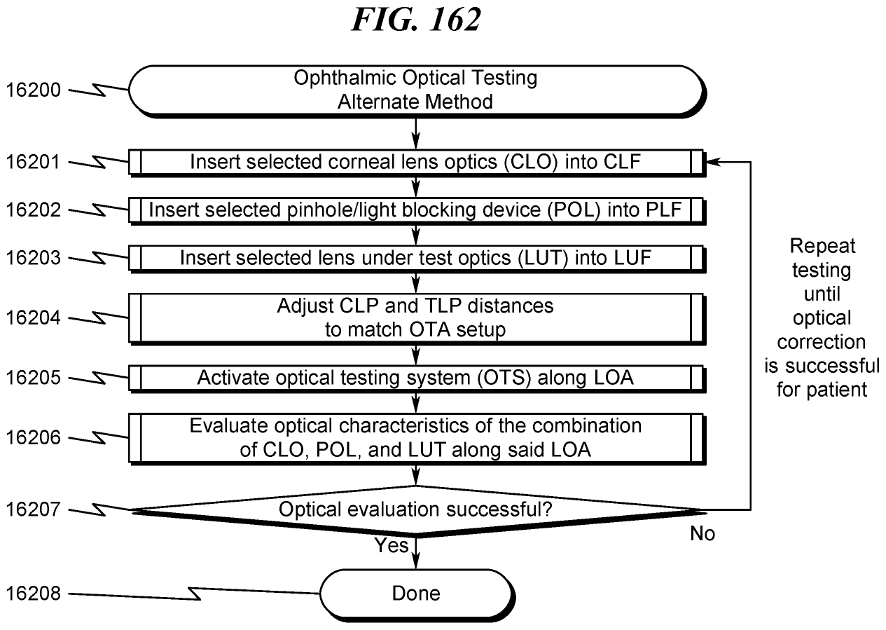

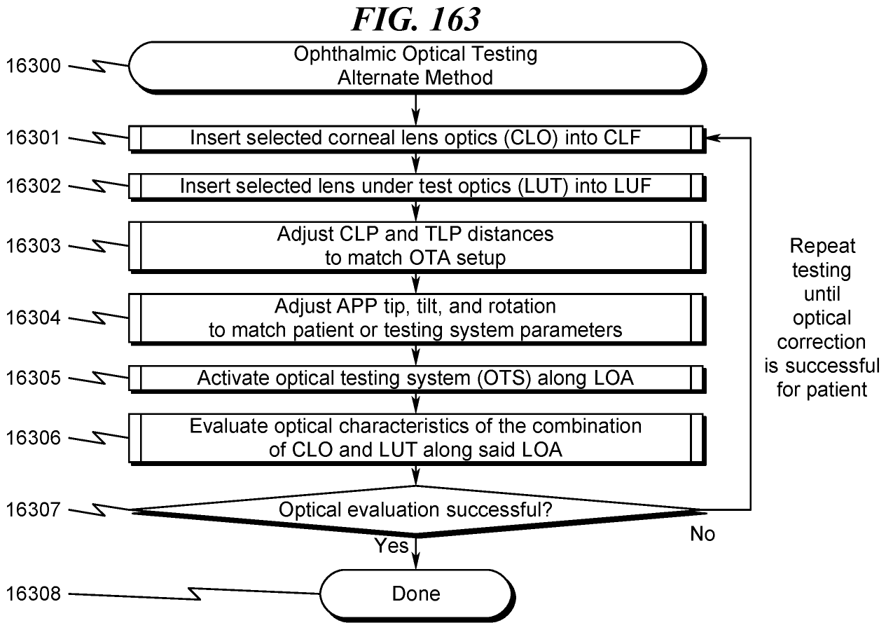

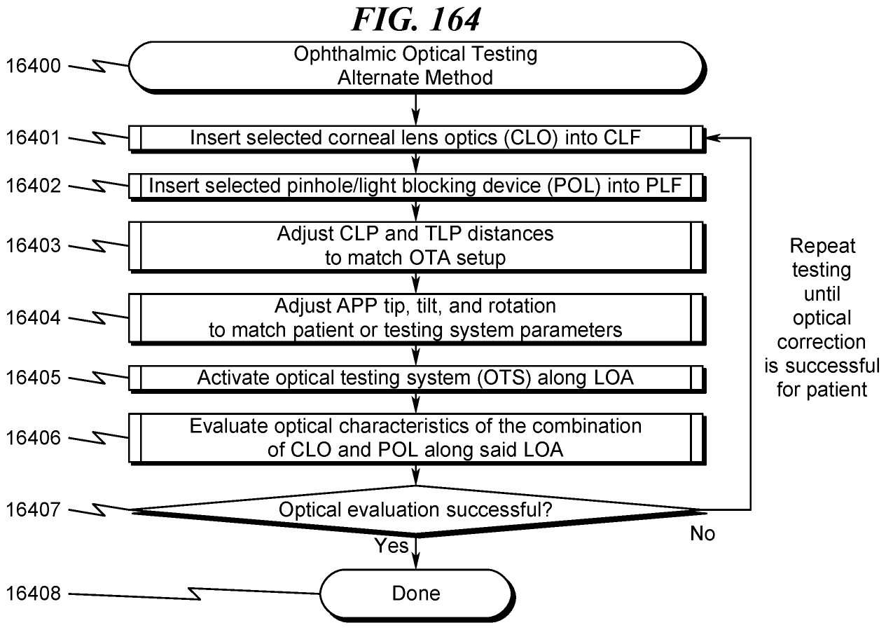

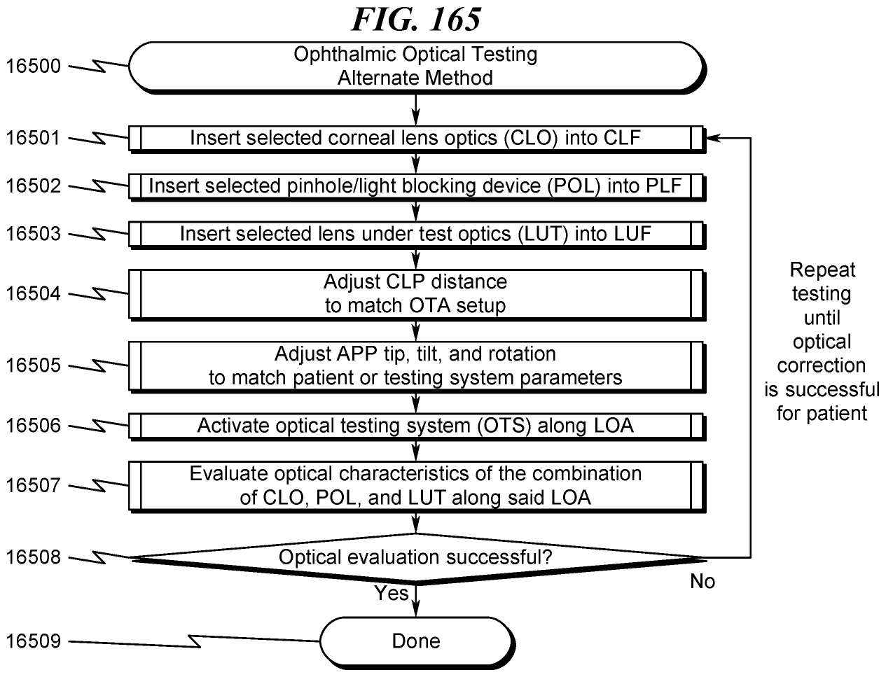

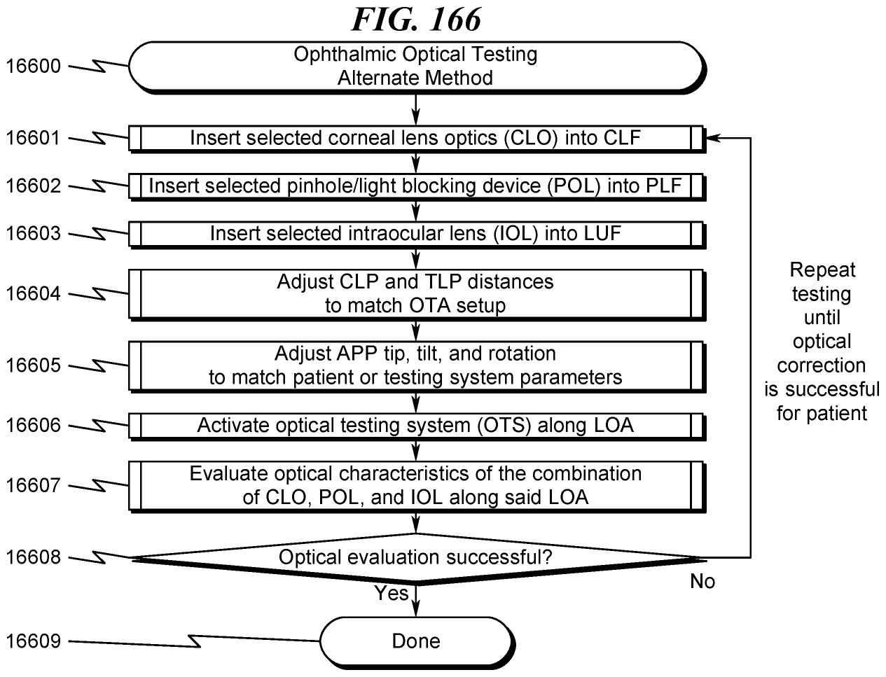

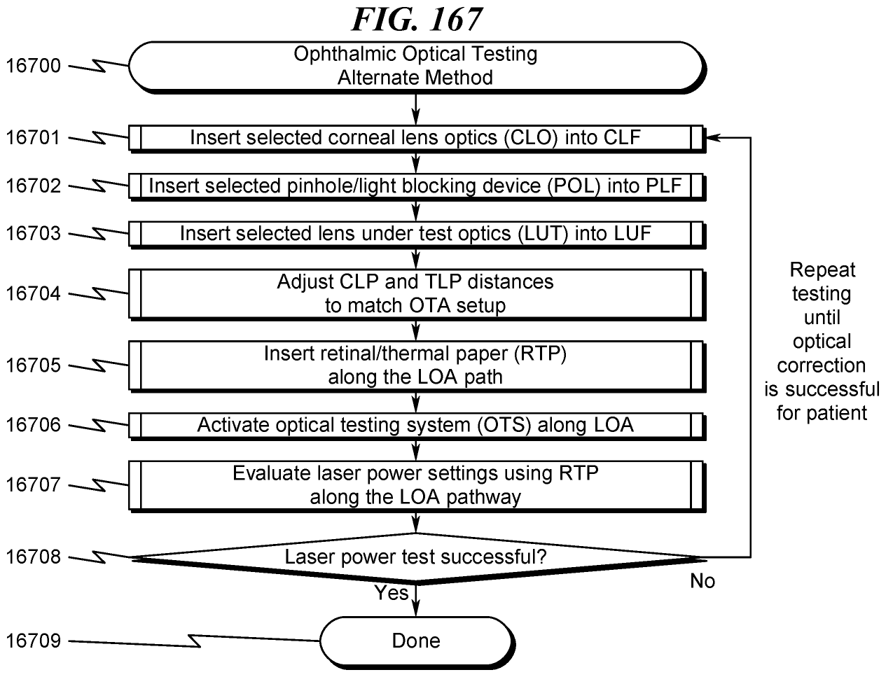

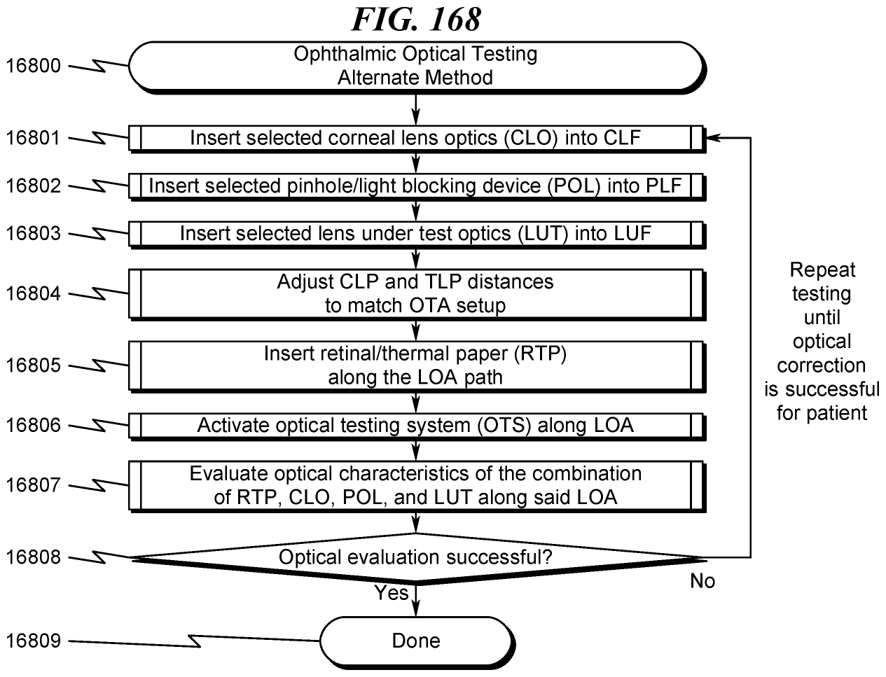

FIG. 162 (16200)-FIG. 168 (16800) depict alternative methods in which one or more steps may be added or omitted depending on application context and system embodiment construction.

### Additional Optical Adjustments

The present invention allows for the adjustable components modeling the human eye that include the anterior chamber depth ACD (test LAP (TLP), the posterior chamber depth (PCD) (corneal LAP (CLP)), pupil opening, and IOL insert. Additional options which may be selectable could include different aspheric and spherical cornea lenses or custom optic.

### System Summary

The present invention system may be broadly generalized as an optical testing system comprising:
(a) optical retention framework (ORF);
(b) corneal longitudinal axis positioning platform (CLP);
(c) corneal lens fixture (CLF); and
(d) corneal lens optics (CLO);

wherein:
the ORF comprises a retention framework base (RFB) having a top framework surface (TFS) and a bottom framework surface (BFS) and a cassette support tower (CST) perpendicular to the TFS;
the CLP comprises a corneal top movable surface (CTS) and a corneal bottom base surface (CBS);
the CBS is mechanically coupled to the TFS;
the CLF comprises a corneal mating surface (CMS) and retains the CLO held in perpendicular alignment with the CMS;
the CMS is mechanically coupled to the CTS;
the CLO is aligned along a longitudinal optical axis (LOA);
the LOA is parallel to the TFS; and
the CLP allows longitudinal parallel movement of the CTS with respect to the LOA.

This general system summary may be augmented by the various elements described herein to produce a wide variety of invention embodiments consistent with this overall design description.

### APP Alternate System Summary

An alternative present invention system embodiment may be broadly generalized as an optical testing system as described above that further comprises:
(a) axial positioning platform (APP);

wherein:
the APP comprises an axial base platform (ABP) and an axial support platform (ASP);
the APP allows tip, tilt, and vertical axial adjustment of the ASP with respect to the ABP; and
the BFS is mechanically coupled to the ASP.

This general system summary may be augmented by the various elements described herein to produce a wide variety of invention embodiments consistent with this overall design description.

### PLO Alternate System Summary

An alternative present invention system embodiment may be broadly generalized as an optical testing system as described above that further comprises:
(a) lens cassette fixture (LCF);
(b) pupil lens fixture (PLF); and
(c) pinhole or light block device (POL);

wherein:
the PLO is retained within the PLF;
the PLF is retained within the LCF;
the LCF is supported within a slot contained in the CST; and
the CLO and the PLO are aligned along the LOA.

This general system summary may be augmented by the various elements described herein to produce a wide variety of invention embodiments consistent with this overall design description.

### TLF Alternate System Summary

An alternative present invention system embodiment may be broadly generalized as an optical testing system as described above that further comprises:
(a) test lens fixture (TLF);
(b) lens under test fixture (LUF); and
(c) lens under test (LUT);

wherein:
the TLF is mechanically coupled to the TFS;
the LUT is retained by the LUF;
the LUF is retained within a slot of the TLF; and
the CLO and the LUT are aligned along the LOA.

This general system summary may be augmented by the various elements described herein to produce a wide variety of invention embodiments consistent with this overall design description.

### TLP Alternate System Summary

An alternative present invention system embodiment may be broadly generalized as an optical testing system as described above that further comprises:
(a) test longitudinal axis positioning platform (TLP);
(b) test lens fixture (TLF);
(c) lens under test fixture (LUF); and
(d) lens under test (LUT);

wherein:
the TLP comprises a test top movable surface (TTS) and a test bottom base surface (TBS);
the TBS is mechanically coupled to the TFS;
the LUT is retained by the LUF;
the LUF is retained within a slot of the TLF;
the TLF is mechanically coupled to the TTS;
the TLP allows longitudinal parallel movement of the TTS with respect to the LOA; and
the CLO and the LUT are aligned along the LOA.

This general system summary may be augmented by the various elements described herein to produce a wide variety of invention embodiments consistent with this overall design description.

### System Combinations Summary

One skilled in the art will recognize that combinations of the above-detailed embodiments may be created without departing from the spirit of the claimed invention.

### Method Summary

The present invention method may be broadly generalized as an optical testing method, the method used in conjunction with an optical testing system, the system comprising:
(a) axial positioning platform (APP);
(b) optical retention framework (ORF);
(c) corneal longitudinal axis positioning platform (CLP);
(d) corneal lens fixture (CLF);
(e) corneal lens optics (CLO);
(f) lens cassette fixture (LCF);
(g) pupil lens fixture (PLF);
(h) pinhole or light block device (POL);
(i) test longitudinal axis positioning platform (TLP);
(j) test lens fixture (TLF);
(k) lens under test fixture (LUF); and
(l) lens under test (LUT);

wherein:
the APP comprises an axial base platform (ABP) and an axial support platform (ASP);
the APP allows tip, tilt, and vertical axial adjustment of the ASP with respect to the ABP;
the ORF comprises a retention framework base (RFB) having a top framework surface (TFS) and a bottom framework surface (BFS) and a cassette support tower (CST) perpendicular to the TFS;
the BFS is mechanically coupled to the ASP;
the CLP comprises a corneal top movable surface (CTS) and a corneal bottom base surface (CBS);
the CBS is mechanically coupled to the TFS;
the CLF comprises a corneal mating surface (CMS) and retains the CLO held in perpendicular alignment with the CMS;
the CMS is mechanically coupled to the CTS;
the PLO is retained within the PLF;
the PLF is retained within the LCF;
the LCF is supported within a slot contained in the CST;
the TLP comprises a test top movable surface (TTS) and a test bottom base surface (TBS);
the TBS is mechanically coupled to the TFS;
the LUT is retained by the LUF;
the LUF is retained within a slot of the TLF;
the TLF is mechanically coupled to the TTS;
the CLO, the PLO, and the LUT are aligned along a common longitudinal optical axis (LOA);
the LOA is parallel to the TFS;
the CLP allows longitudinal parallel movement of the CTS with respect to the LOA; and
the TLP allows longitudinal parallel movement of the TTS with respect to the LOA;

the method comprising the steps of:
(1) inserting selected corneal or custom lens optics (CLO) into the CLF (16101);
(2) inserting selected pinhole or light block device (POL) into the PLF (16102);
(3) inserting selected test intraocular lens (IOL) into the LUF (16103);
(4) adjusting CLP and TLP distances to match the setup parameters of the OTA (16104);
(5) adjusting APP tip, tilt, and rotation to match the patient eye characteristics or the testing system parameters (16105);
(6) activating an external optical testing system (OTS) along the LOA (16106);
(7) evaluating the optical characteristics of the combination of the CLO, the PLO, and the IOL along the LOA (16107); and
(8) determining if the optical evaluation is successful, and if not, repeating steps (1)-(7) until the evaluation generates a successful optical correction suitable for the patient (16108).

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

FIG. 162 (16200)-FIG. 168 (16800) depict alternative methods in which one or more steps may be added or omitted depending on application context and system embodiment construction.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the CLP comprises a manually activated longitudinal travel micrometer adjustment.
An embodiment further comprising a light source configured to emit radiation along the LOA, the light source selected from a group consisting of: laser light; incandescent light; fluorescent light; xenon light; and light emitting diode (LED) light.
An embodiment further comprising a testing material having a planar surface that is perpendicularly positioned in the path of the LOA, the testing material selected from a group consisting of: retina diffusion paper; thermal paper; heat sensitive paper; heat sensitive material; and graticule paper.
An embodiment further comprising a computer control system (CCS) that electro-mechanically controls the position of the CLP.
An embodiment further comprising a computer control system (CCS) that controls operation of a light source configured to emit radiation along the LOA.
An embodiment wherein the APP comprises manually activated tilt, tip, and axial rotation adjustments.
An embodiment further comprising a computer control system (CCS) that electro-mechanically controls the position of the APP.
An embodiment wherein the LCF comprises an adjustable optical aperture (AOA).
An embodiment wherein the LCF comprises a pinhole or light blocking device (POL).
An embodiment further comprising a computer control system (CCS) that electro-mechanically controls the position of the AOA.
An embodiment wherein the LUF comprises an intraocular lens (IOL).
An embodiment wherein the TLP comprises a manually activated longitudinal travel micrometer adjustment.
An embodiment further comprising a computer control system (CCS) that electro-mechanically controls the position of the TLP.

One skilled in the art will recognize that other embodiments are possible based on combinations of elements taught within the above invention description.

### Generalized Computer Usable Medium

In various alternate embodiments, the present invention may be implemented as a computer program product for use with a computerized computing system. Those skilled in the art will readily appreciate that programs defining the functions defined by the present invention can be written in any appropriate programming language and delivered to a computer in many forms, including but not limited to: (a) information permanently stored on non-writeable storage media (e.g., read-only memory devices such as ROMs or CD-ROM disks); (b) information alterably stored on writeable storage media (e.g., floppy disks and hard drives); and/or (c) information conveyed to a computer through communication media, such as a local area network, a telephone network, or a public network such as the Internet. When carrying computer readable instructions that implement the present invention methods, such computer readable media represent alternate embodiments of the present invention.

As generally illustrated herein, the present invention system embodiments can incorporate a variety of computer readable media that comprise computer usable medium having computer readable code means embodied therein. One skilled in the art will recognize that the software associated with the various processes described herein can be embodied in a wide variety of computer accessible media from which the software is loaded and activated. Pursuant to In re Beauregard, 35 USPQ2d 1383 (U.S. Pat. No. 5,710,578), the present invention anticipates and includes this type of computer readable media within the scope of the invention. Pursuant to In re Nuijten, 500 F.3d 1346 (Fed. Cir. 2007) (U.S. patent application Ser. No. 09/211,928), the present invention scope is limited to computer readable media wherein the media is both tangible and non-transitory.

### CONCLUSION

An ophthalmic optical testing system/method allowing human eye characteristics modeling and evaluation of a lens under test (LUT) has been disclosed. The system and method incorporate an axial positioning platform (APP) allowing tip/tilt/rotation about a vertical or horizontal axis of an optical retention framework (ORF) containing a cassette support tower (CST). The CST retains a pupil lens fixture (PLF) incorporating pinhole or light blocking device (POL). The ORF mates to a corneal and test longitudinal axis positioning platforms (LAP) that are attached respectively to a corneal lens fixture (CLF) retaining corneal lens optics (CLO) and a test lens fixture (TLF) retaining an lens under test (LUF) and LUT. The LAPs allow longitudinal adjustment of lenses along a common longitudinal optical axis (LOA) pathway. APP positioning, LAP adjustments, and selection of CLO/PLO/LUT permit LOA optical characteristics to be adjusted and tested.

### CLAIMS INTERPRETATION

The following rules apply when interpreting the CLAIMS of the present invention:
The CLAIM PREAMBLE should be considered as limiting the scope of the claimed invention.
“WHEREIN” clauses should be considered as limiting the scope of the claimed invention.
“WHEREBY” clauses should be considered as limiting the scope of the claimed invention.
“ADAPTED TO” clauses should be considered as limiting the scope of the claimed invention.
“ADAPTED FOR” clauses should be considered as limiting the scope of the claimed invention.
The term “MEANS” specifically invokes the means-plus-function claims limitation recited in 35 U.S.C. § 112(f) and such claim shall be construed to cover the corresponding structure, material, or acts described in the specification and equivalents thereof.
The phrase “MEANS FOR” specifically invokes the means-plus-function claims limitation recited in 35 U.S.C. § 112(f) and such claim shall be construed to cover the corresponding structure, material, or acts described in the specification and equivalents thereof.
The phrase “STEP FOR” specifically invokes the step-plus-function claims limitation recited in 35 U.S.C. § 112(f) and such claim shall be construed to cover the corresponding structure, material, or acts described in the specification and equivalents thereof.
The step-plus-function claims limitation recited in 35 U.S.C. § 112(f) shall be construed to cover the corresponding structure, material, or acts described in the specification and equivalents thereof ONLY for such claims including the phrases “MEANS FOR”, “MEANS”, or “STEP FOR”.
The phrase “AND/OR” in the context of an expression “X and/or Y” should be interpreted to define the set of “(X and Y)” in union with the set “(X or Y)” as interpreted by Ex Parte Gross (USPTO Patent Trial and Appeal Board, Appeal 2011-004811, Ser. No. 11/565,411, (“‘and/or’ covers embodiments having element A alone, B alone, or elements A and B taken together”).
The claims presented herein are to be interpreted in light of the specification and drawings presented herein with sufficiently narrow scope such as to not preempt any abstract idea.
The claims presented herein are to be interpreted in light of the specification and drawings presented herein with sufficiently narrow scope such as to not preclude every application of any idea.
The claims presented herein are to be interpreted in light of the specification and drawings presented herein with sufficiently narrow scope such as to preclude any basic mental process that could be performed entirely in the human mind.
The claims presented herein are to be interpreted in light of the specification and drawings presented herein with sufficiently narrow scope such as to preclude any process that could be performed entirely by human manual effort.

Although a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

What is claimed is:

1. An optical testing system comprising:
(a) optical retention framework (ORF);
(b) corneal axis positioning platform (CLP);
(c) corneal lens fixture (CLF); and
(d) corneal lens optics (CLO);
wherein:
said ORF comprises a retention framework base (RFB) having a top framework surface (TFS) and a bottom framework surface (BFS) and a cassette support tower (CST) perpendicular to said TFS;
said CLP comprises a corneal top movable surface (CTS) and a corneal bottom base surface (CBS);
said CBS is mechanically coupled to said TFS;
said CLF comprises a corneal mating surface (CMS) and retains said CLO held in perpendicular alignment with said CMS;
said CMS is mechanically coupled to said CTS;
said CLO is aligned along a longitudinal optical axis (LOA);
said LOA is parallel to said TFS; and
said CLP allows parallel movement of said CTS with respect to said LOA.

2. The optical testing system of claim 1 wherein said CLP comprises a manually activated travel micrometer adjustment.

3. The optical testing system of claim 1 further comprising a light source configured to emit radiation along said LOA, said light source selected from a group consisting of: laser light; incandescent light;
fluorescent light; xenon light; and light emitting diode (LED) light.

4. The optical testing system of claim 1 further comprising a testing material having a planar surface that is perpendicularly positioned in the path of said LOA, said testing material selected from a group consisting of: retina diffusion paper; thermal paper;
heat sensitive material; thermal or heat sensor; beam positioning sensor; and graticule paper.

5. The optical testing system of claim 1 further comprising a computer control system (CCS) that electro-mechanically controls the position of said CLP.

6. The optical testing system of claim 1 further comprising a computer control system (CCS) that controls operation of a light source configured to emit radiation along said LOA.

7. The optical testing system of claim 1 further comprising:
(a) axial positioning platform (APP);
wherein:
said APP comprises an axial base platform (ABP) and an axial support platform (ASP);
said APP allows tip, tilt, and vertical axial adjustment of said ASP with respect to said ABP; and
said BFS is mechanically coupled to said ASP.

8. The optical testing system of claim 7 wherein said APP comprises manually activated tilt and tip adjustments.

9. The optical testing system of claim 7 wherein said APP comprises manually activated axial rotation adjustment.

10. The optical testing system of claim 7 wherein said APP comprises manually activated tilt, tip, and axial rotation adjustments.

11. The optical testing system of claim 7 further comprising a testing material having a planar surface that is perpendicularly positioned in the path of said LOA, said testing material selected from a group consisting of: retina diffusion paper; thermal paper; heat sensitive material; and graticule paper.

12. The optical testing system of claim 7 further comprising a computer control system (CCS) that electro-mechanically controls the position of said APP.

13. The optical testing system of claim 7 further comprising a computer control system (CCS) that controls operation of a light source configured to emit radiation along said LOA.

14. The optical testing system of claim 1 further comprising:
(a) lens cassette fixture (LCF);
(b) pupil lens fixture (PLF); and
(c) pinhole or light block device (POL);
wherein:
said PLO is retained within said PLF;
said PLF is retained within said LCF;
said LCF is supported within a slot contained in said CST; and
said CLO and said PLO are aligned along said LOA.

15. The optical testing system of claim 14 wherein said LCF comprises an adjustable optical aperture (AOA).

16. The optical testing system of claim 14 wherein said LCF comprises a pinhole or light blocking device (POL).

17. The optical testing system of claim 14 further comprising a testing material having a planar surface that is perpendicularly positioned in the path of said LOA, said testing material selected from a group consisting of: retina diffusion paper; thermal paper; heat sensitive material; and graticule paper.

18. The optical testing system of claim 14 further comprising a computer control system (CCS) that electro-mechanically controls the position of said AOA.

19. The optical testing system of claim 14 further comprising a computer control system (CCS) that controls operation of a light source configured to emit radiation along said LOA.

20. The optical testing system of claim 1 further comprising:
(a) test lens fixture (TLF);
(b) lens under test fixture (LUF); and
(c) lens under test (LUT);
wherein:
said TLF is mechanically coupled to said TFS;
said LUT is retained by said LUF;
said LUF is retained within a slot of said TLF; and
said CLO and said LUT are aligned along said LOA.

21. The optical testing system of claim 20 wherein said LUF comprises an intraocular lens (IOL).

22. The optical testing system of claim 20 further comprising a light source configured to emit radiation along said LOA, said light source selected from a group consisting of: laser light; incandescent light; fluorescent light; xenon light; and light emitting diode (LED) light.

23. The optical testing system of claim 20 further comprising a testing material having a planar surface that is perpendicularly positioned in the path of said LOA, said testing material selected from a group consisting of: retina diffusion paper; thermal paper; heat sensitive paper; heat sensitive material; and graticule paper.

24. The optical testing system of claim 20 further comprising a computer control system (CCS) that controls operation of a light source configured to emit radiation along said LOA.

25. The optical testing system of claim 1 further comprising:
(a) test longitudinal axis positioning platform (TLP);
(b) test lens fixture (TLF);
(c) lens under test fixture (LUF); and
(d) lens under test (LUT);
wherein:
said TLP comprises a test top movable surface (TTS) and a test bottom base surface (TBS);
said TBS is mechanically coupled to said TFS;
said LUT is retained by said LUF;
said LUF is retained within a slot of said TLF;
said TLF is mechanically coupled to said TTS;
said TLP allows longitudinal parallel movement of said TTS with respect to said LOA; and
said CLO and said LUT are aligned along said LOA.

26. The optical testing system of claim 25 wherein said LUF comprises an intraocular lens (IOL).

27. The optical testing system of claim 25 wherein said TLP comprises a manually activated longitudinal travel micrometer adjustment.

28. The optical testing system of claim 25 further comprising a testing material having a planar surface that is perpendicularly positioned in the path of said LOA, said testing material selected from a group consisting of: retina diffusion paper; thermal paper; heat sensitive material; and graticule paper.

29. The optical testing system of claim 25 further comprising a computer control system (CCS) that electro-mechanically controls the position of said TLP.

30. The optical testing system of claim 25 further comprising a computer control system (CCS) that controls operation of a light source configured to emit radiation along said LOA.

31. An optical testing method, said method used in conjunction with an optical testing system, said system comprising:
(a) axial positioning platform (APP);
(b) optical retention framework (ORF);
(c) corneal longitudinal axis positioning platform (CLP);
(d) corneal lens fixture (CLF);
(e) corneal lens optics (CLO);
(f) lens cassette fixture (LCF);
(g) pupil lens fixture (PLF);
(h) pinhole or light block device (POL);
(i) test longitudinal axis positioning platform (TLP);
(j) test lens fixture (TLF);
(k) lens under test fixture (LUF); and
(l) lens under test (LUT);
wherein:
said APP comprises an axial base platform (ABP) and an axial support platform (ASP);
said APP allows tip, tilt, and vertical axial adjustment of said ASP with respect to said ABP;
said ORF comprises a retention framework base (RFB) having a top framework surface (TFS) and a bottom framework surface (BFS) and a cassette support tower (CST) perpendicular to said TFS;
said BFS is mechanically coupled to said ASP;
said CLP comprises a corneal top movable surface (CTS) and a corneal bottom base surface (CBS);
said CBS is mechanically coupled to said TFS;
said CLF comprises a corneal mating surface (CMS) and retains said CLO held in perpendicular alignment with said CMS;
said CMS is mechanically coupled to said CTS;
said PLO is retained within said PLF;
said PLF is retained within said LCF;
said LCF is supported within a slot contained in said CST;
said TLP comprises a test top movable surface (TTS) and a test bottom base surface (TBS);
said TBS is mechanically coupled to said TFS;
said LUT is retained by said LUF;
said LUF is retained within a slot of said TLF;
said TLF is mechanically coupled to said TTS;
said CLO, said PLO, and said LUT are aligned along a common longitudinal optical axis (LOA);
said LOA is parallel to said TFS;
said CLP allows longitudinal parallel movement of said CTS with respect to said LOA; and
said TLP allows longitudinal parallel movement of said TTS with respect to said LOA;
said method comprising the steps of:
(1) inserting selected corneal lens optics (CLO) into said CLF;
(2) inserting selected pinhole or light block device (POL) into said PLF;
(3) inserting selected lens under test (LUT) into said LUF;
(4) adjusting CLP and TLP distances to match OTA setup parameters;
(5) adjusting APP tip, tilt, and rotation to match patient eye characteristics or testing system parameters;
(6) activating an external optical test system (OTS) along said LOA;
(7) evaluating the optical characteristics of the combination of said CLO, said PLO, and said LUT along said LOA; and
(8) determining if said optical evaluation is successful, and if not, repeating steps (1)-(7) until said evaluation generates a successful optical correction suitable for said patient.

32. The optical testing method of claim 31 wherein said APP comprises manually activated tilt, tip, and axial rotation adjustments.

33. The optical testing method of claim 31 wherein said CLP and said TLP each comprise separate manually activated longitudinal travel micrometer adjustments.

34. The optical testing method of claim 31 wherein said LCF comprises an adjustable optical aperture.

35. The optical testing method of claim 31 wherein said LCF comprises a pinhole or light blocking device (POL).

36. The optical testing method of claim 31 wherein said LUF comprises an intraocular lens (IOL).

37. The optical testing method of claim 31 further comprising a light source configured to emit radiation along said LOA, said light source selected from a group consisting of: laser light; incandescent light; fluorescent light; xenon light; and light emitting diode (LED) light.

38. The optical testing method of claim 31 further comprising a testing material having a planar surface that is perpendicularly positioned in the path of said LOA between said LUF and said CLF, said testing material selected from a group consisting of: retina diffusion paper; thermal paper; heat sensitive material; and graticule paper.

39. The optical testing method of claim 31 further comprising a computer control system (CCS) that electro-mechanically controls the position of said APP, said CLP, and said TLP.

40. The optical testing method of claim 31 further comprising a computer control system (CCS) that controls operation of a light source configured to emit radiation along said LOA.

41. An optical testing method, said method used in conjunction with an optical testing system, said system comprising:
(a) plurality of retaining slots which represent the intraocular lens (IOL) and cornea of a sample patient;
(b) light source which demonstrates the image created by lenses inserted in said slots;
wherein said method comprises the steps of:
(1) inserting selected corneal lens optics (CLO) into one of said slots;
(2) inserting a selected test intraocular lens (IOL) into one of said slots;
(3) evaluating the optical characteristics of the combination of said light source and said lenses in said slots.

42. The testing method of claim 41 in which a testing material is inserted in one or more of said slots to test heat effects of said light source, said testing material selected from a group consisting of: retina diffusion paper; thermal paper; heat sensitive paper; heat sensitive material; and graticule paper.

43. An optical testing method, said method used in conjunction with an optical testing system, said system comprising:
(a) plurality of retaining slots which represent the intraocular lens (IOL), pupil, and cornea of a sample patient;
(b) light source which demonstrates the image created by lenses inserted in said slots;
wherein said method comprises the steps of:
(1) inserting selected corneal lens optics (CLO) into one of said slots;
(2) inserting selected pinhole or light block device (POL) into one of said slots;
(3) inserting a selected test intraocular lens (IOL) into one of said slots;
(4) evaluating the optical characteristics of the combination of said light source and said lenses in said slots.

44. The testing method of claim 43 in which a testing material is inserted in one or more of said slots to test heat effects of said light source, said testing material selected from a group consisting of: retina diffusion paper; thermal paper; heat sensitive paper; heat sensitive material; and graticule paper.
